(19) United States
(12) Patent Application Publication
(10) Pub. No.: US 2014/0006234 A1
(43) Pub. Date: Jan. 2, 2014

(54) CONSISTENT INTERFACE FOR CUSTOMER PROJECT EXPENSE LIST AND DEVIATING TAX CALCULATION RULE

(71) Applicants: Otfried Von Geisau, Sinsheim (DE); Tanja Rueckel, Waghaeusel (DE); Payal Patnaik, Bangalore (IN); Andrea Hahn, Waghaeusel (DE); Elena Renkewitsch, Heidelberg (DE); Michael Hoffmann, Bad Schoenborn (DE); Joachim Liebler, Heidelberg (DE); Anupam Narayan, Bangalore (IN); Vijay Kumar, Bangalore (IN); Girish Jayappa, Bangalore (IN); Abid Saleem Khattak, Wiesloch (DE); Velislav Ivanov, Walldorf (DE)

(72) Inventors: Otfried Von Geisau, Sinsheim (DE); Tanja Rueckel, Waghaeusel (DE); Payal Patnaik, Bangalore (IN); Andrea Hahn, Waghaeusel (DE); Elena Renkewitsch, Heidelberg (DE); Michael Hoffmann, Bad Schoenborn (DE); Joachim Liebler, Heidelberg (DE); Anupam Narayan, Bangalore (IN); Vijay Kumar, Bangalore (IN); Girish Jayappa, Bangalore (IN); Abid Saleem Khattak, Wiesloch (DE); Velislav Ivanov, Walldorf (DE)

(73) Assignee: SAP AG

(21) Appl. No.: 13/535,750

(22) Filed: Jun. 28, 2012

(51) Int. Cl. G06Q 40/00

(52) U.S. Cl. 705/31; 705/30

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a customer project expense list and a deviating tax calculation rule business object.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about tax exemption rules. The medium comprises program code for receiving, via a message-based interface exposing at least one service as defined in a service registry and from a heterogeneous application executing in an environment of computer systems providing message-based services, a first message for notification of a rule for a deviating tax calculation for a specific product, a specific business partner and/or an organizational unit for a tax jurisdiction. The first message includes a message package hierarchically organized as a deviating tax calculation message entity and a deviating tax calculation package including a deviating tax calculation entity, wherein the deviating tax calculation entity includes a tax calculation rule details entity. The medium further comprises program code for sending a second message to the heterogeneous application responsive to the first message.

Implementations can include the following. The deviating tax calculation entity further includes at least one of the following: a select all indicator entity, one or more organisational centre entities, one or more product entities, one or more business partner entities, and a tax jurisdiction entity. The deviating tax calculation entity includes at least one of the following: a universally unique identifier, a deviating tax calculation rule identifier, a tax type code, a country code, a valid from date, a valid to date, and system administrative data.

In another aspect, a distributed system operates in a landscape of computer systems providing message-based services defined in a service registry. The system comprises a graphical user interface comprising computer readable instructions, embedded on tangible media, for notification of a rule for a deviating tax calculation for a specific product, a specific business partner and/or an organizational unit for a tax jurisdiction, the instructions using a request. The system further comprises a first memory storing a user interface controller for processing the request and involving a message including a message package hierarchically organized as a deviating tax calculation message entity and a deviating tax calculation package including a deviating tax calculation entity, wherein the deviating tax calculation entity includes a tax calculation rule details entity. The system further comprises a second memory, remote from the graphical user interface, storing a plurality of service interfaces, wherein one of the service interfaces is operable to process the message via the service interface.

Implementations can include the following. The first memory is remote from the graphical user interface. first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example Deviating Tax Calculation Rule object model.

FIG. 33 depicts an example Cost Object Expense List Accounting Notification message data type.

FIGS. 34-1 through 34-11 depict an example Cost Object Expense List Accounting Notification element structure.

FIGS. 35-1 through 35-3 depict an example Customer Project Expense List object model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

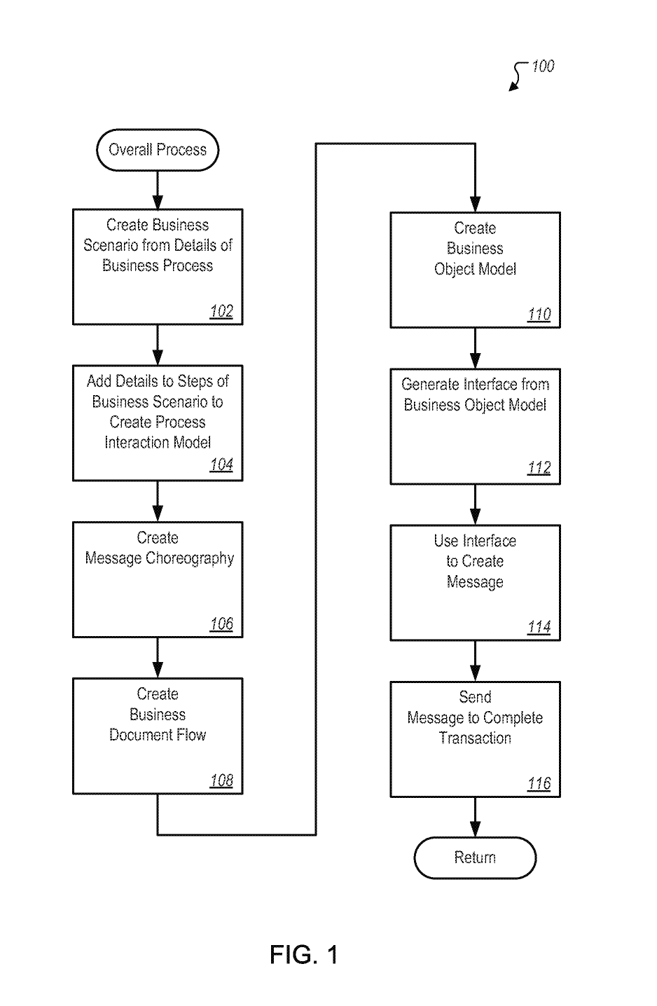

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

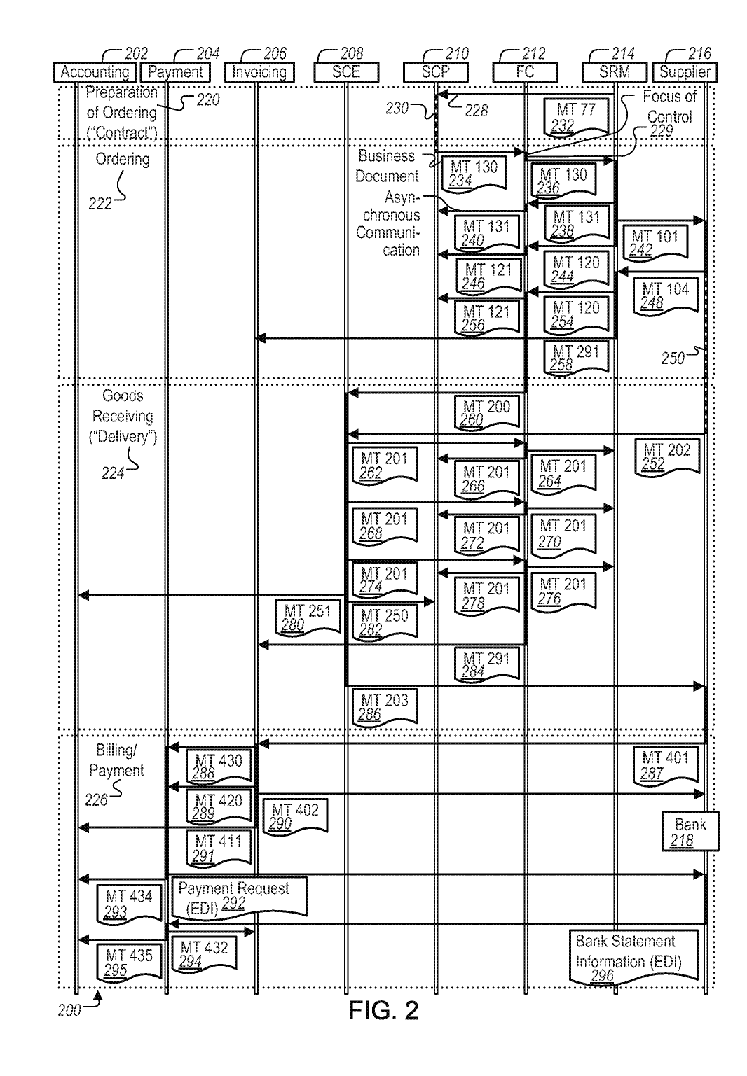

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

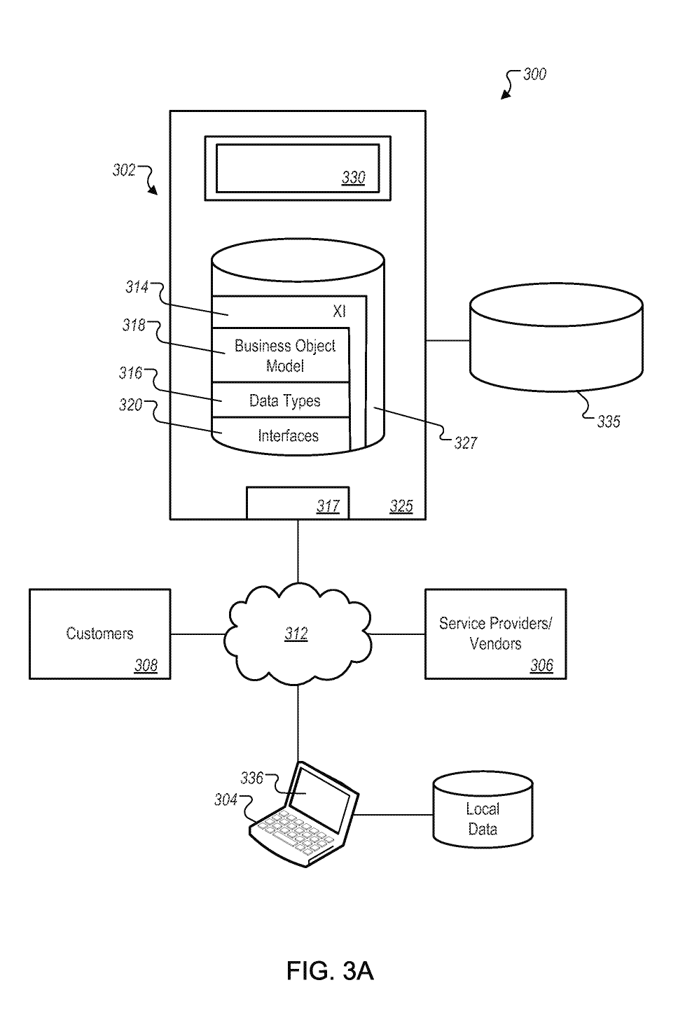

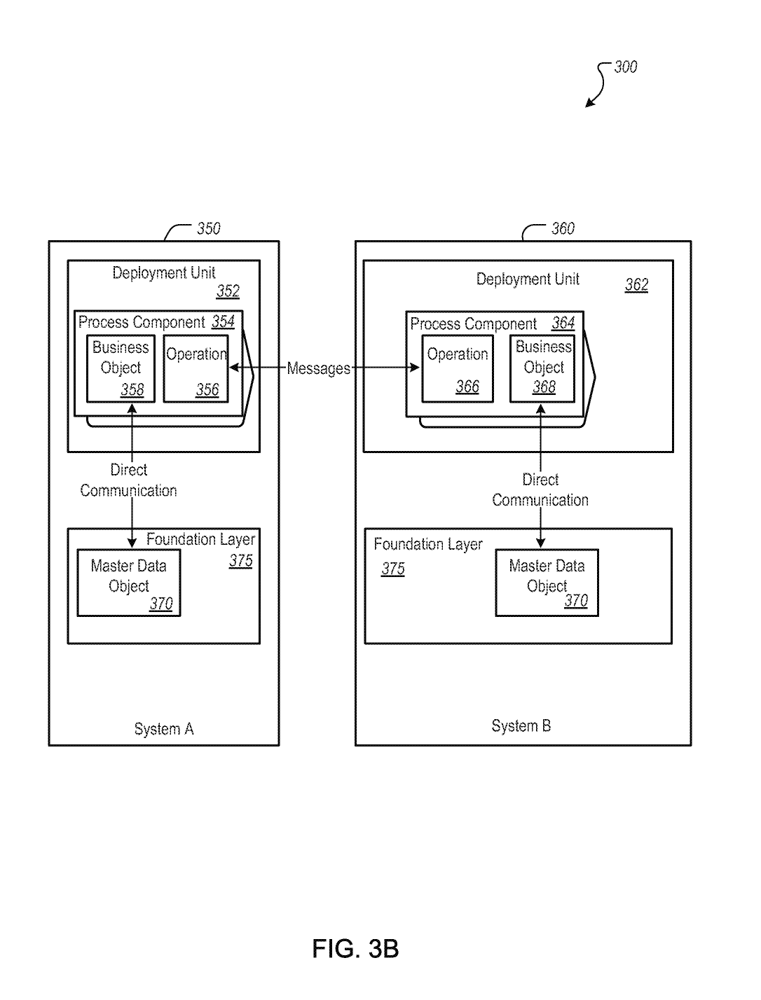

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

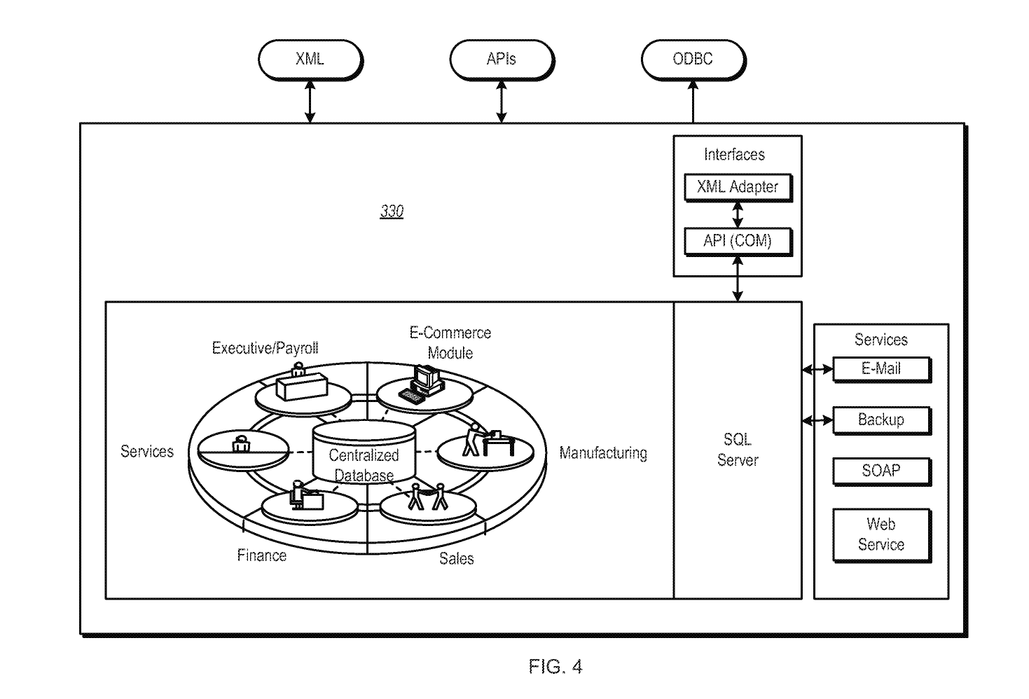

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 306 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

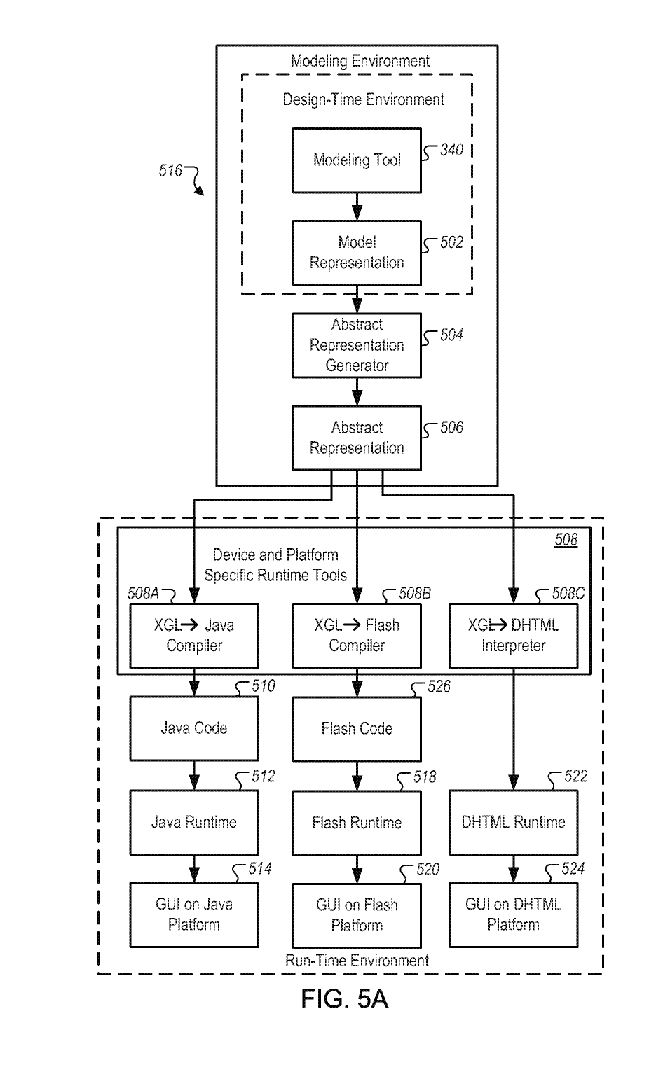

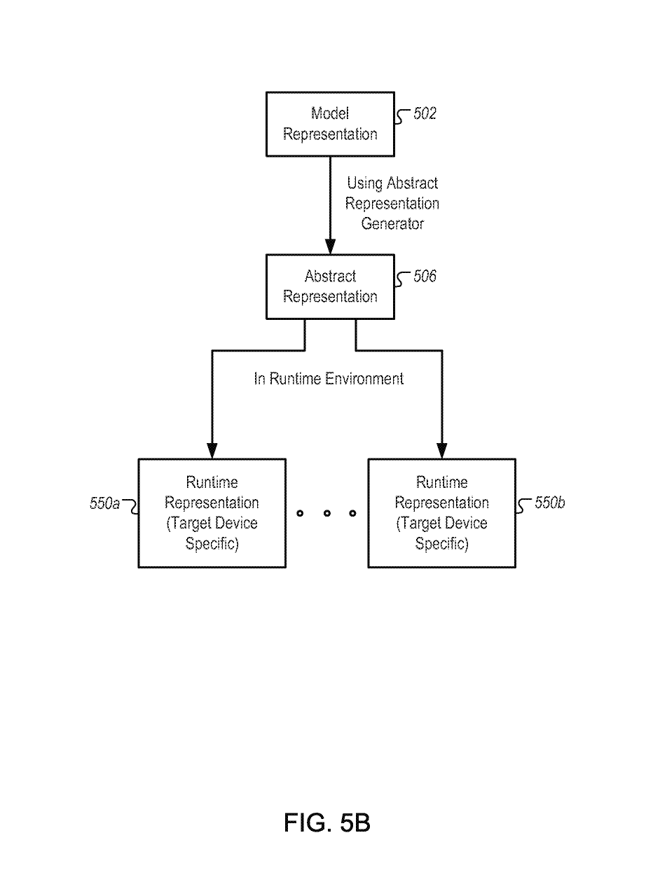

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

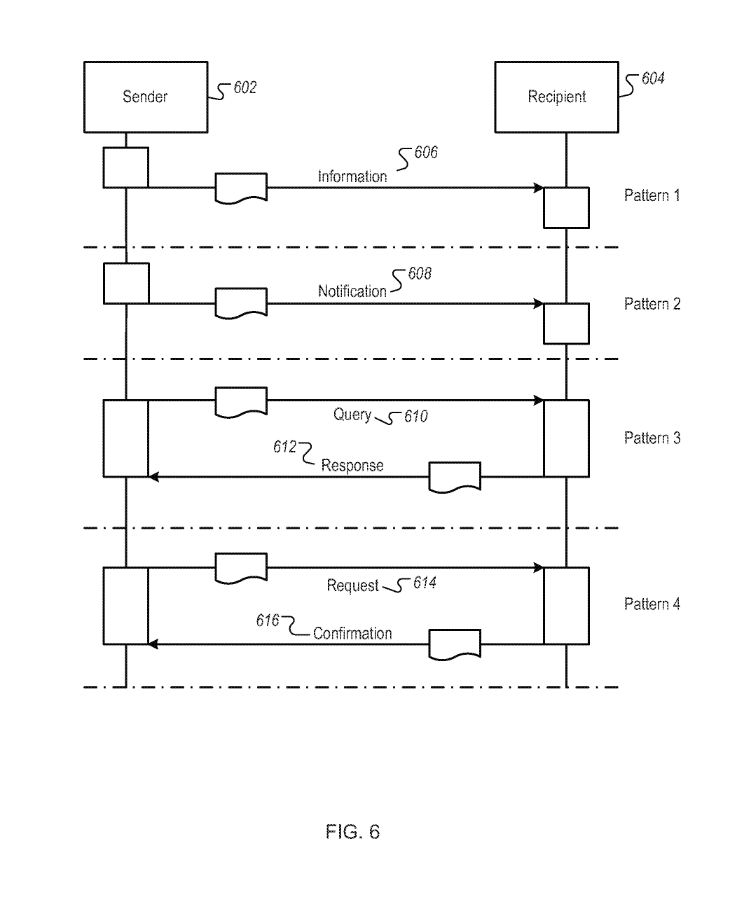

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

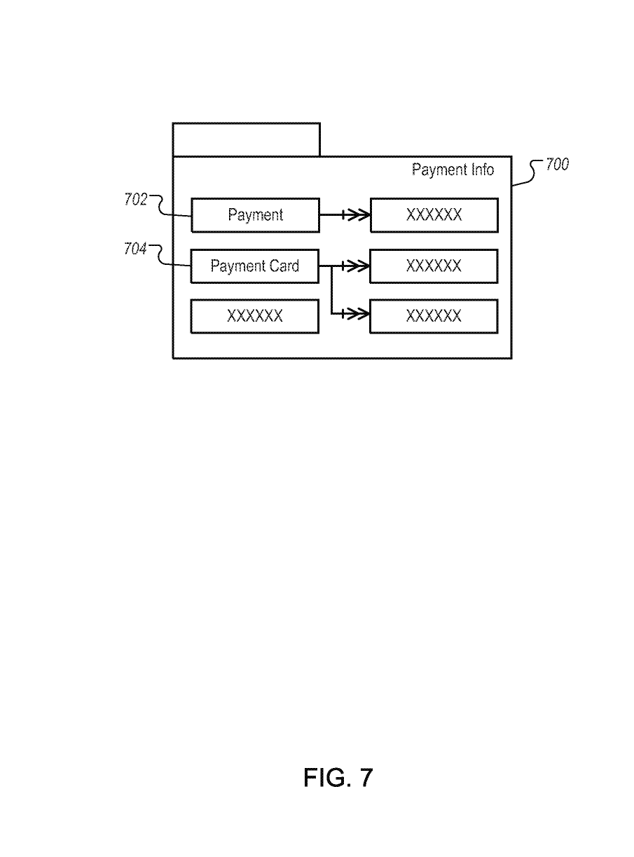

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

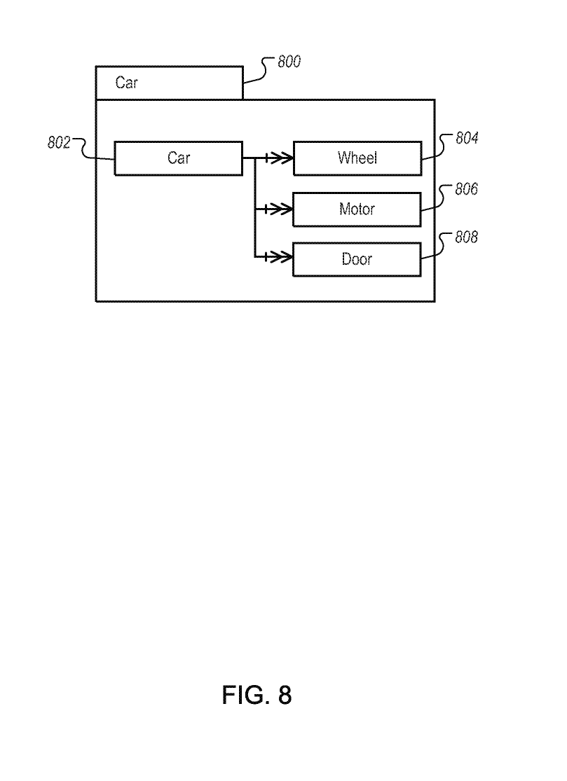

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

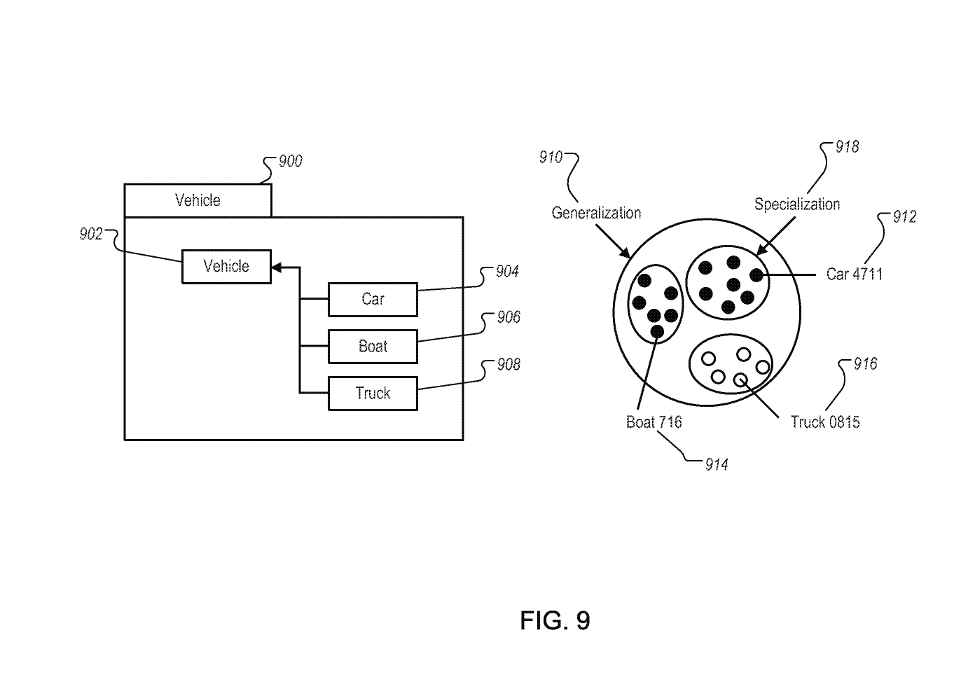

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

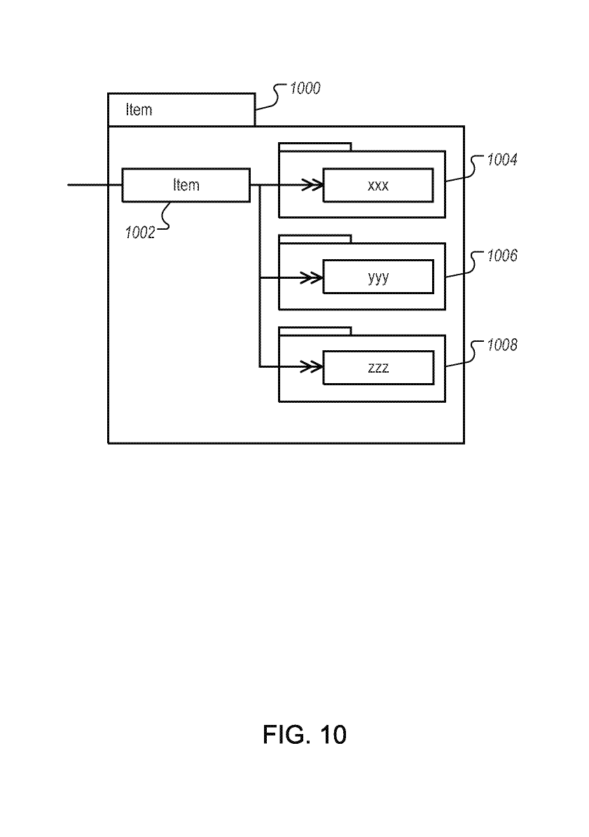

Packages also may be used to represent hierarchy levels. For example, as depicted in FIG. 10, the Item Package 1000 includes Item 1002 with subitem xxx 1004, subitem yyy 1006, and subitem zzz 1008.

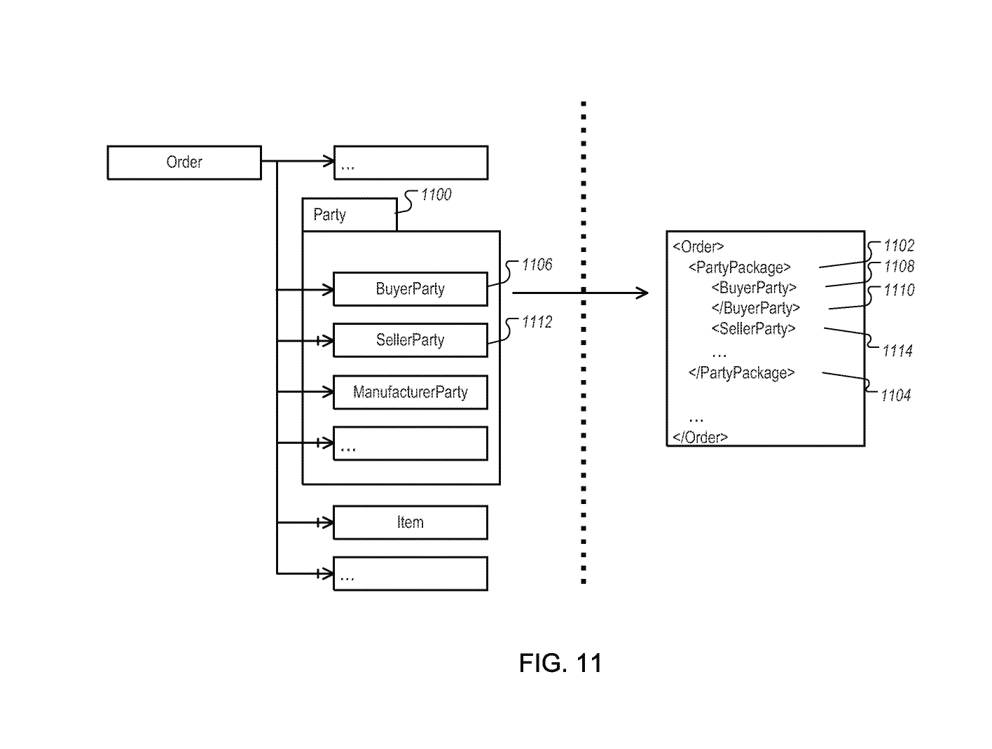

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

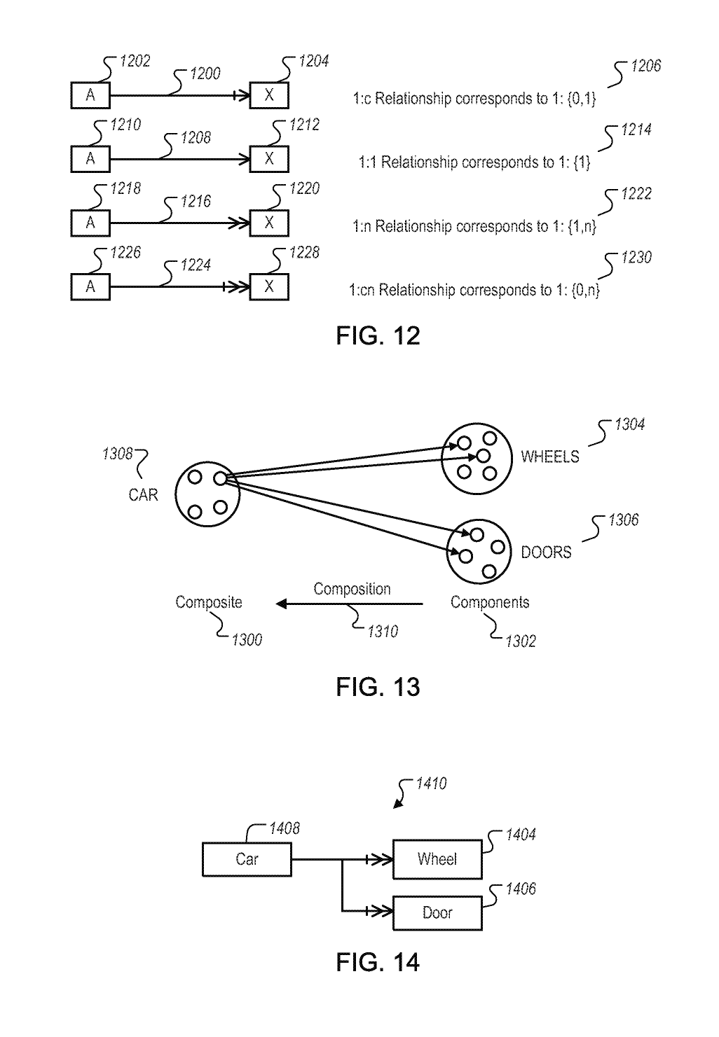

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

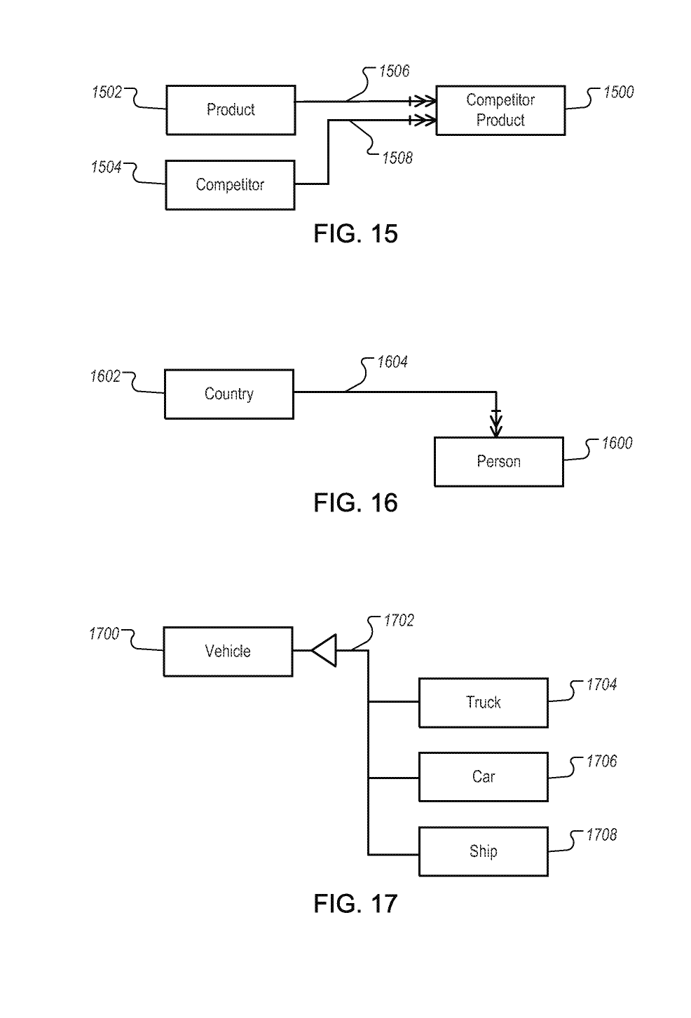

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

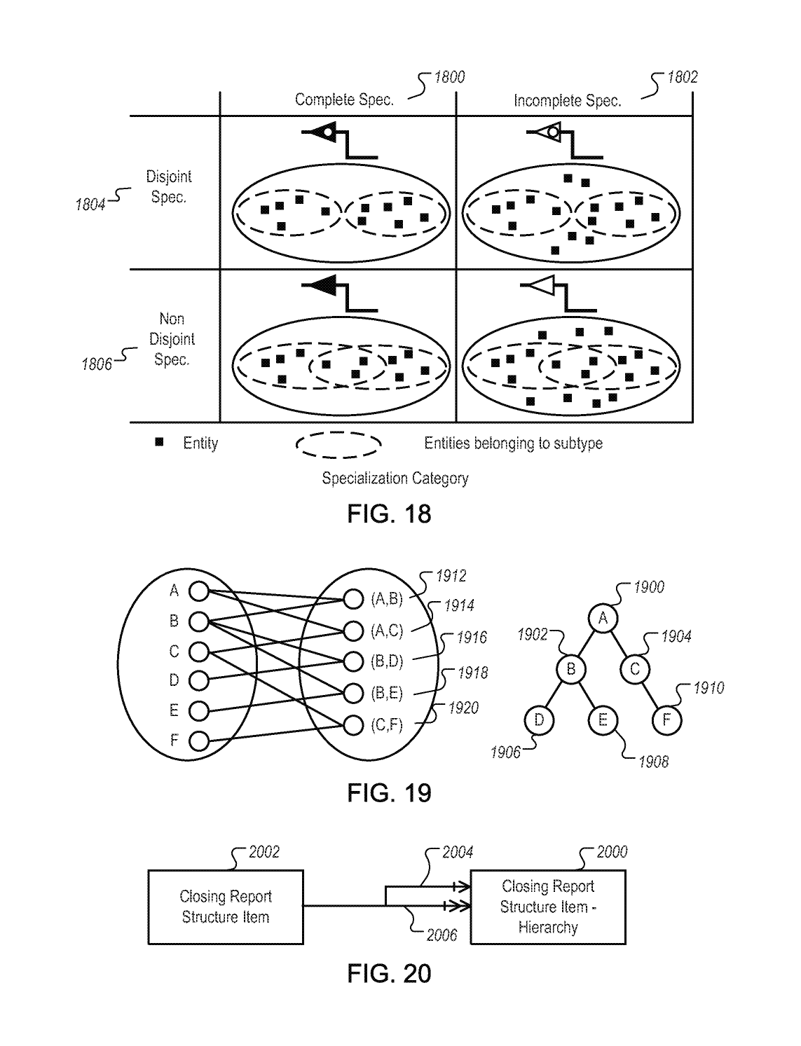

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

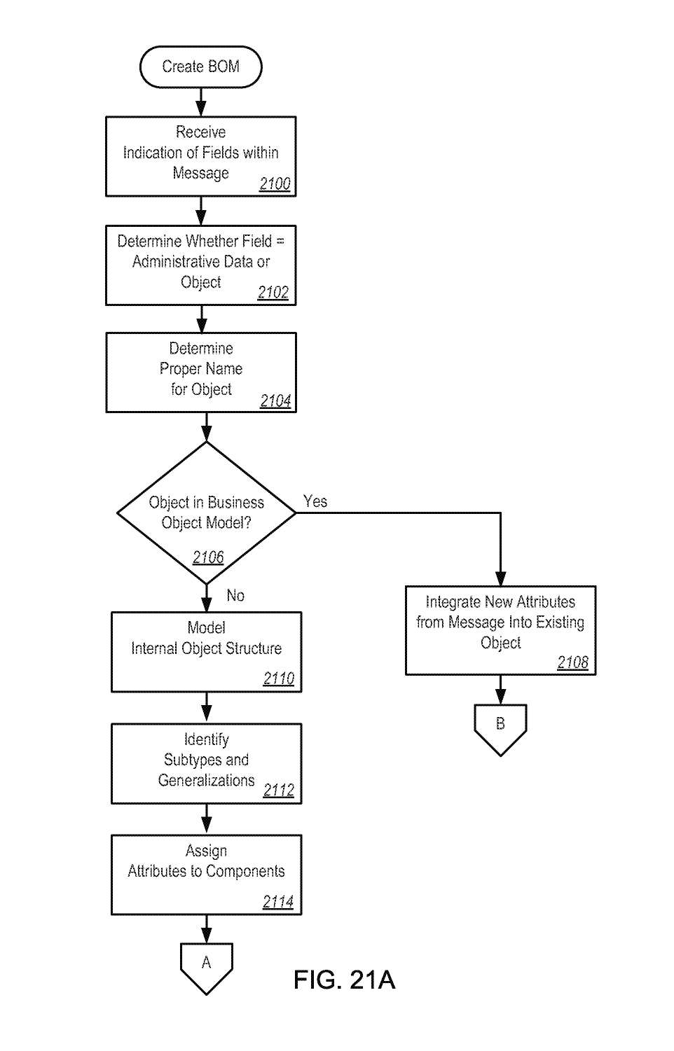

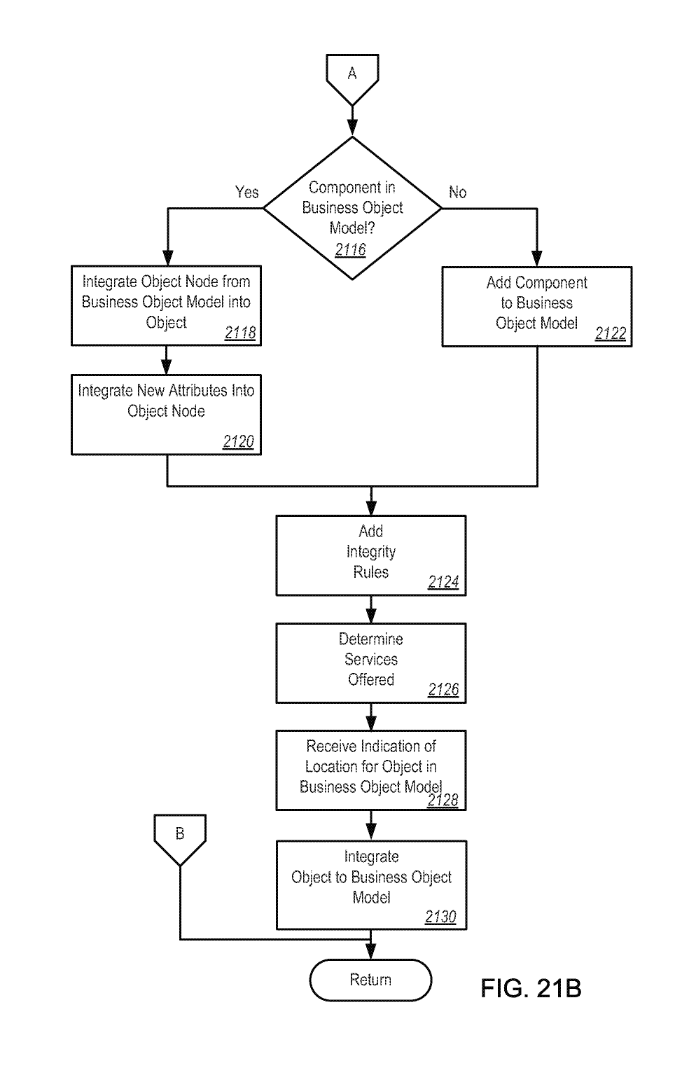

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | MainObject |
| AdditionalID | |
| PostingDate | |
| LastChangeDate | |
| AcceptanceStatus | |
| Note | |
| CompleteTransmissionIndicator | |
| Buyer | |
| BuyerOrganisationName | |
| PersonName | |
| FunctionalTitle | |
| DepartmentName | |
| CountryCode | |
| StreetPostalCode | |
| POBoxPostalCode | |
| CompanyPostalCode | |
| CityName | |
| DistrictName | |
| POBoxID | |
| POBoxIndicator | |
| POBoxCountryCode | |
| POBoxRegionCode | |
| POBoxCityName | |
| StreetName | |
| HouseID | |
| BuildingID | |
| FloorID | |
| RoomID | |
| CareOfName | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionofMessage | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBoxPostalCode | |
| CompanyPostalCode | |
| CityName | |
| DistrictName | |
| POBoxID | |
| POBoxIndicator | |
| POBoxCountryCode | |
| POBoxRegionCode | |
| POBoxCityName | |
| StreetName | |
| HouseID | |
| BuildingID | |
| FloorID | |
| RoomID | |
| CareOfName | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Pur- | | |
| AdditionalID | chase- | | |
| PostingDate | Order | | |
| LastChangeDate | | | |
| AcceptanceStatus | | | |
| Note | | | |
| CompleteTransmission- | | | |
| Indicator | | | |
| Buyer | | Buyer | |
| BuyerOrganisationName | | | |
| PersonName | | | |
| FunctionalTitle | | | |
| DepartmentName | | | |
| CountryCode | | | |
| StreetPostalCode | | | |
| POBoxPostalCode | | | |
| CompanyPostalCode | | | |
| CityName | | | |
| DistrictName | | | |
| POBoxID | | | |
| POBoxIndicator | | | |
| POBoxCountryCode | | | |
| POBoxRegionCode | | | |
| POBoxCityName | | | |
| StreetName | | | |
| HouseID | | | |
| BuildingID | | | |
| FloorID | | | |
| RoomID | | | |
| CareOfName | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof- | | | |
| Message | | | |
| FollowUpActivity | | | |
| ItemID | | PurchaseOrder- | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation- | | | |
| Name | | | |
| PersonName | | | |
| FunctionalTitle | | | |
| DepartmentName | | | |
| CountryCode | | | |
| StreetPostalCode | | | |
| POBoxPostalCode | | | |
| CompanyPostalCode | | | |
| CityName | | | |
| DistrictName | | | |
| POBoxID | | | |
| POBoxIndicator | | | |
| POBoxCountryCode | | | |
| POBoxRegionCode | | | |
| POBoxCityName | | | |
| StreetName | | | |
| HouseID | | | |
| BuildingID | | | |
| FloorID | | | |
| RoomID | | | |
| CareOfName | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial- | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscountTerms | | | 0 . . . 1 |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation- | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase- | | | | | 1 |
| Order | | | | | |
| | PurchaseOrder- | | | | |
| | Update | | | | |
| | | PurchaseOrderRequest | | | |
| | | PurchaseOrderChange | | | |
| | | PurchaseOrder- | | | |
| | | Confirmation | | | |
| | PurchaseOrder- | | | | |
| | Cancellation | | | | |
| | PurchaseOrder- | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount- | | | | 0 . . . 1 |
| | Terms | | | | |
| | | MaximumCashDiscount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation- | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo- | | 0 . . . 1 |
| | | | Location | | |
| | | | ShipFrom- | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description- | | | |
| | | ScheduleLine | | | 0 . . . n |
| | | | Delivery- | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

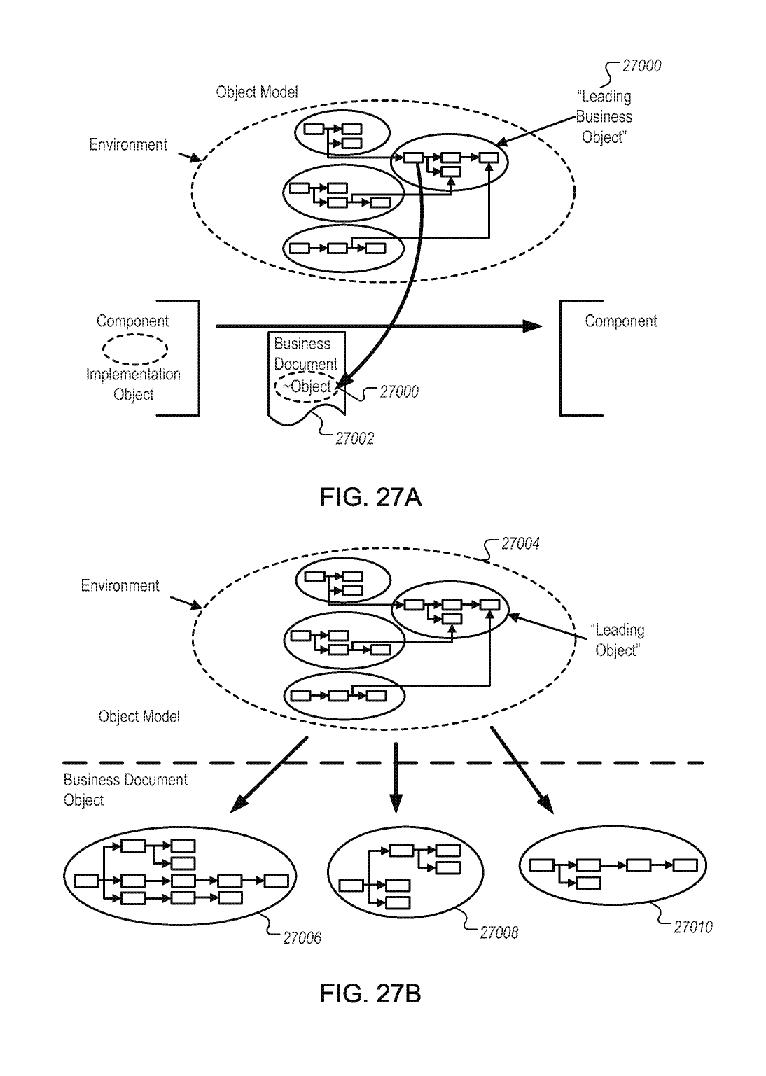

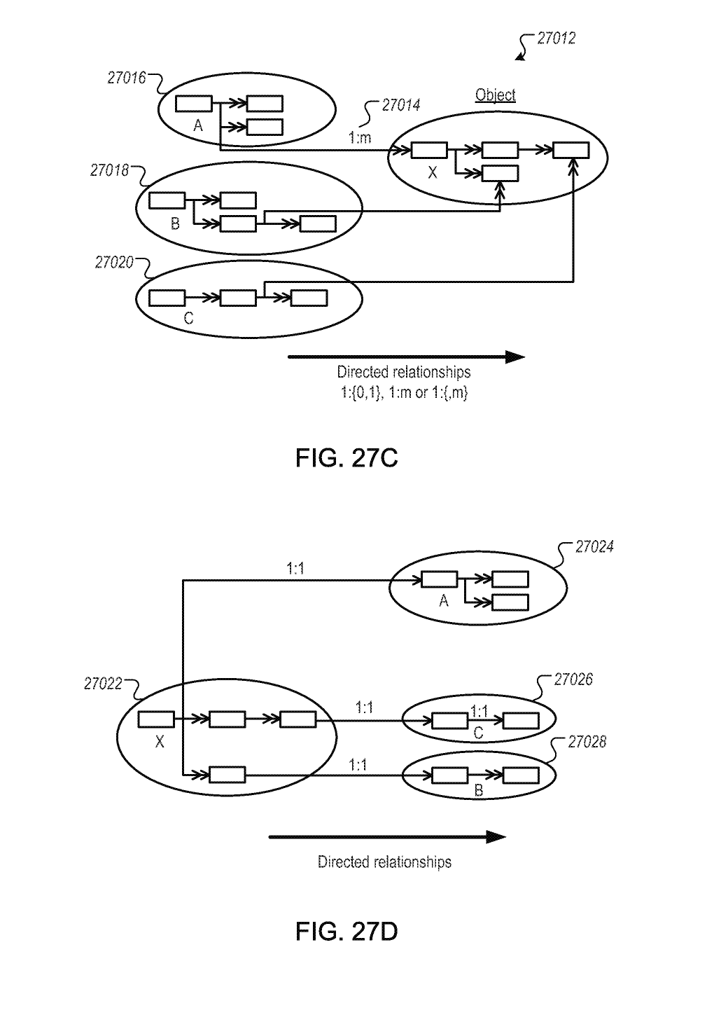

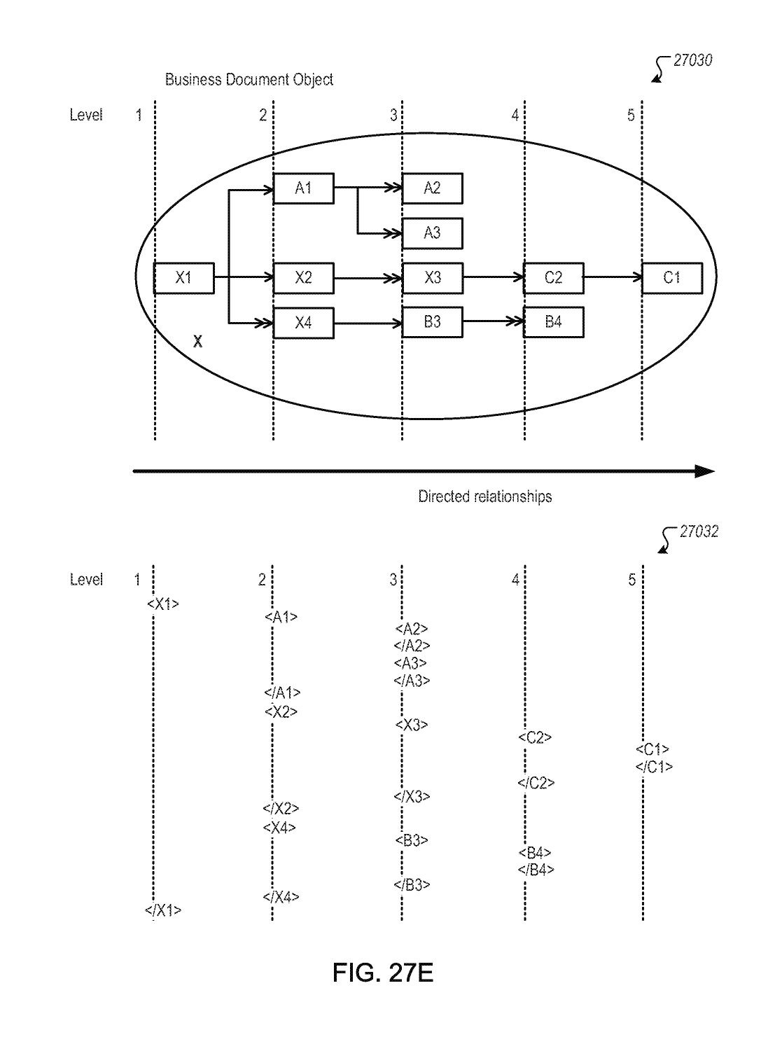

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

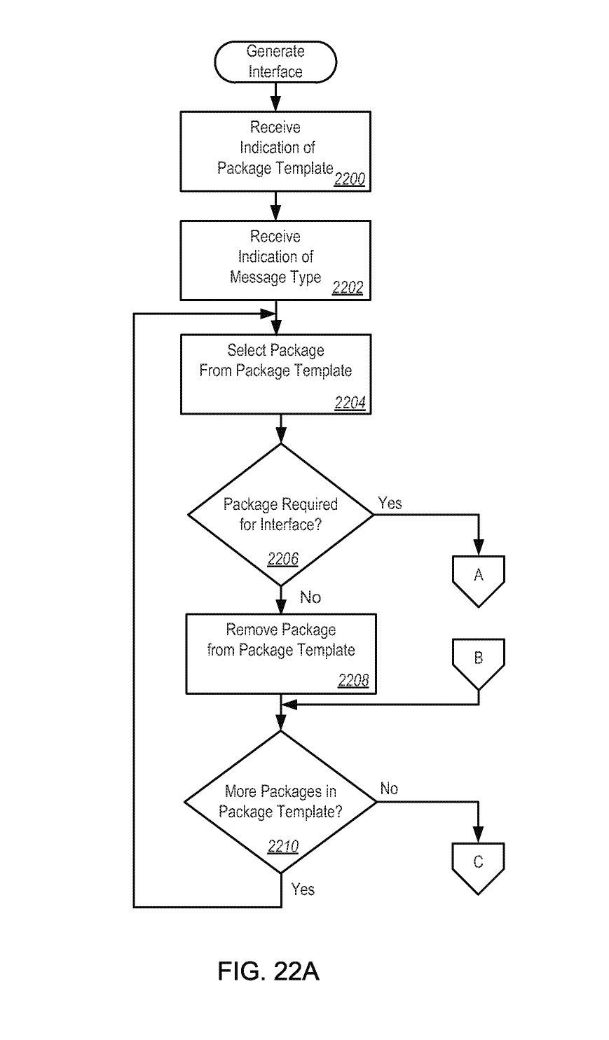

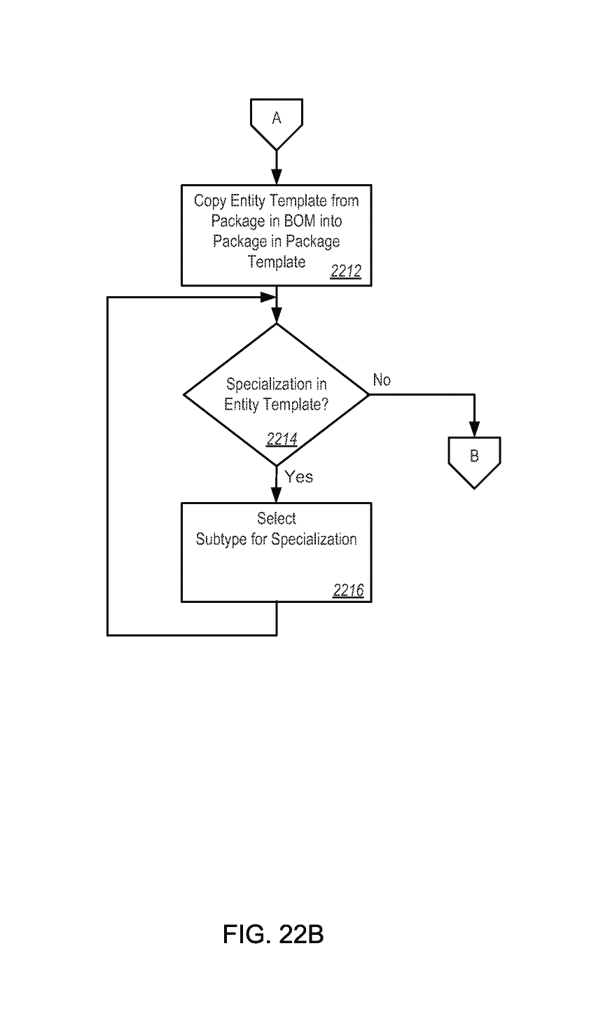

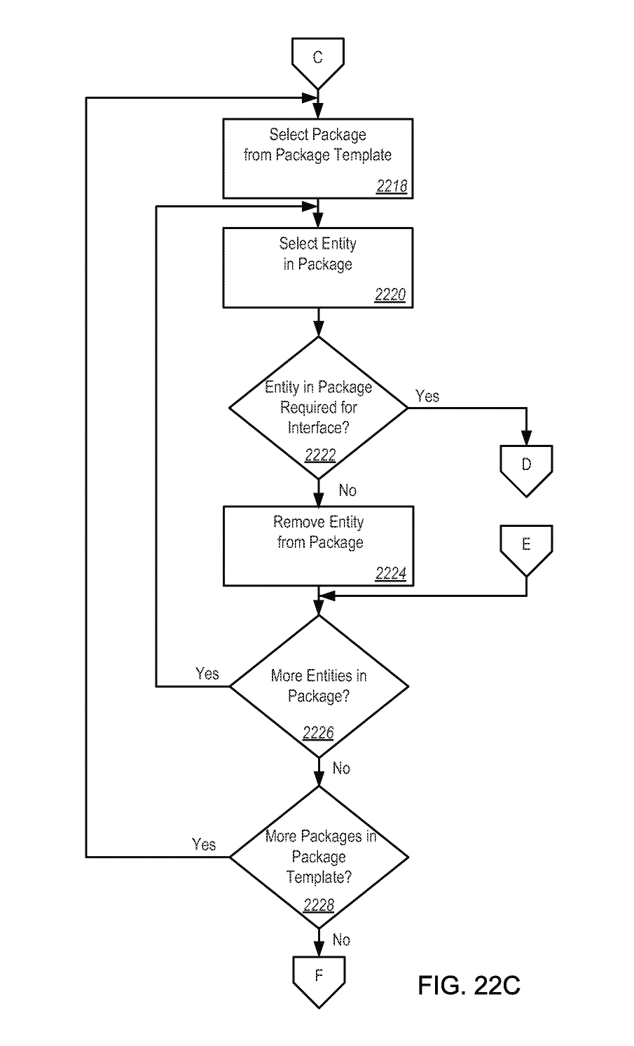

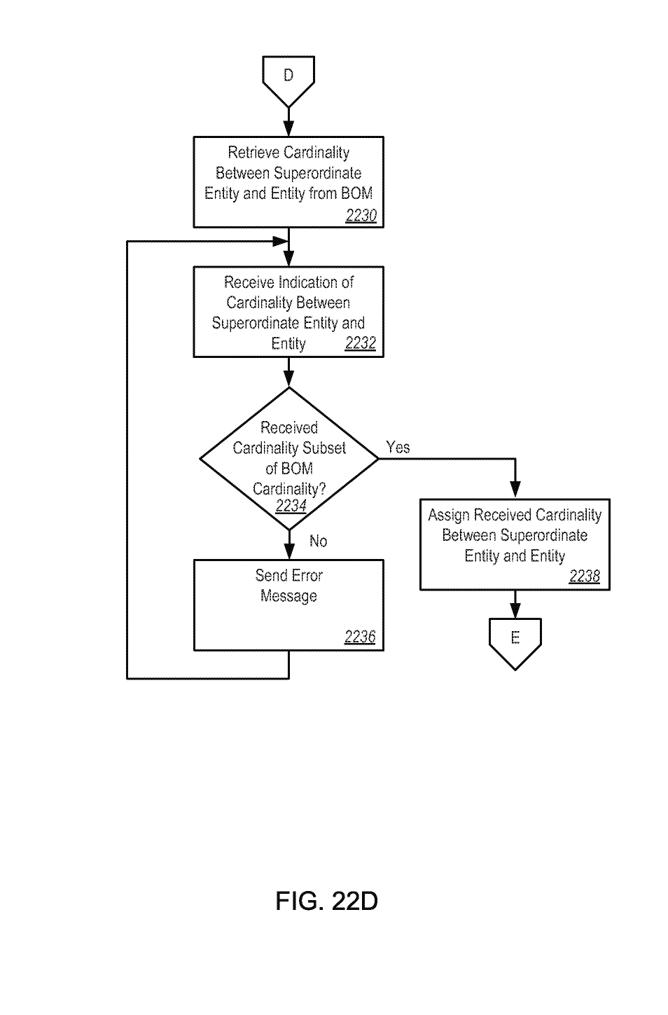

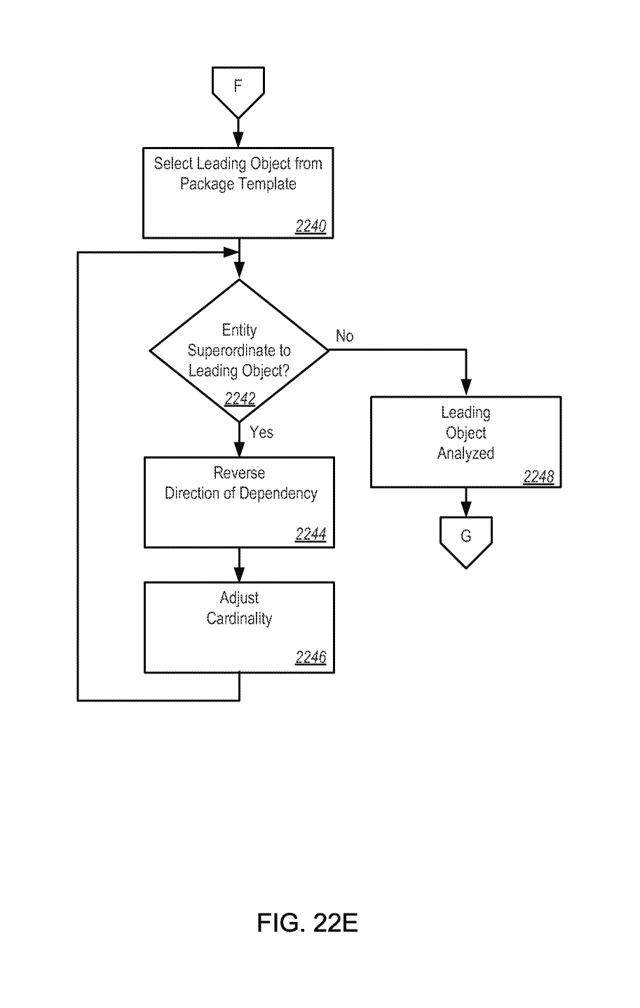

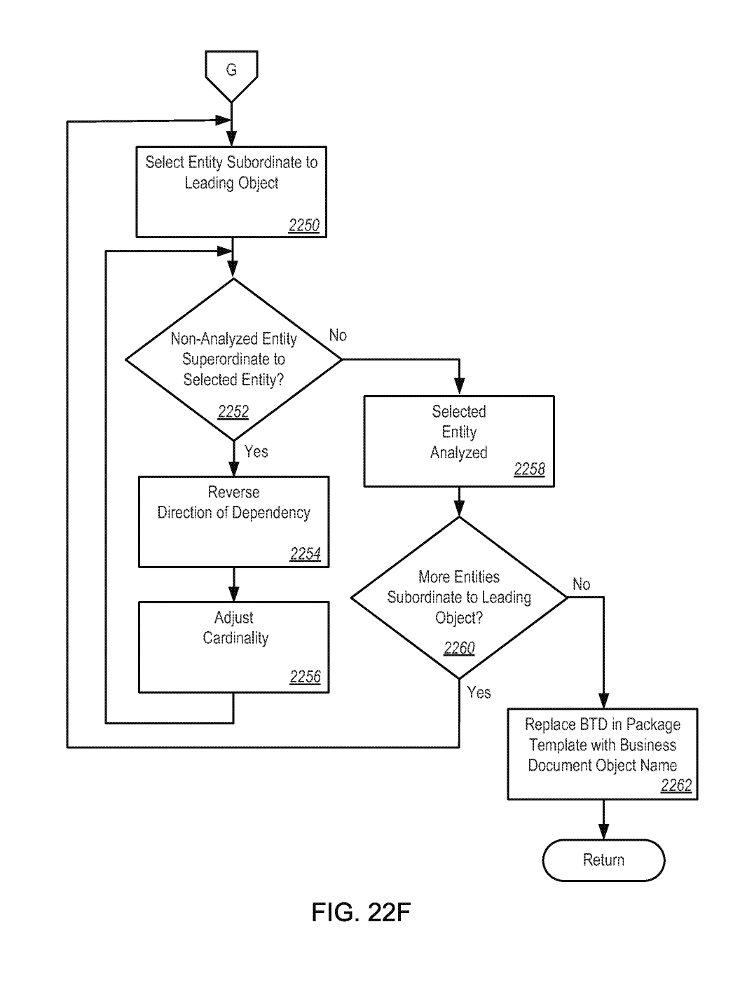

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

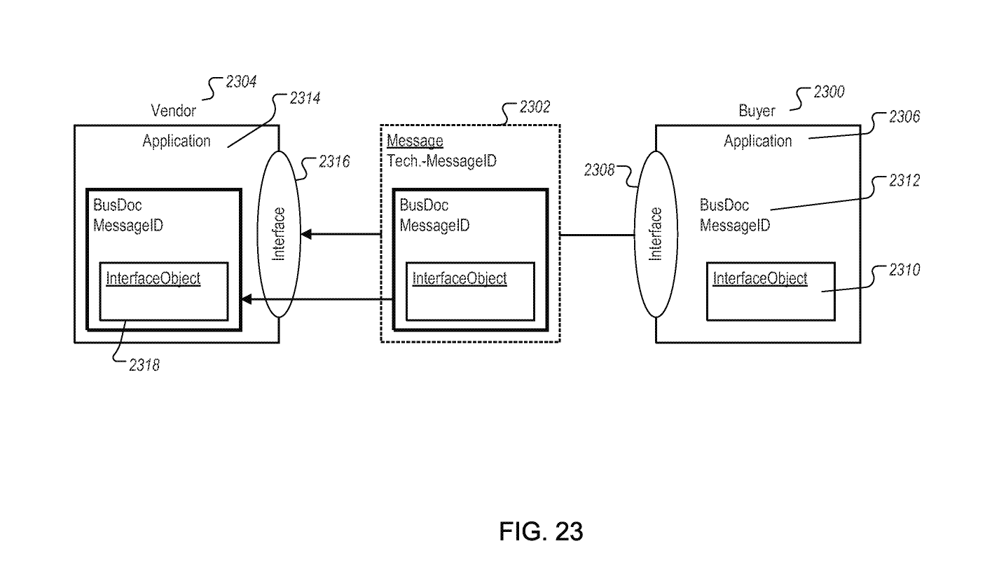

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

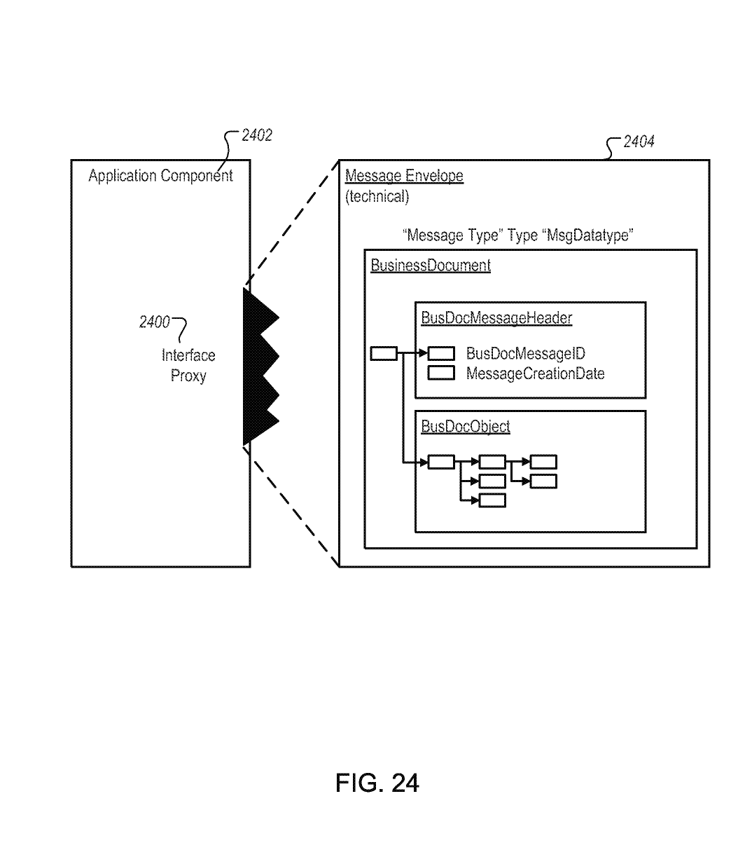

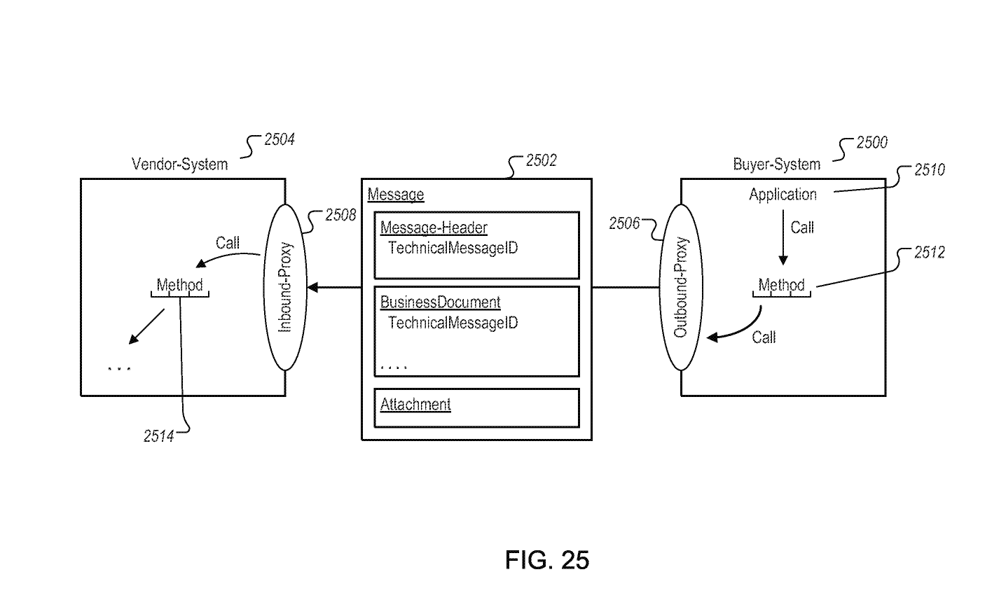

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

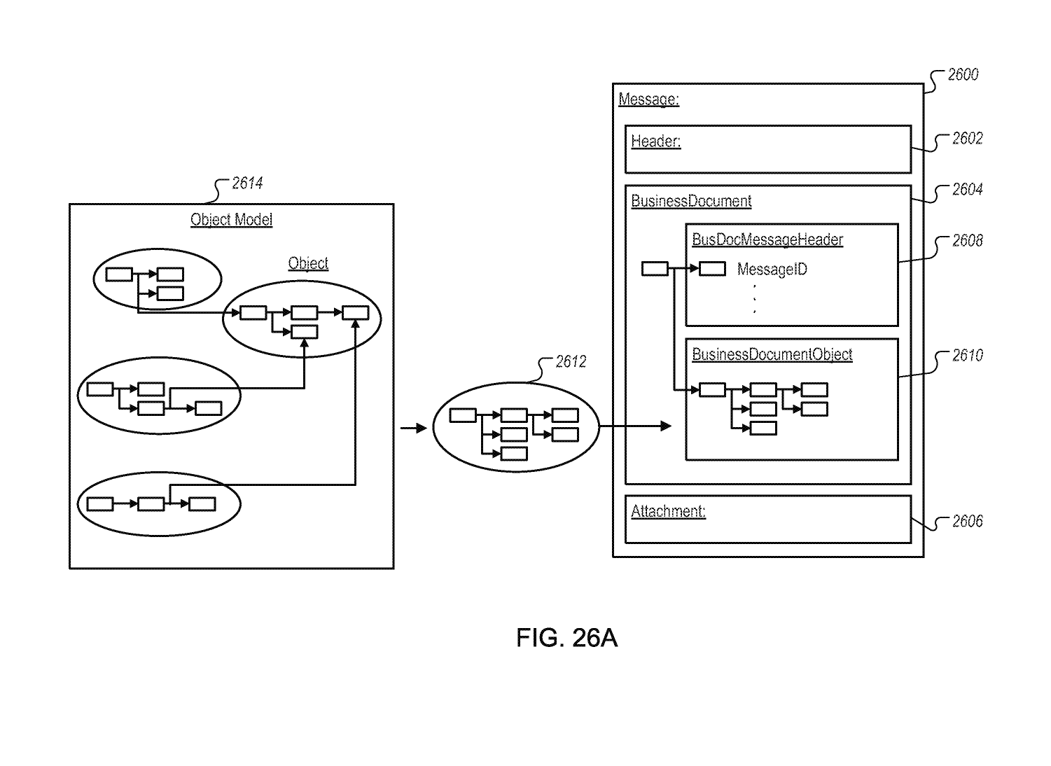

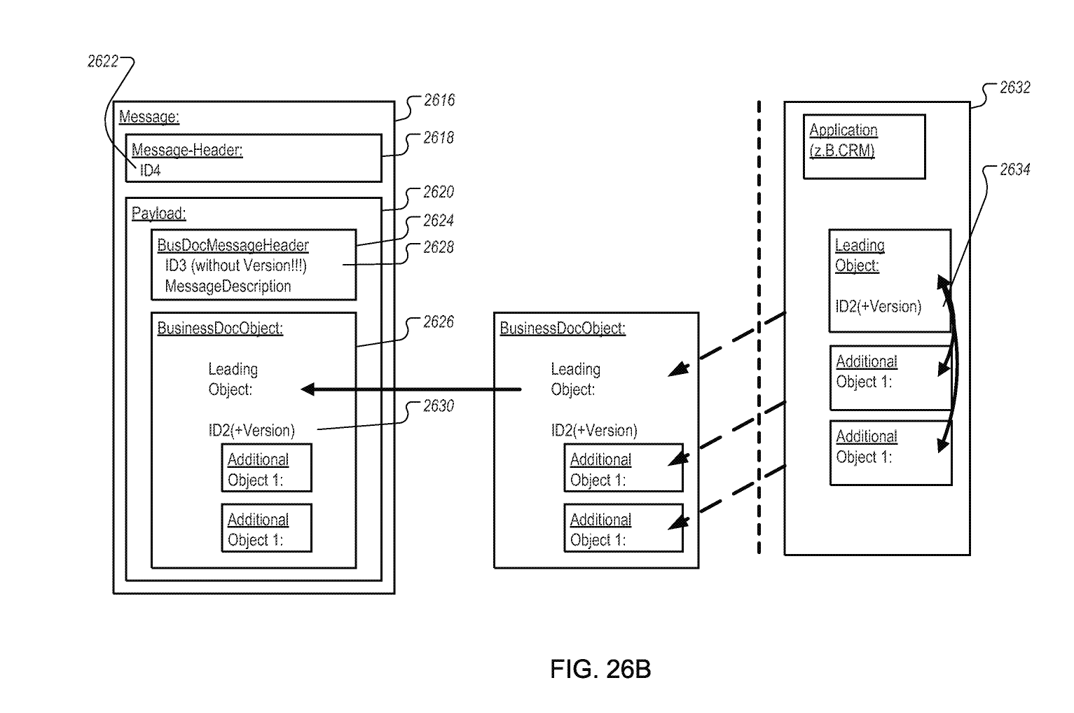

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

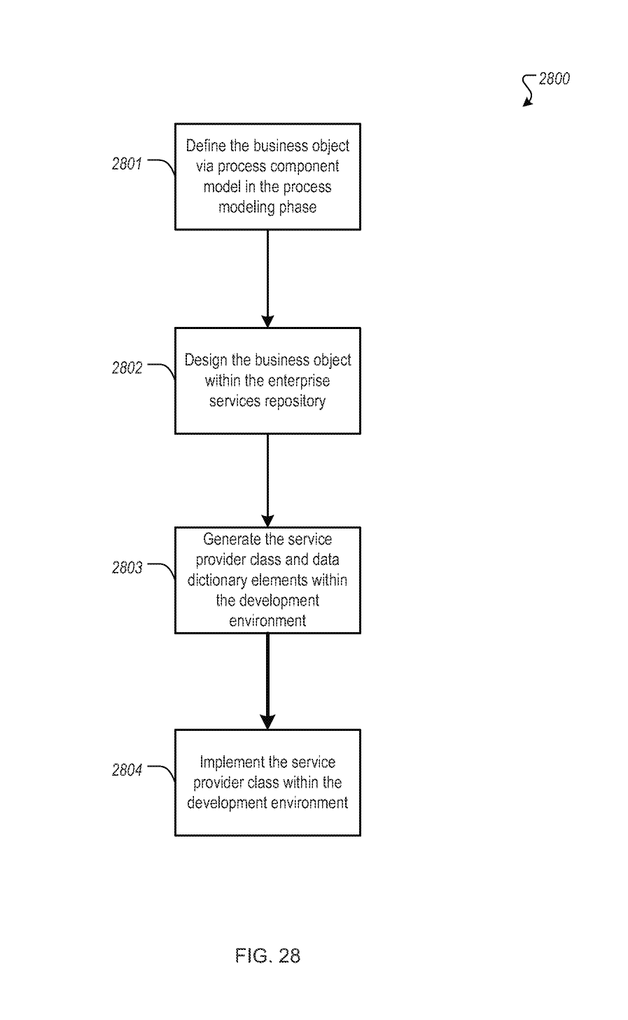

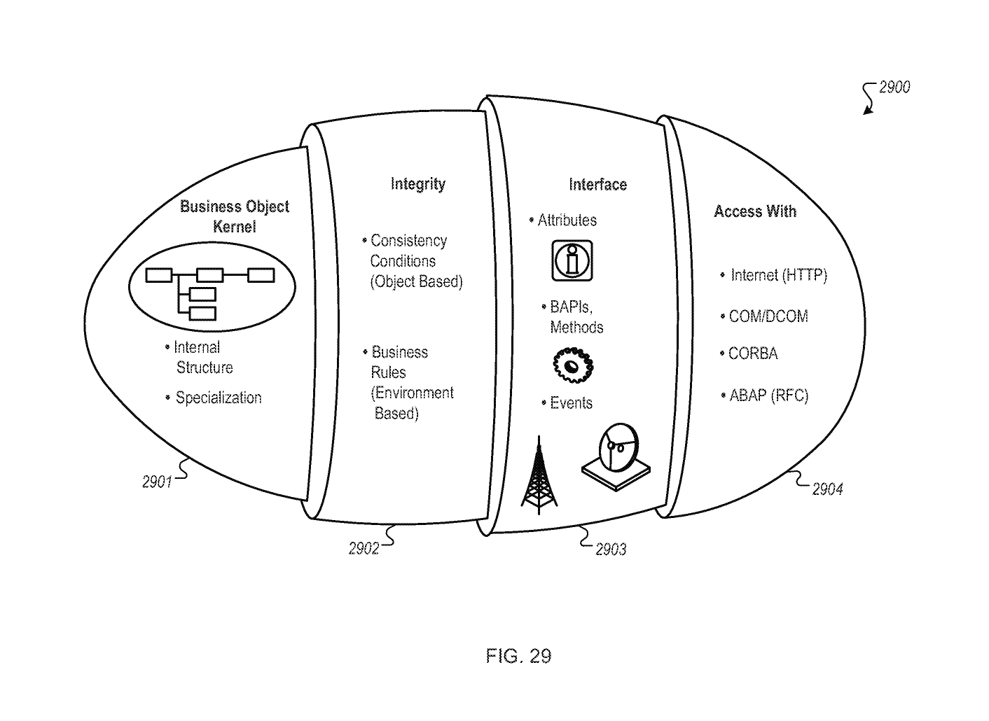

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

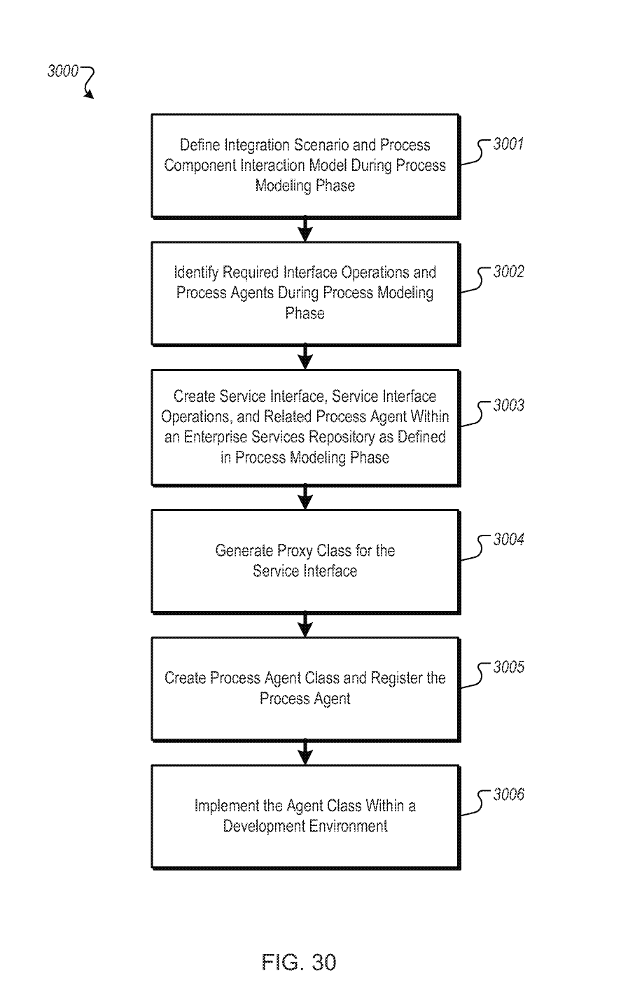

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

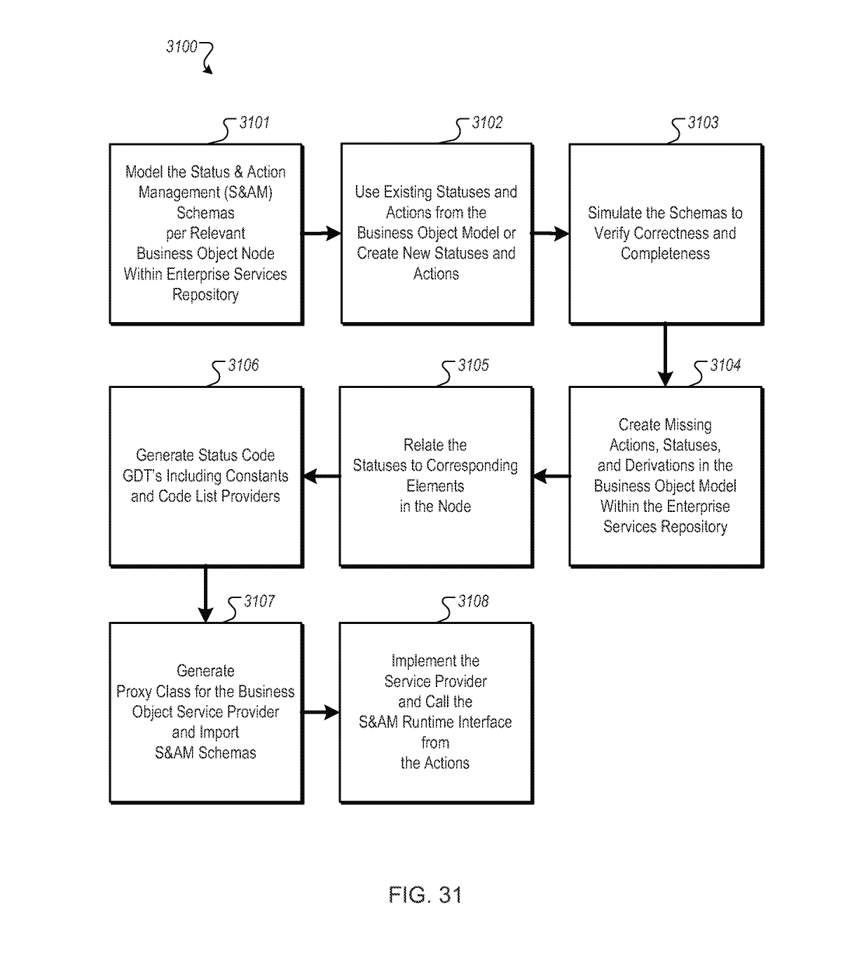

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

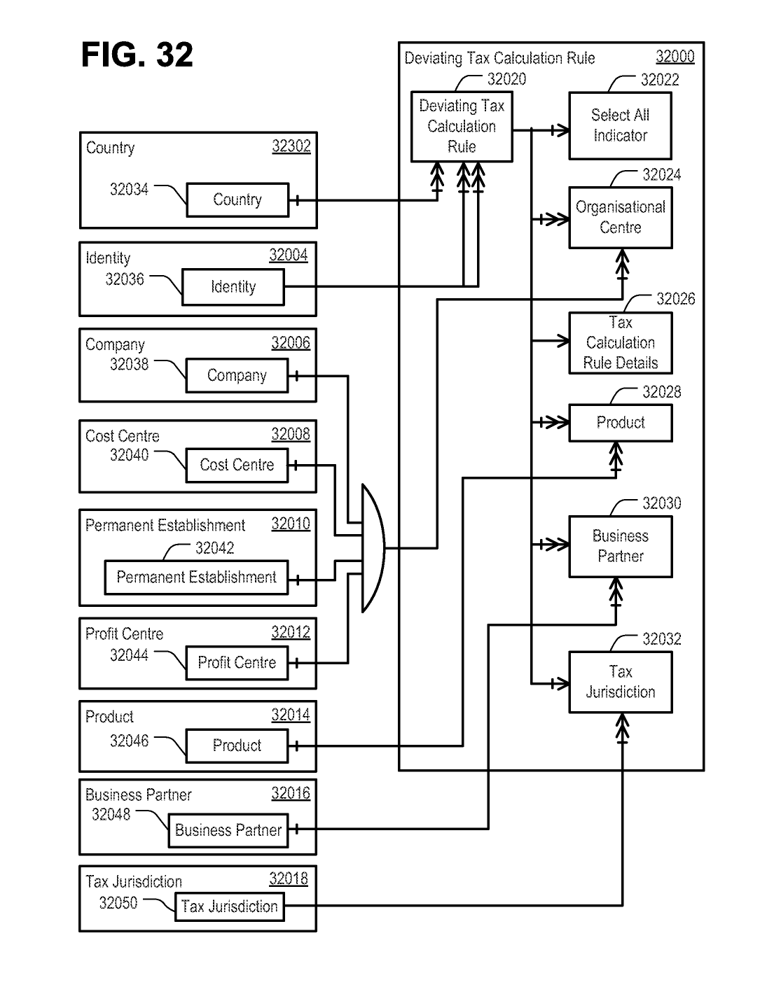

FIG. 32 illustrates an example object model for a Deviating Tax Calculation Rule business object 32000. Specifically, the object model depicts interactions among various components of the Deviating Tax Calculation Rule business object 32000, as well as external components that interact with the Deviating Tax Calculation Rule business object 32000 (shown here as 32002 through 32018 and 32034 through 32050). The Deviating Tax Calculation Rule business object 32000 includes elements 32020 through 32032, which can be hierarchical, as depicted. For example, the Deviating Tax Calculation Rule entity 32020 hierarchically includes entities Select All Indicator 32022 through Tax Jurisdiction 32032. Some or all of the entities 32020 through 32032 can correspond to packages and/or entities in the message data types described below.

The business object Deviating Tax Calculation Rule may be the same as (e.g., may also be known as) a business object Tax Exemption Rule. The business object Tax Exemption Rule is a rule for a deviating tax calculation for a specific product, business partner, and/or organizational unit for a tax jurisdiction country, region or municipality. The Tax Exemption Rule business object belongs to the process component Pricing Engine. The Tax Exemption Rule business object belongs to the deployment unit Foundation. The business object Tax Exemption Rule includes tax rates, tax base rates, and additional taxation attributes and parameters for specified combinations of tax type, product, business partner, business residence and jurisdiction. The business object Tax Exemption Rule has an object category of Master Data Object and a technical category of Standard Business Object.

The business object Tax Exemption Rule can include a Root node. The elements located directly at the node Deviating Tax Calculation Rule are defined by the inline structure GLO_S_DTCR_ROOT_EL. These elements include: UUID, DeviatingTaxCalculationRuleID, TaxTypeCode, CountryCode, ValidFromDate, ValidToDate, and SystemAdministrativeData. UUID may be optional, may be an alternative key, and may be based on datatype GDT: UUID. DeviatingTaxCalculationRuleID may be optional, may be an alternative key, is a semantic key of a deviating tax calculation rule, and may be based on datatype GDT: DeviatingTaxCalculationRuleID. TaxTypeCode may be optional, is a coded representation of a tax type to which a deviating tax rule is assigned, and may be based on datatype GDT: TaxTypeCode. CountryCode may be optional, is a name of a country for which a Deviating Tax Rule is maintained, and may be based on datatype GDT: CountryCode. ValidFromDate may be optional, is a date from which a Deviating Tax Rule is valid, and may be based on datatype GDT: Date. ValidToDate may be optional, is a date to which a deviating tax rule is valid, and may be based on datatype GDT: Date. SystemAdministrativeData may be optional and may be based on datatype GDT: SystemAdministrativeData.

The following composition relationships to subordinate nodes exist: Select All Indicator, with a cardinality of 1:C; Organisational Centre, with a cardinality of 1:CN; Tax Calculation Rule Details, with a cardinality of 1:1; Product, with a cardinality of 1:CN; Business Partner, with a cardinality of 1:CN; and Tax Jurisdiction, with a cardinality of 1:C. The following inbound association relationships may exist: Country Code, from the business object Country/node Country, with a cardinality of C:CN; Creation Identity, from the business object Identity/node Identity, with a cardinality of 1:CN; and Last Change Identity, from the business object Identity/node Identity, with a cardinality of 1:CN.

A Select All query can be used to select all instances of the Root node. A Query By DeviatingTaxID query can be used to select instances based on a specified identifier. The query elements are defined by the inline structure DTCR_ROOT_QUERY_DEVIATINGTAXID. These elements include DeviatingTaxID, which may be based on datatype GDT: DeviatingTaxCalculationRuleID.

A Query By Elements query can be used to select instances based on specified query elements. The query elements are defined by the inline structure DTCR_ROOT_QEL. These elements include: UUID, DeviatingTaxID, ValidFromDate, CountryCode, TaxTypeCode, ValidToDate, ProductKey, TaxJurisdictionCode, OrganisationalCentreID, OrganisationalCentreTypeCode, BusinessPartnerRoleCode, and BusinessPartnerID. UUID may be based on datatype GDT: UUID. DeviatingTaxID may be based on datatype GDT: DeviatingTaxCalculationRuleID. ValidFromDate may be based on datatype GDT: Date. CountryCode may be based on datatype GDT: CountryCode. TaxTypeCode may be based on datatype GDT: TaxTypeCode. ValidToDate may be based on datatype GDT: Date. ProductKey may be based on datatype KDT: ProductKey. ProductKey may include ProductTypeCode, ProductidentifierTypeCode, and ProductID. ProductKey/ProductTypeCode is a coded representation of a product type, such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. TaxJurisdictionCode may be based on datatype GDT: TaxJurisdictionCode. OrganisationalCentreID may be based on datatype GDT: OrganisationalCentreID. OrganisationalCentreTypeCode may be based on datatype GDT: ORGANISATIONALCENTRE_PartyBusinessCharacterCode. BusinessPartnerRoleCode may be based on datatype GDT: BusinessPartnerRoleCode. BusinessPartnerID may be based on datatype GDT: BusinessPartnerID.

Select All Indicator is a subordinate node. The elements located directly at the node Select All Indicator are defined by the inline structure DTCR_SEL_ALL_IND_EL. These elements include: SelectAllServicesIndicator, SelectAllProductsIndicator, SelectAllBusinessPartnersIndicator, and SelectAllOrganisationalUnitsIndicator. SelectAllServicesIndicator may be optional and may be based on datatype GDT: Indicator. SelectAllProductsIndicator may be optional and may be based on datatype GDT: Indicator. SelectAllBusinessPartnersIndicator may be optional and may be based on datatype GDT: Indicator. SelectAllOrganisationalUnitsIndicator may be optional and may be based on datatype GDT: Indicator. The following specialization associations for navigation may exist to the node Deviating Tax Calculation Rule: Parent, with a target cardinality of 1; and Root, with a target cardinality of 1.

Organisational Centre is a subordinate note. The elements located directly at the node Organisational Centre are defined by the inline structure GLO_S_DTCR_ORGUNIT_EL. These elements include: OrganisationalCentreID, OrganisationalCentreTypeCode, and OrganisationalCentreUUID. OrganisationalCentreID may be optional and may be based on datatype GDT: OrganisationalCentreID. OrganisationalCentreTypeCode may be optional and may be based on datatype GDT: ORGANISATIONALCENTRE_PartyBusinessCharacterCode. OrganisationalCentreUUID may be optional and may be based on datatype GDT: UUID. The following inbound association relationships may exist: Company, from the business object Company/node Company, with a cardinality of C:CN; Cost Centre, from the business object Cost Centre/node Cost Centre, with a cardinality of C:CN; Perm Establishment, from the business object Permanent Establishment/node Permanent Establishment, with a cardinality of C:CN; and Profit Centre, from the business object Profit Centre/node Profit Centre, with a cardinality of C:CN. The following specialization associations for navigation may exist to the node Deviating Tax Calculation Rule: Parent, with a target cardinality of 1; and Root, with a target cardinality of 1. A Select All query can be used to select all instances of the node.

Tax Calculation Rule Details includes details of a tax calculation rule which can vary depending on a selected condition. The elements located directly at the node Tax Calculation Rule Details are defined by the inline structure GLO_S_DTCR_TAXCALCRULE_EL. These elements include: TaxRatePercent, TaxBaseRatePercent, ExemptionReasonDescription, and UUID. TaxRatePercent may be optional and may be based on datatype GDT: Percent, with a qualifier of TaxRate. TaxBaseRatePercent may be optional and may be based on datatype GDT: Percent. ExemptionReasonDescription may be optional and may be based on datatype GDT: LONG_Description, with a qualifier of TaxExemptionReason. UUID may be optional, may be an alternative key, and may be based on datatype GDT: UUID. The following specialization associations for navigation may exist to the node Deviating Tax Calculation Rule: Parent, with a target cardinality of 1; and Root, with a target cardinality of 1. A Select All query can be used to select all instances of the node.

Product represents a product to which a deviating tax calculation rule applies. The elements located directly at the node Product are defined by the inline structure GLO_S_DTCR_PRODUCT_EL. These elements include: ProductUUID and ProductKey. ProductUUID may be optional, is a unique identifier of a product to which a deviating tax rule is applied, and may be based on datatype GDT: UUID. ProductKey may be optional and may be based on datatype KDT: ProductKey. ProductKey may include ProductTypeCode, ProductidentifierTypeCode, and ProductID. ProductKey/ProductTypeCode may be optional, is a coded representation of a product type, such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. The following inbound association relationships may exist: Product, from the business object Product/node Root, with a cardinality of C:CN. The following specialization associations for navigation may exist to the node Deviating Tax Calculation Rule: Parent, with a target cardinality of 1; and Root, with a target cardinality of 1. A Select All query can be used to select all instances of the node.

Business Partner represents a business partner to which a deviating tax calculation rule applies. The elements located directly at the node Business Partner are defined by the inline structure GLO_S_DTCR_BP_EL. These elements include: BusinessPartnerID, BusinessPartnerUUID, and BusinessPartnerRoleCode. BusinessPartnerID may be optional, is an identifier of a business partner to which a deviating tax rule is applicable, and may be based on datatype GDT: BusinessPartnerID. BusinessPartnerUUID may be optional, is a unique identifier of a business partner to which a deviating tax rule is applicable, and may be based on datatype GDT: UUID. BusinessPartnerRoleCode may be optional and may be based on datatype GDT: BusinessPartnerRoleCode. A Business Partner inbound association relationship may exist from the business object Business Partner/node Business Partner, with a cardinality of C:CN. The following specialization associations for navigation may exist to the node Deviating Tax Calculation Rule: Parent, with a target cardinality of 1; and Root, with a target cardinality of 1. A Select All query can be used to select all instances of the node.

Tax Jurisdiction represents a tax jurisdiction to which a deviating tax calculation rule applies. The elements located directly at the node Tax Jurisdiction are defined by the inline structure GLO_S_DTCR_TAXJURIS_EL. These elements include: UUID, TaxJurisdictionCode, CountryCode, and TaxJurisdictionKey. UUID may be optional, may be an alternative key, and may be based on datatype GDT: UUID. TaxJurisdictionCode may be optional and may be based on datatype GDT: TaxJurisdictionCode. CountryCode may be optional and may be based on datatype GDT: CountryCode. TaxJurisdictionKey may be based on datatype KDT: TaxJurisdictionKey. TaxJurisdictionKey may include TaxJurisdictionKey/CountryCode, which may be optional, is a coded representation of a country in ISO format alpha-2 for tax calculation, and may be based on datatype GDT: CountryCode. TaxJurisdictionKey may include TaxJurisdictionKey/Code, which is a coded representation of a geographical area where certain political or administrative authorities levy taxes, and may be based on datatype GDT: TaxJurisdictionCode. A Tax Jurisdiction inbound association relationship may exist from the business object Configuration Tax Jurisdiction/node Tax Jurisdiction, with a cardinality of 1:CN. The following specialization associations for navigation may exist to the node Deviating Tax Calculation Rule: Parent, with a target cardinality of 1; and Root, with a target cardinality of 1. A Select All query can be used to select all instances of the node.

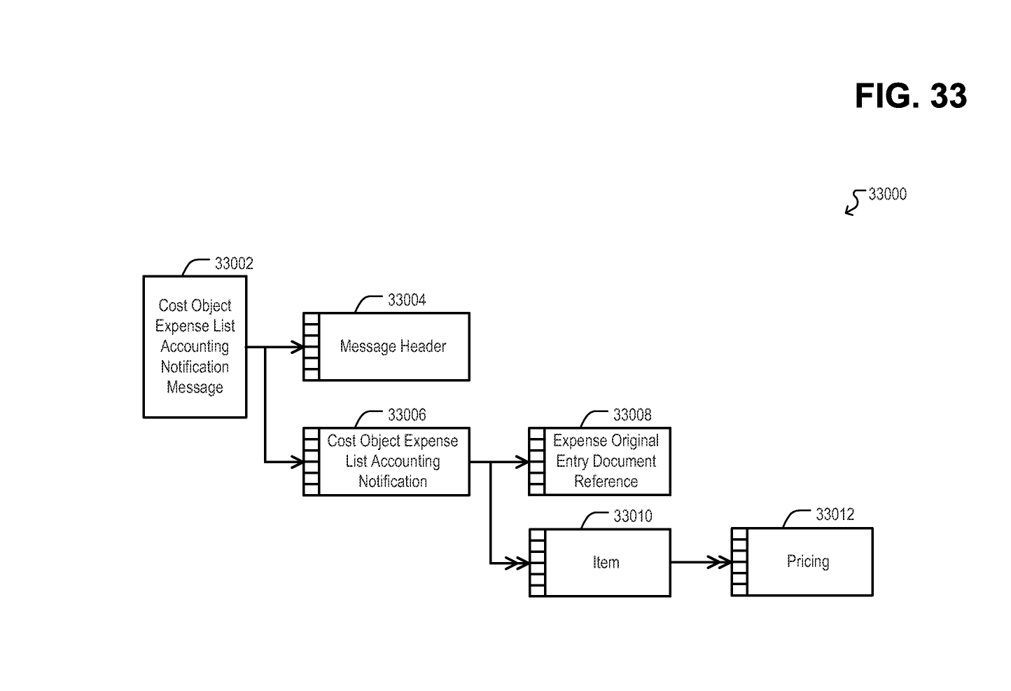

FIG. 33 illustrates one example logical configuration of a Cost Object Expense List Accounting Notification message 33000. Specifically, this figure depicts the arrangement and hierarchy of various components such as one or more levels of packages, entities, and data types, shown here as 33002 through 33012. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Cost Object Expense List Accounting Notification message 33000 includes, among other things, the Expense Original Entry Document Reference entity 33008. Accordingly, heterogeneous applications may communicate using this consistent message configured as such.

The message type Cost Object Expense List Accounting Notification is derived from the business object Customer Project Expense List as a leading object together with its operation signature. The message type Cost Object Expense List Accounting Notification is a notification about expenses arising from and collected during a customer project, where the notification includes information about how the expenses are to be invoiced or have been invoiced to the customer. The structure of the message type Cost Object Expense List Accounting Notification is determined by the message data type CostObjectExpenseListAccountingNotificationMessage. The message data type CostObjectExpenseListAccountingNotificationMessage includes the MessageHeader package and the CostObjectExpenseListAccountingNotification package. The package MessageHeader includes the sub-packages Party and Business Scope and the entity MessageHeader. MessageHeader is typed by BusinessDocumentMessageHeader.

The package CostObjectExpenseListAccountingNotification includes the sub-packages ExpenseOriginalEntryDocumentReference and Item and the entity CostObjectExpenseListAccountingNotification. CostObjectExpenseListAccountingNotification includes the following attributes: reconciliationPeriodCounterValue and itemListCompleteTransmissionIndicator. The attribute reconciliationPeriodCounterValue may have a multiplicity of 1 and may be based on datatype BGDT:CounterValue. The attribute itemListCompleteTransmissionIndicator may have a multiplicity of 1 and may be based on datatype CDT:Indicator, with a qualifier of CompleteTransmission. CostObjectExpenseListAccountingNotification includes the following non-node elements: OperationalDocumentIncludingBusinessObjectReference, OperationalDocumentReference, OperationalDocumentTransactionUUID, CompanyID, AccountingBusinessTransactionDateTime, CostObjectReference, CostObjectReference, CostObjectItemReference, TotalAmount, TotalQuantity, and TotalQuantityTypeCode. OperationalDocumentIncludingBusinessObjectReference may have a multiplicity of 1 and may be based on datatype AGDT:ObjectNodeReference. OperationalDocumentReference may have a multiplicity of 1 and may be based on datatype AGDT:ObjectNodeReference. OperationalDocumentTransactionUUID may have a multiplicity of 1 and may be based on datatype BGDT:UUID. CompanyID may have a multiplicity of 1 and may be based on datatype BGDT:OrganisationalCentreID. AccountingBusinessTransactionDateTime may have a multiplicity of 1 and may be based on datatype CDT:GLOBAL_DateTime. CostObjectReference may have a multiplicity of 1 and may be based on datatype MIDT:CostObjectExpenseListAccountingNotificationCostObjectReference. CostObjectReference may include a CostObjectReference subitem, which may have a multiplicity of 1 and may be based on datatype AGDT:ObjectNodeReference. CostObjectReference may include a CostObjectItemReference subitem, which may have a multiplicity of 1 and may be based on datatype AGDT:ObjectNodeReference. TotalAmount may have a multiplicity of 0 . . . 1 and may be based on datatype CDT:Amount. TotalQuantity may have a multiplicity of 0 . . . 1 and may be based on datatype CDT:Quantity. TotalQuantityTypeCode may have a multiplicity of 0 . . . 1 and may be based on datatype BGDT:QuantityTypeCode. CostObjectExpenseListAccountingNotification includes the following node elements: ExpenseOriginalEntryDocumentReference, in a 1:1 cardinality relationship; and Item, in a 1:N cardinality relationship.

The package CostObjectExpenseListAccountingNotificationExpenseOriginalEntryDocumentReference includes the entity ExpenseOriginalEntryDocumentReference. ExpenseOriginalEntryDocumentReference includes the following non-node elements: ExpenseOriginalEntryDocumentIncludingBusinessObjectReference, ExpenseOriginalEntryDocumentReference, ExpenseOriginalEntryDocumentTransactionUUID, and ExpenseOriginalEntryDocumentItemReference. ExpenseOriginalEntryDocumentIncludingBusinessObjectReference may have a multiplicity of 0 . . . 1 and may be based on datatype AGDT:ObjectNodeReference. ExpenseOriginalEntryDocumentReference may have a multiplicity of 1 and may be based on datatype AGDT:ObjectNodeReference. ExpenseOriginalEntryDocumentTransactionUUID may have a multiplicity of 0 . . . 1 and may be based on datatype BGDT:UUID. ExpenseOriginalEntryDocumentItemReference may have a multiplicity of 1 and may be based on datatype AGDT:ObjectNodeReference.

The package CostObjectExpenseListAccountingNotificationItem includes the sub-package Pricing and the entity Item. Item includes the actionCode attribute, which may have a multiplicity of 1 and may be based on datatype BGDT:ActionCode. Item includes the following non-node elements: OperationalDocumentItemReference, SalesOrderReference, CancelledIndicator, NotToBeInvoicedIndicator, ExcessIndicator, Quantity, QuantityTypeCode, Amount, InvoicingCostObjectReference, and CustomerInvoiceReference. OperationalDocumentItemReference may have a multiplicity of 1, is a reference to customer project expense list expense document item accounting information in Customer Project Invoice Preparation, and may be based on datatype AGDT:ObjectNodeReference. SalesOrderReference may have a multiplicity of 1 and may be based on datatype MIDT:CostObjectExpenseListAccountingNotificationSalesOrderReference. SalesOrderReference may include a subitem SalesOrderReference, which may have a multiplicity of 1 and may be based on datatype AGDT:ObjectNodeReference. SalesOrderReference may include a subitem SalesOrderItemReference, which may have a multiplicity of 1 and may be based on datatype AGDT:ObjectNodeReference. CancelledIndicator may have a multiplicity of 1, indicates whether a customer project expense list accounting notification item is cancelled, and may be based on datatype CDT:Indicator, with a qualifier of Cancelled. NotToBeInvoicedIndicator may have a multiplicity of 1, indicates whether a customer project expense list accounting notification item is not to be invoiced, and may be based on datatype CDT:Indicator. ExcessIndicator may have a multiplicity of 1, is an indicator that specifies whether a quantity or amount of an expense document item split for which a customer project expense list accounting notification item was created exceeds a total quantity or amount of a corresponding item, and may be based on datatype CDT:Indicator, with a qualifier of Excess. Quantity may have a multiplicity of 0 . . . 1, is a quantity of an incurred expense which is assigned to a customer project expense list accounting notification item, and may be based on datatype CDT:Quantity. QuantityTypeCode may have a multiplicity of 0 . . . 1, is a coded representation of a type of a quantity assigned to a customer project expense list accounting notification item, and may be based on datatype BGDT:QuantityTypeCode. Amount may have a multiplicity of 0 . . . 1, is an amount of an incurred expense which is assigned to a customer project expense list accounting notification item, and may be based on datatype CDT:Amount. InvoicingCostObjectReference may have a multiplicity of 0 . . . 1, is a reference to a customer project task which is assigned to a sales order item during an invoicing process, and may be based on datatype MIDT:CostObjectExpenseListAccountingNotificationInvoicingCostObjectReference. InvoicingCostObjectReference may include a subitem InvoicingCostObjectReference, which may have a multiplicity of 1 and may be based on datatype AGDT:ObjectNodeReference. InvoicingCostObjectReference may include a subitem InvoicingCostObjectItemReference, which may have a multiplicity of 1 and may be based on datatype AGDT:ObjectNodeReference. CustomerInvoiceReference may have a multiplicity of 0 . . . 1, is a reference to a customer invoice for a customer project expense list accounting notification item, and may be based on datatype MIDT:CostObjectExpenseListAccountingNotificationCustomernvoiceReference. CustomerInvoiceReference may include a subitem CustomerInvoiceReference, which may have a multiplicity of 1 and may be based on datatype AGDT:ObjectNodeReference. CustomerInvoiceReference may include a subitem CustomerInvoiceItemReference, which may have a multiplicity of 1 and may be based on datatype AGDT:ObjectNodeReference. Item includes the following node elements: Pricing, in a 1:N cardinality relationship.

The package CostObjectExpenseListAccountingNotificationItemPricing includes the entity Pricing. Pricing includes price specification element information for a customer project expense list accounting notification item. Pricing includes the following non-node elements: PriceSpecificationElementCategoryCode, PriceSpecificationElementPurposeCode, and CalculatedAmount. PriceSpecificationElementCategoryCode may have a multiplicity of 0 . . . 1 and may be based on datatype BGDT:PriceSpecificationElementCategoryCode. PriceSpecificationElementPurposeCode may have a multiplicity of 0 . . . 1 and may be based on datatype BGDT:PriceSpecificationElementPurposeCode. CalculatedAmount may have a multiplicity of 1 and may be based on datatype CDT:Amount.

The business object Customer Project Expense List is a list of expenses arising from and collected during a customer project which includes information about how the expenses are to be invoiced or have been invoiced to the customer. The Customer Project Expense List business object belongs to the process component Customer Project Invoice Preparation. The Customer Project Expense List business object belongs to the deployment unit Project Management. Expenses can, for example, be caused by services provided or materials consumed against a project task. A person creating an invoice can decide which expenses can be partially or completely invoiced to a customer, and how they are invoiced, for example, based on which sales order and as which service. In addition, Customer Project Expense List can keep track of invoicing decisions by tracking sales order and service product assignments. Expenses collected in a CustomerProjectExpenseList can be used to detail an invoice. Information that is used to create an invoice can be used by the business object CustomerProjectInvoiceRequisition. A customer project expense list can include items representing expenses accounted to a customer project task, split items with information about how to invoice an item, and item accounting information concerning realized revenues for expense items. The business object Customer Project Expense List has an object category of Business Transaction Document and a technical category of Standard Business Object. The business object Customer Project Expense List is involved in the following Process Component Interactions: Customer Project Invoice Preparation_Accounting_Expense List.

A service interface Cost Object Expense List Accounting Out has a technical name of CostObjectExpenseListAccountingOut. The service interface Cost Object Expense List Accounting Out is part of the process component interaction Customer Project Invoice Preparation_Accounting_Expense List, and is an interface to notify Accounting about a creation or update of a cost object expense list. A Notify of Customer Project Expense List operation has a technical name of CostObjectExpenseListAccountingOut.NotifyOfCustomerProjectExpenseList, can be used to notify Accounting about a creation or update of a customer project expense list, is based on a message type Cost Object Expense List Accounting Notification that is derived from the business object Customer Project Expense List, and can be used to notify accounting regarding expected revenues, a customer invoice reference, and an invoicing project task linkage on splits of a Customer Project Expense List.

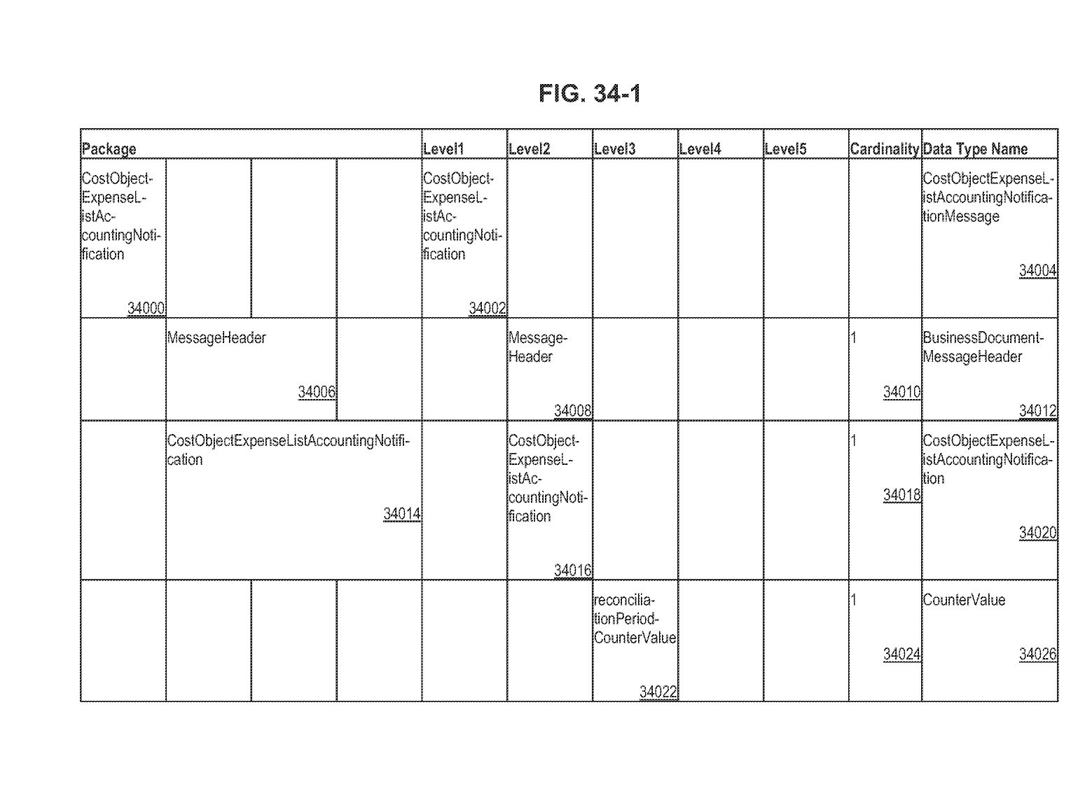

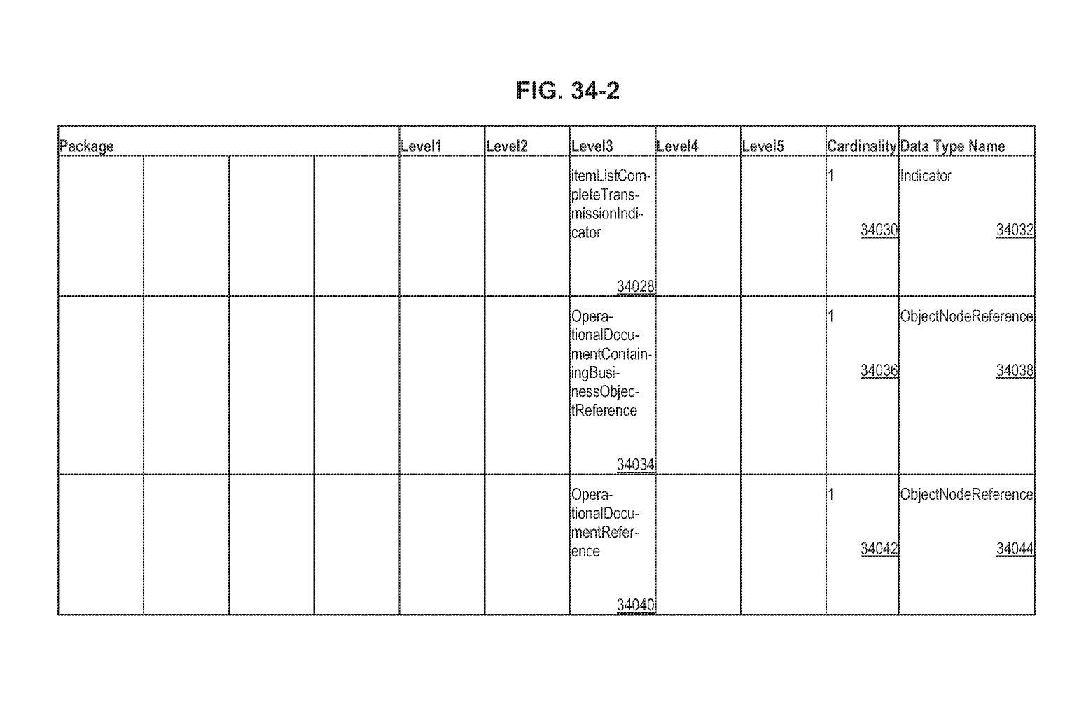

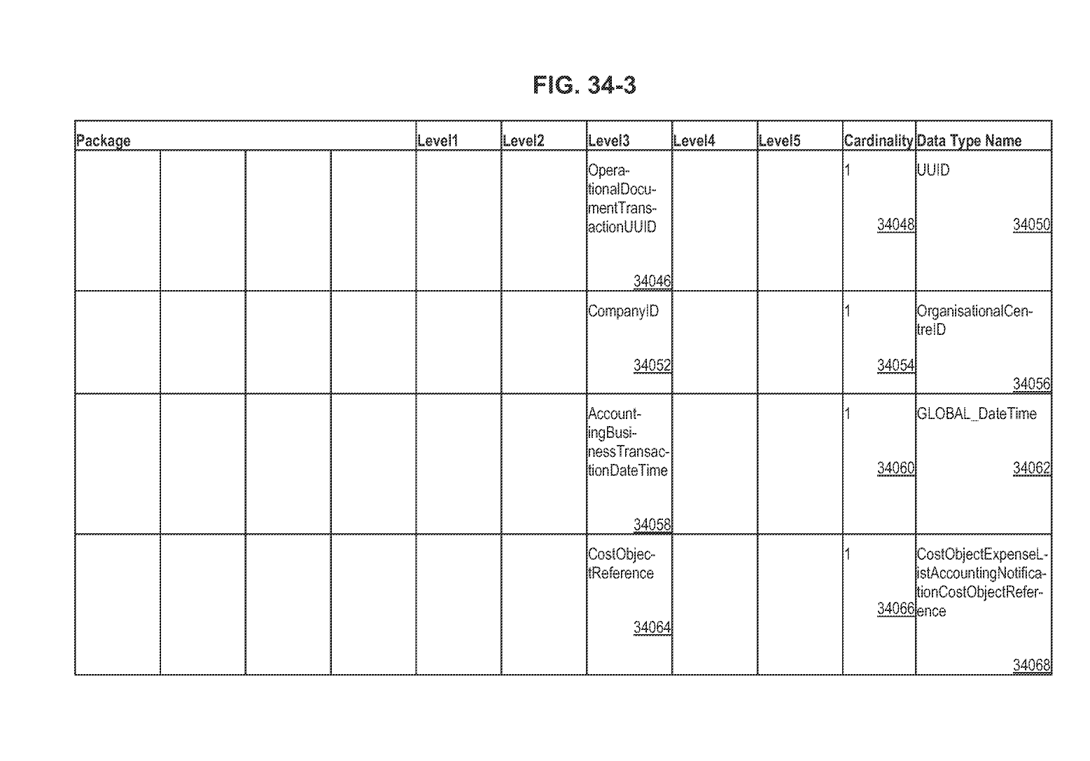

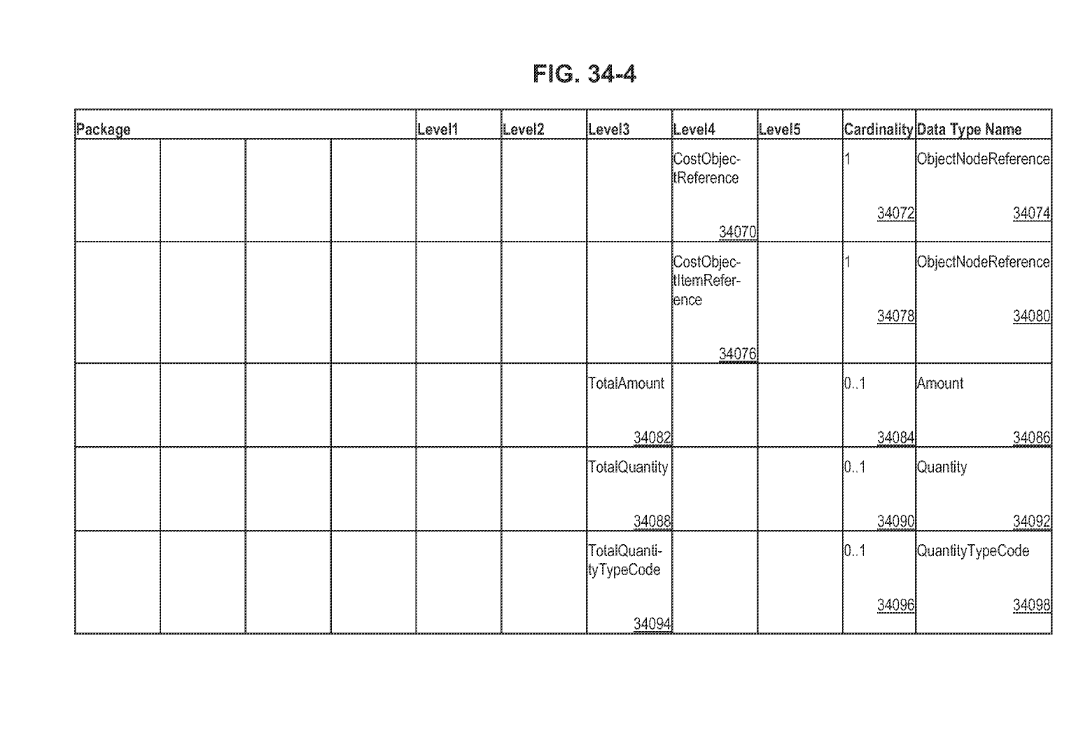

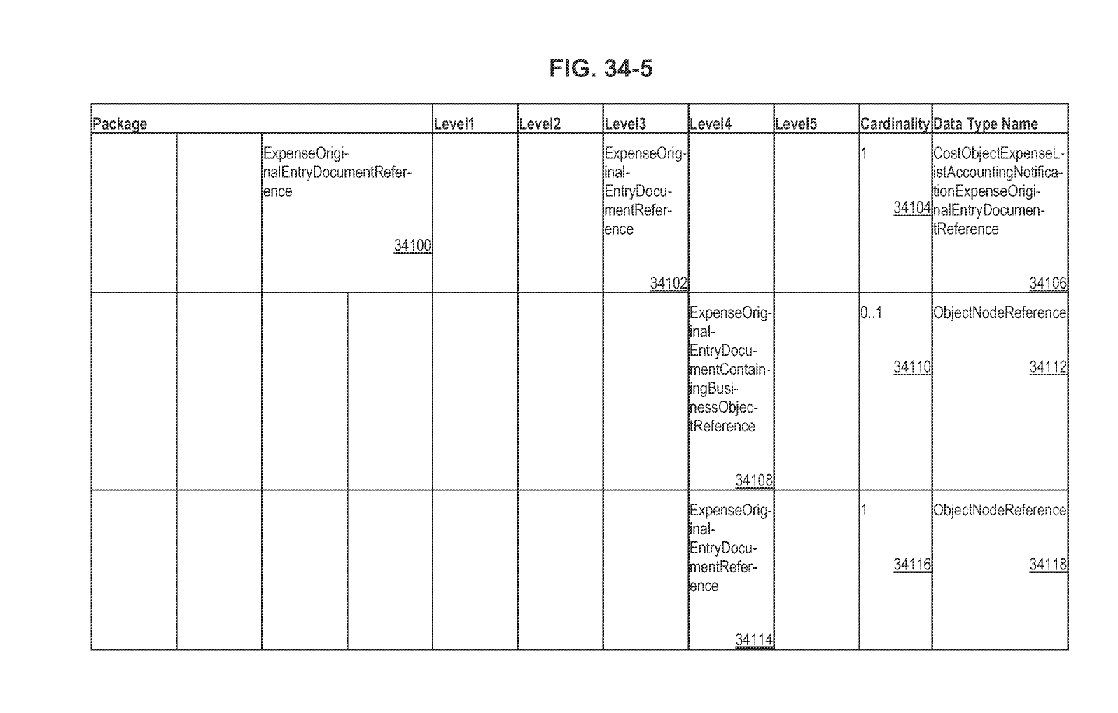

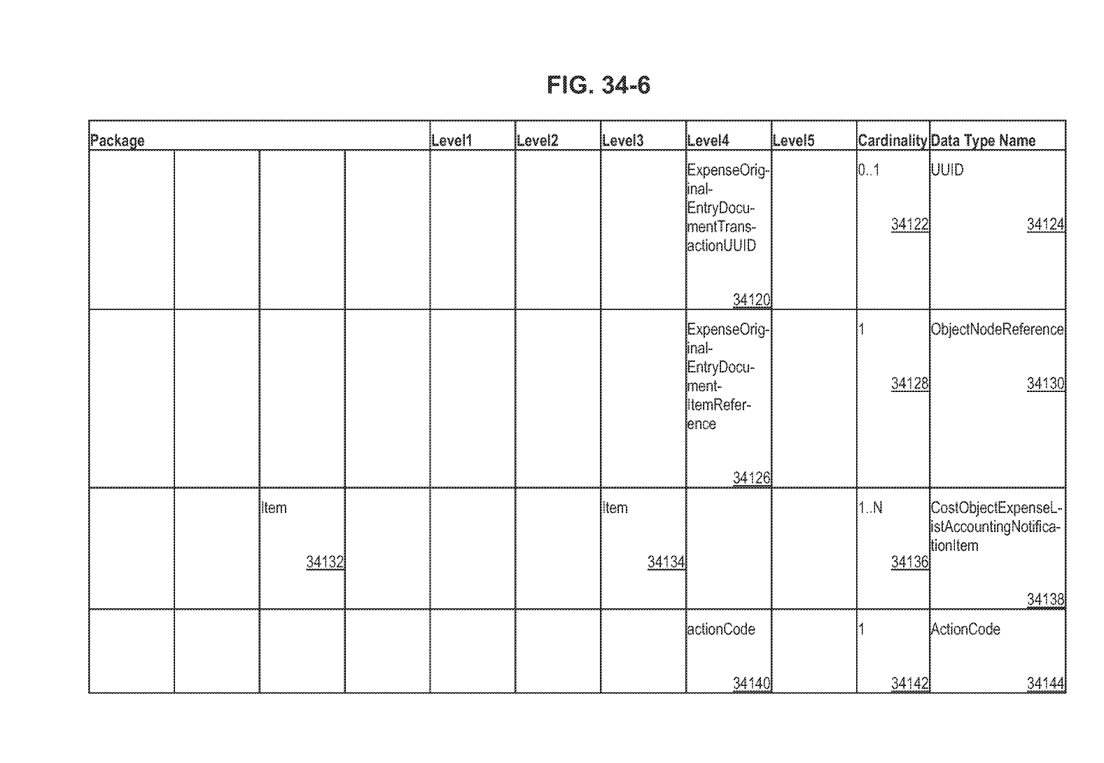

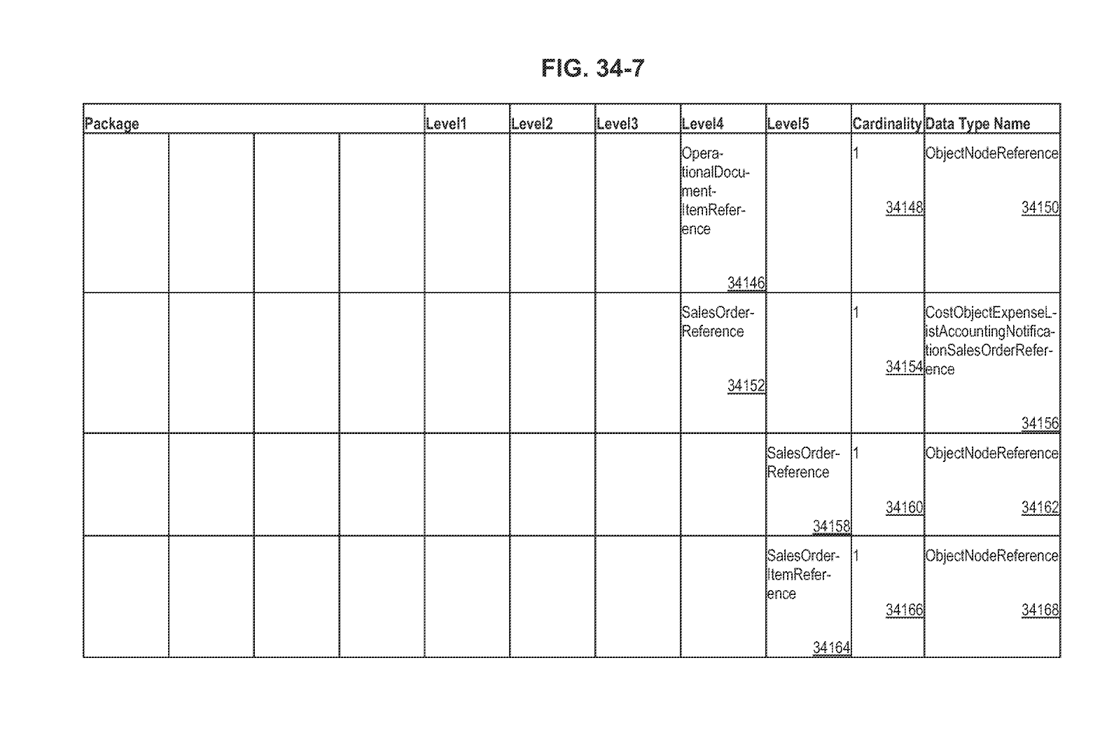

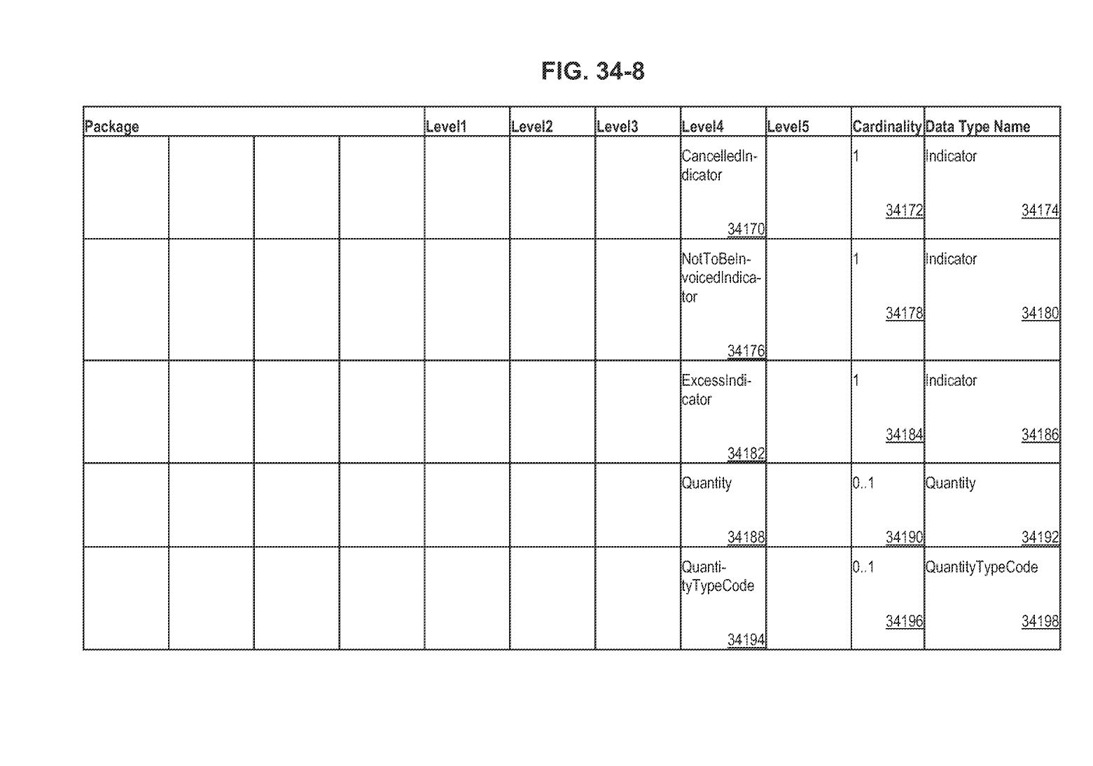

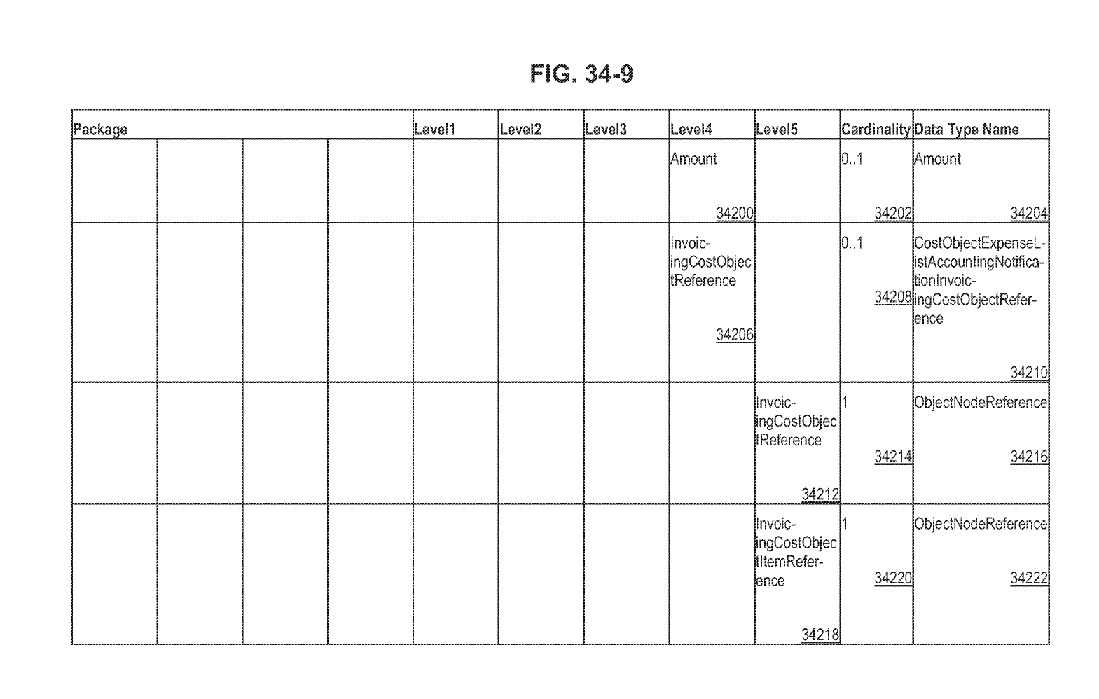

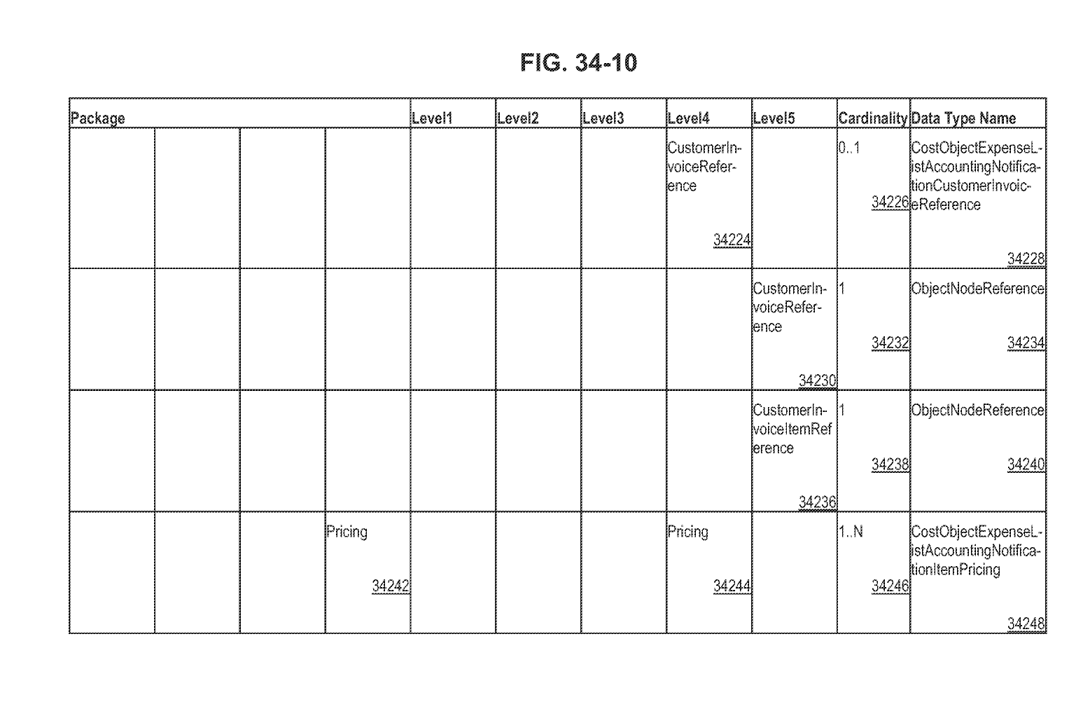

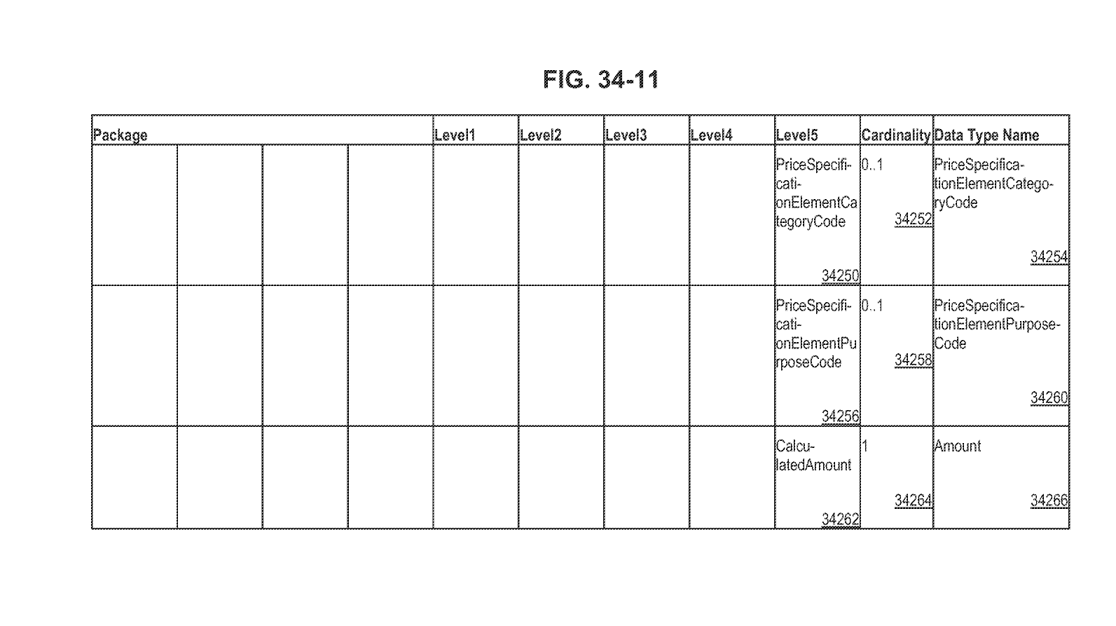

FIGS. 34-1 through 34-11 show an example configuration of an Element Structure that includes a CostObjectExpenseListAccountingNotification 34000 package. Specifically, these figures depict the arrangement and hierarchy of various components such as one or more levels of packages, entities, and datatypes, shown here as 34000 through 34266. As described above, packages may be used to represent hierarchy levels. Entities are discrete business elements that are used during a business transaction. Data types are used to type object entities and interfaces with a structure. For example, the CostObjectExpenseListAccountingNotification 34000 includes, among other things, a CostObjectExpenseListAccountingNotification 34002. Accordingly, heterogeneous applications may communicate using this consistent message configured as such.

The CostObjectExpenseListAccountingNotification 34000 package is a CostObjectExpenseListAccountingNotificationMessage 34004 data type. The CostObjectExpenseListAccountingNotification 34000 package includes a CostObjectExpenseListAccountingNotification 34002 entity. The CostObjectExpenseListAccountingNotification 34000 package includes various packages, namely a MessageHeader 34006 and a CostObjectExpenseListAccountingNotification 34014.

The MessageHeader 34006 package is a BusinessDocumentMessageHeader 34012 data type. The MessageHeader 34006 package includes a MessageHeader 34008 entity. The MessageHeader 34008 entity has a cardinality of 1 34010 meaning that for each instance of the MessageHeader 34006 package there is one MessageHeader 34008 entity.

The CostObjectExpenseListAccountingNotification 34014 package is a CostObjectExpenseListAccountingNotification 34020 data type. The CostObjectExpenseListAccountingNotification 34014 package includes a CostObjectExpenseListAccountingNotification 34016 entity. The CostObjectExpenseListAccountingNotification 34014 package includes various packages, namely an ExpenseOriginalEntryDocumentReference 34100 and an Item 34132.

The CostObjectExpenseListAccountingNotification 34016 entity has a cardinality of 1 34018 meaning that for each instance of the CostObjectExpenseListAccountingNotification 34014 package there is one CostObjectExpenseListAccountingNotification 34016 entity. The CostObjectExpenseListAccountingNotification 34016 entity includes various attributes, namely a reconciliationPeriodCounterValue 34022, an itemListCompleteTransmissionIndicator 34028, an OperationalDocumentContainingBusinessObjectReference 34034, an OperationalDocumentReference 34040, an OperationalDocumentTransactionUUID 34046, a CompanyID 34052, an AccountingBusinessTransactionDateTime 34058, a TotalAmount 34082, a TotalQuantity 34088 and a TotalQuantityTypeCode 34094. The CostObjectExpenseListAccountingNotification 34016 entity includes a CostObjectReference 34064 subordinate entity.

The reconciliationPeriodCounterValue 34022 attribute is a CounterValue 34026 data type. The reconciliationPeriodCounterValue 34022 attribute has a cardinality of 1 34024 meaning that for each instance of the CostObjectExpenseListAccountingNotification 34016 entity there is one reconciliationPeriodCounterValue 34022 attribute. The itemListCompleteTransmissionIndicator 34028 attribute is an Indicator 34032 data type. The itemListCompleteTransmissionIndicator 34028 attribute has a cardinality of 1 34030 meaning that for each instance of the CostObjectExpenseListAccountingNotification 34016 entity there is one itemListCompleteTransmissionIndicator 34028 attribute.

The OperationalDocumentContainingBusinessObjectReference 34034 attribute is an ObjectNodeReference 34038 data type. The OperationalDocumentContainingBusinessObjectReference 34034 attribute has a cardinality of 1 34036 meaning that for each instance of the CostObjectExpenseListAccountingNotification 34016 entity there is one OperationalDocumentContainingBusinessObjectReference 34034 attribute. The OperationalDocumentReference 34040 attribute is an ObjectNodeReference 34044 data type. The OperationalDocumentReference 34040 attribute has a cardinality of 1 34042 meaning that for each instance of the CostObjectExpenseListAccountingNotification 34016 entity there is one OperationalDocumentReference 34040 attribute.

The OperationalDocumentTransactionUUID 34046 attribute is an UUID 34050 data type. The OperationalDocumentTransactionUUID 34046 attribute has a cardinality of 1 34048 meaning that for each instance of the CostObjectExpenseListAccountingNotification 34016 entity there is one OperationalDocumentTransactionUUID 34046 attribute. The CompanyID 34052 attribute is an OrganisationalCentreID 34056 data type. The CompanyID 34052 attribute has a cardinality of 1 34054 meaning that for each instance of the CostObjectExpenseListAccountingNotification 34016 entity there is one CompanyID 34052 attribute.

The AccountingBusinessTransactionDateTime 34058 attribute is a GLOBAL_DateTime 34062 data type. The AccountingBusinessTransactionDateTime 34058 attribute has a cardinality of 1 34060 meaning that for each instance of the CostObjectExpenseListAccountingNotification 34016 entity there is one AccountingBusinessTransactionDateTime 34058 attribute. The TotalAmount 34082 attribute is an Amount 34086 data type. The TotalAmount 34082 attribute has a cardinality of 0 . . . 1 34084 meaning that for each instance of the CostObjectExpenseListAccountingNotification 34016 entity there may be one TotalAmount 34082 attribute.

The TotalQuantity 34088 attribute is a Quantity 34092 data type. The TotalQuantity 34088 attribute has a cardinality of 0 . . . 1 34090 meaning that for each instance of the CostObjectExpenseListAccountingNotification 34016 entity there may be one TotalQuantity 34088 attribute. The TotalQuantityTypeCode 34094 attribute is a QuantityTypeCode 34098 data type. The TotalQuantityTypeCode 34094 attribute has a cardinality of 0 . . . 1 34096 meaning that for each instance of the CostObjectExpenseListAccountingNotification 34016 entity there may be one TotalQuantityTypeCode 34094 attribute.

The CostObjectReference 34064 entity has a cardinality of 1 34066 meaning that for each instance of the CostObjectExpenseListAccountingNotification 34016 entity there is one CostObjectReference 34064 entity. The CostObjectReference 34064 entity includes various attributes, namely a CostObjectReference 34070 and a CostObjectItemReference 34076. The CostObjectReference 34070 attribute is an ObjectNodeReference 34074 data type. The CostObjectReference 34070 attribute has a cardinality of 1 34072 meaning that for each instance of the CostObjectReference 34064 entity there is one CostObjectReference 34070 attribute. The CostObjectItemReference 34076 attribute is an ObjectNodeReference 34080 data type. The CostObjectItemReference 34076 attribute has a cardinality of 1 4078 meaning that for each instance of the CostObjectReference 34064 entity there is one CostObjectItemReference 34076 attribute.

The ExpenseOriginalEntryDocumentReference 34100 package is a CostObjectExpenseListAccountingNotificationExpenseOriginalEntryDocumentReference 34106 data type. The ExpenseOriginalEntryDocumentReference 34100 package includes an ExpenseOriginalEntryDocumentReference 34102 entity. The ExpenseOriginalEntryDocumentReference 34102 entity has a cardinality of 1 34104 meaning that for each instance of the ExpenseOriginalEntryDocumentReference 34100 package there is one ExpenseOriginalEntryDocumentReference 34102 entity. The ExpenseOriginalEntryDocumentReference 34102 entity includes various attributes, namely an ExpenseOriginalEntryDocumentContainingBusinessObjectReference 34108, an ExpenseOriginalEntryDocumentReference 34114, an ExpenseOriginalEntryDocumentTransactionUUID 34120 and an ExpenseOriginalEntryDocumentItemReference 34126.

The ExpenseOriginalEntryDocumentContainingBusinessObjectReference 34108 attribute is an ObjectNodeReference 34112 data type. The ExpenseOriginalEntryDocumentContainingBusinessObjectReference 34108 attribute has a cardinality of 0 . . . 1 34110 meaning that for each instance of the ExpenseOriginalEntryDocumentReference 34102 entity there may be one ExpenseOriginalEntryDocumentContainingBusinessObjectReference 34108 attribute. The ExpenseOriginalEntryDocumentReference 34114 attribute is an ObjectNodeReference 34118 data type. The ExpenseOriginalEntryDocumentReference 34114 attribute has a cardinality of 1 34116 meaning that for each instance of the ExpenseOriginalEntryDocumentReference 34102 entity there is one ExpenseOriginalEntryDocumentReference 34114 attribute.

The ExpenseOriginalEntryDocumentTransactionUUID 34120 attribute is an UUID 34124 data type. The ExpenseOriginalEntryDocumentTransactionUUID 34120 attribute has a cardinality of 0 . . . 1 34122 meaning that for each instance of the ExpenseOriginalEntryDocumentReference 34102 entity there may be one ExpenseOriginalEntryDocumentTransactionUUID 34120 attribute. The ExpenseOriginalEntryDocumentItemReference 34126 attribute is an ObjectNodeReference 34130 data type. The ExpenseOriginalEntryDocumentItemReference 34126 attribute has a cardinality of 1 34128 meaning that for each instance of the ExpenseOriginalEntryDocumentReference 34102 entity there is one ExpenseOriginalEntryDocumentItemReference 34126 attribute.

The Item 34132 package is a CostObjectExpenseListAccountingNotificationitem 34138 data type. The Item 34132 package includes an Item 34134 entity. The Item 34132 package includes a Pricing 34242 package. The Item 34134 entity has a cardinality of 1 . . . N 34136 meaning that for each instance of the Item 34132 package there are one or more Item 34134 entities. The Item 34134 entity includes various attributes, namely an actionCode 34140, an OperationalDocumentItemReference 34146, a CancelledIndicator 34170, a NotToBeInvoicedIndicator 34176, an ExcessIndicator 34182, a Quantity 34188, a QuantityTypeCode 34194 and an Amount 34200. The Item 34134 entity includes various subordinate entities, namely a SalesOrderReference 34152, an InvoicingCostObjectReference 34206 and a CustomerInvoiceReference 34224.

The actionCode 34140 attribute is an ActionCode 34144 data type. The actionCode 34140 attribute has a cardinality of 1 34142 meaning that for each instance of the Item 34134 entity there is one actionCode 34140 attribute. The OperationalDocumentItemReference 34146 attribute is an ObjectNodeReference 34150 data type. The OperationalDocumentItemReference 34146 attribute has a cardinality of 1 34148 meaning that for each instance of the Item 34134 entity there is one OperationalDocumentItemReference 34146 attribute.

The CancelledIndicator 34170 attribute is an Indicator 34174 data type. The CancelledIndicator 34170 attribute has a cardinality of 1 34172 meaning that for each instance of the Item 34134 entity there is one CancelledIndicator 34170 attribute. The NotToBeInvoicedIndicator 34176 attribute is an Indicator 34180 data type. The NotToBeInvoicedIndicator 34176 attribute has a cardinality of 1 34178 meaning that for each instance of the Item 34134 entity there is one NotToBeInvoicedIndicator 34176 attribute.

The ExcessIndicator 34182 attribute is an Indicator 34186 data type. The ExcessIndicator 34182 attribute has a cardinality of 1 34184 meaning that for each instance of the Item 34134 entity there is one ExcessIndicator 34182 attribute. The Quantity 34188 attribute is a Quantity 34192 data type. The Quantity 34188 attribute has a cardinality of 0 . . . 1 34190 meaning that for each instance of the Item 34134 entity there may be one Quantity 34188 attribute.

The QuantityTypeCode 34194 attribute is a QuantityTypeCode 34198 data type. The QuantityTypeCode 34194 attribute has a cardinality of 0 . . . 1 34196 meaning that for each instance of the Item 34134 entity there may be one QuantityTypeCode 34194 attribute. The Amount 34200 attribute is an Amount 34204 data type. The Amount 34200 attribute has a cardinality of 0 . . . 1 34202 meaning that for each instance of the Item 34134 entity there may be one Amount 34200 attribute.

The SalesOrderReference 34152 entity has a cardinality of 1 34154 meaning that for each instance of the Item 34134 entity there is one SalesOrderReference 34152 entity. The SalesOrderReference 34152 entity includes various attributes, namely a SalesOrderReference 34158 and a SalesOrderItemReference 34164. The SalesOrderReference 34158 attribute is an ObjectNodeReference 34162 data type. The SalesOrderReference 34158 attribute has a cardinality of 1 34160 meaning that for each instance of the SalesOrderReference 34152 entity there is one SalesOrderReference 34158 attribute. The SalesOrderItemReference 34164 attribute is an ObjectNodeReference 34168 data type. The SalesOrderItemReference 34164 attribute has a cardinality of 1 34166 meaning that for each instance of the SalesOrderReference 34152 entity there is one SalesOrderItemReference 34164 attribute.

The InvoicingCostObjectReference 34206 entity has a cardinality of 0 . . . 1 34208 meaning that for each instance of the Item 34134 entity there may be one InvoicingCostObjectReference 34206 entity. The InvoicingCostObjectReference 34206 entity includes various attributes, namely an InvoicingCostObjectReference 34212 and an InvoicingCostObjectItemReference 34218.

The InvoicingCostObjectReference 34212 attribute is an ObjectNodeReference 34216 data type. The InvoicingCostObjectReference 34212 attribute has a cardinality of 1 34214 meaning that for each instance of the InvoicingCostObjectReference 34206 entity there is one InvoicingCostObjectReference 34212 attribute. The InvoicingCostObjectItemReference 34218 attribute is an ObjectNodeReference 34222 data type. The InvoicingCostObjectItemReference 34218 attribute has a cardinality of 1 34220 meaning that for each instance of the InvoicingCostObjectReference 34206 entity there is one InvoicingCostObjectItemReference 34218 attribute.

The CustomerInvoiceReference 34224 entity has a cardinality of 0 . . . 1 34226 meaning that for each instance of the Item 34134 entity there may be one CustomerInvoiceReference 34224 entity. The CustomerInvoiceReference 34224 entity includes various attributes, namely a CustomerInvoiceReference 34230 and a CustomerInvoiceItemReference 34236.

The CustomerInvoiceReference 34230 attribute is an ObjectNodeReference 34234 data type. The CustomerInvoiceReference 34230 attribute has a cardinality of 1 34232 meaning that for each instance of the CustomerInvoiceReference 34224 entity there is one CustomerInvoiceReference 34230 attribute. The CustomerInvoiceItemReference 34236 attribute is an ObjectNodeReference 34240 data type. The CustomerInvoiceItemReference 34236 attribute has a cardinality of 1 34238 meaning that for each instance of the CustomerInvoiceReference 34224 entity there is one CustomerInvoiceItemReference 34236 attribute.

The Pricing 34242 package is a CostObjectExpenseListAccountingNotificationitemPricing 34248 data type. The Pricing 34242 package includes a Pricing 34244 entity. The Pricing 34244 entity has a cardinality of 1 . . . N 34246 meaning that for each instance of the Pricing 34242 package there are one or more Pricing 34244 entities. The Pricing 34244 entity includes various attributes, namely a PriceSpecificationElementCategoryCode 34250, a PriceSpecificationElementPurposeCode 34256 and a CalculatedAmount 34262.

The PriceSpecificationElementCategoryCode 34250 attribute is a PriceSpecificationElementCategoryCode 34254 data type. The PriceSpecificationElementCategoryCode 34250 attribute has a cardinality of 0 . . . 1 34252 meaning that for each instance of the Pricing 34244 entity there may be one PriceSpecificationElementCategoryCode 34250 attribute. The PriceSpecificationElementPurposeCode 34256 attribute is a PriceSpecificationElementPurposeCode 34260 data type. The PriceSpecificationElementPurposeCode 34256 attribute has a cardinality of 0 . . . 1 34258 meaning that for each instance of the Pricing 34244 entity there may be one PriceSpecificationElementPurposeCode 34256 attribute. The CalculatedAmount 34262 attribute is an Amount 34266 data type. The CalculatedAmount 34262 attribute has a cardinality of 1 34264 meaning that for each instance of the Pricing 34244 entity there is one CalculatedAmount 34262 attribute.

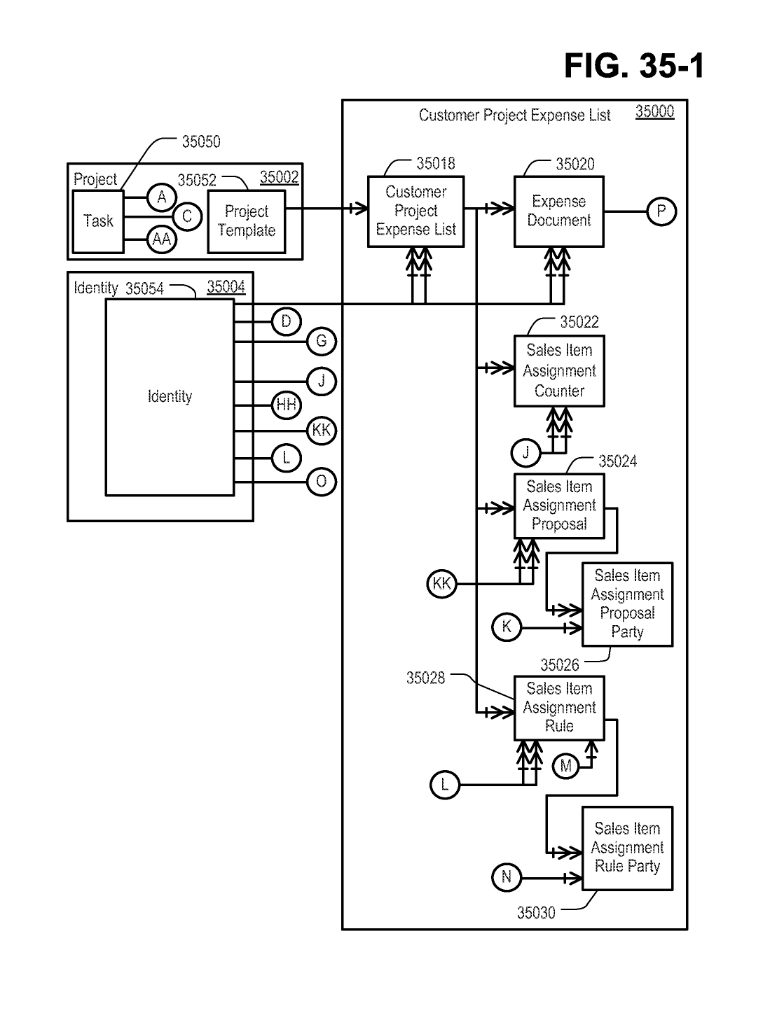

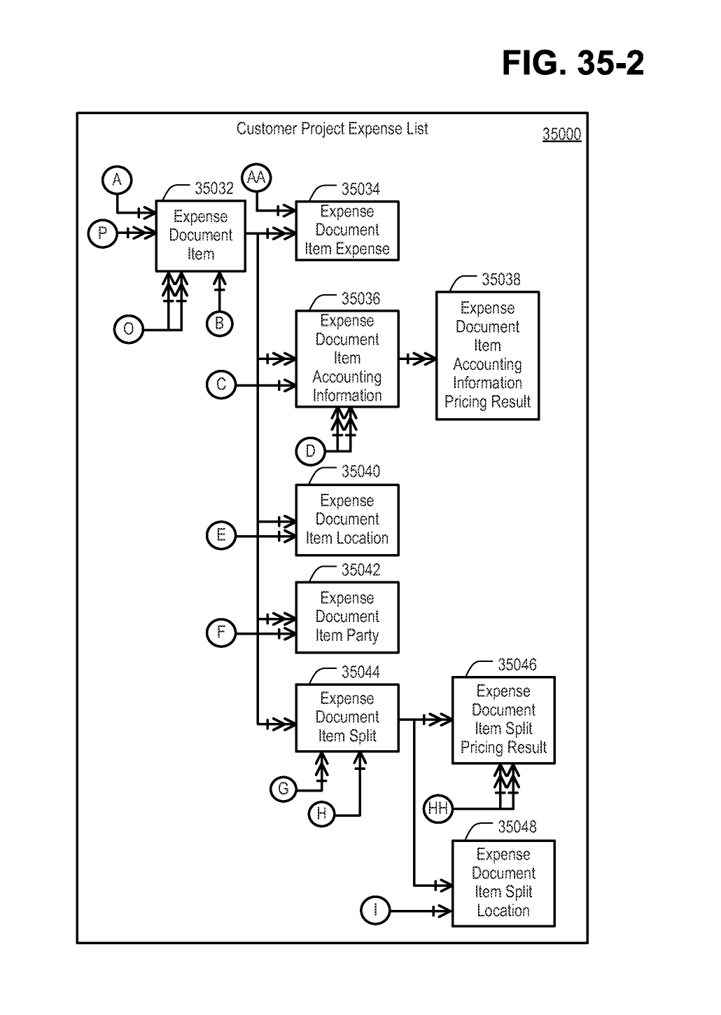

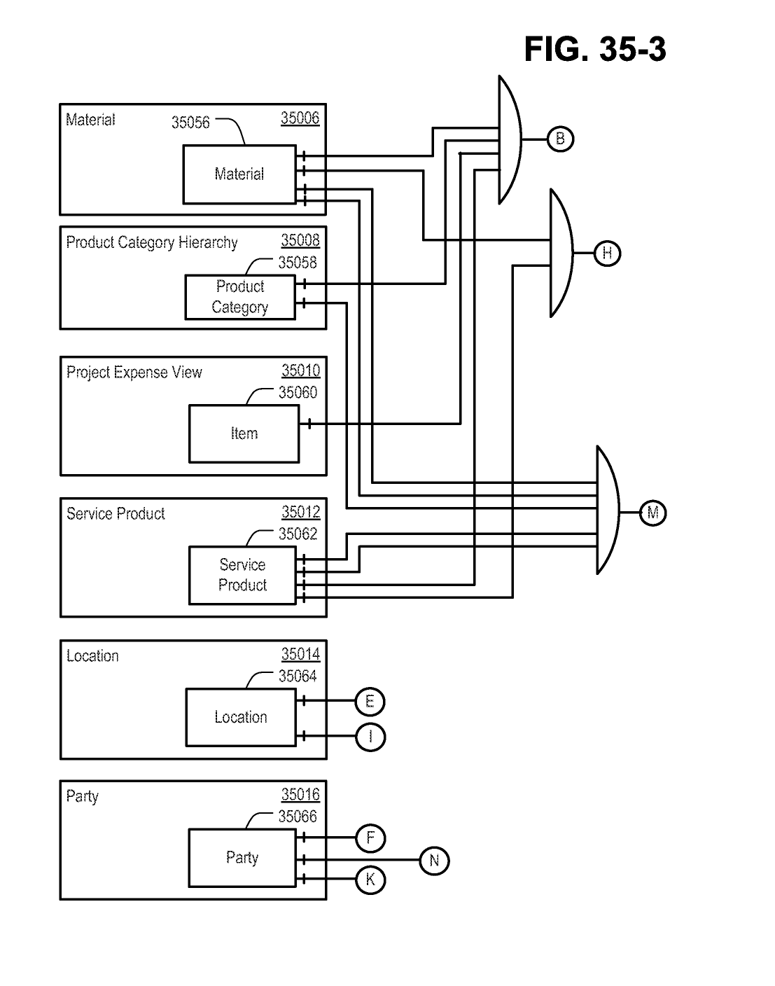

FIGS. 35-1 through 35-3 illustrate an example object model for a Customer Project Expense List business object 35000. Specifically, the object model depicts interactions among various components of the Customer Project Expense List business object 35000, as well as external components that interact with the Customer Project Expense List business object 35000 (shown here as 35002 through 35016 and 35050 through 35066). The Customer Project Expense List business object 35000 includes elements 35018 through 35048, which can be hierarchical, as depicted. For example, the Sales Item Assignment Proposal entity 35024 hierarchically includes zero or more Sales Item Assignment Proposal Party entities 35026. Some or all of the entities 35018 through 35048 can correspond to packages and/or entities in the message data types described below.

The business object Customer Project Expense List can include a Root node. Associated business objects can include, for example, EmployeeTimeCalendar, ExpenseReport, GoodsAndActivityConfirmation, GoodsAndServiceAcknowledgement, and Supplierinvoice. An external representation of an expense is how an expense is invoiced to a customer. An internal representation of an expense is an actual expense recorded by a business object, such as Employee Time Calendar, for a project task. For example, an employee time recording of 10 hours of “Consulting” can be recorded for a project task, which can be an internal representation of an expense. When creating a customer invoice, a user can decide to invoice the customer for 10 hours of “Junior Consulting”. This is an external representation of the expense. The elements located directly at the node Customer Project Expense List are defined by the inline structure PRO_S_CPEL_EL. These elements include: UUID, ProjectUUID, SystemAdministrativeData, UnassignedExpensehemNumberValue, and NotInvoicedExpenseItemNumberValue. UUID may be an alternative key, is a universally unique identifier of a customer project expense list for referencing purposes, and may be based on datatype GDT: UUID. ProjectUUID is a universally unique identifier of a project for which a customer project expense list is created, and may be based on datatype GDT: UUID. SystemAdministrativeData includes administrative data that provides information about creation and change dates as well as a system user who performed such actions, and may be based on datatype GDT: SystemAdministrativeData. UnassignedExpenseItemNumberValue may be optional, is a number of expense document item expenses that are not yet assigned to a customer project invoice requisition item, and may be based on datatype GDT: NumberValue, with a qualifier of Item. NotInvoicedExpenseItemNumberValue may be optional, is a number of expense document item expenses that are not yet invoiced, and may be based on datatype GDT: NumberValue, with a qualifier of Item. The following composition relationships to subordinate nodes exist: ExpenseDocument, with a cardinality of 1:CN; Sales Item Assignment Counter, with a cardinality of 1:CN; Sales Item Assignment Rule, with a cardinality of 1:CN; and Sales Item Assignment Proposal, with a cardinality of 1:CN, which may be filtered. The filter elements are defined by the inline structure CUST_PROJ_EXPNS_LST_SIAP_FILT. These elements include: ProductUUID, ProjectTaskUUID, AccountDeterminationExpenseGroupCode, ProductCategoryHierarchyProductCategoryIDKey, IsBestGuessScenarioIndicator, QuantityTypeCode, ProjectTaskID, ProjectID, ProductKey, and SourceObjectTypeCode. ProductUUID may be optional and may be based on datatype GDT: UUID. ProjectTaskUUID may be optional and may be based on datatype GDT: UUID. AccountDeterminationExpenseGroupCode may be optional and may be based on datatype GDT: AccountDeterminationExpenseGroupCode. ProductCategoryHierarchyProductCategoryIDKey may be optional and may be based on datatype KDT: ProductCategoryHierarchyProductCategoryIDKey. ProductCategoryHierarchyProductCategoryIDKey may include ProductCategoryHierarchyProductCategoryIDKey/ProductCategoryHierarchyID, which may be optional, is an identifier for a product category hierarchy, and may be based on datatype GDT: ProductCategoryHierarchyID. ProductCategoryHierarchyProductCategoryIDKey may include ProductCategoryHierarchyProductCategoryIDKey/ProductCategoryInternalID, which may be optional, is an identifier for a product category, and may be based on datatype GDT: ProductCategoryInternalID. IsBestGuessScenarioIndicator may be optional and may be based on datatype GDT: Indicator. QuantityTypeCode may be optional and may be based on datatype GDT: QuantityTypeCode. ProjectTaskID may be optional and may be based on datatype GDT: ProjectElementID. ProjectID may be optional and may be based on datatype GDT: ProjectID. ProductKey may be optional and may be based on datatype KDT: ProductKey. ProductKey may include ProductKey/ProductTypeCode may be optional, which is a coded representation of a product type, such as a material or service, and may be based on datatype GDT: ProductTypeCode. ProductKey may include ProductKey/ProductidentifierTypeCode, which may be optional, is a coded representation of a product identifier type, and may be based on datatype GDT: ProductidentifierTypeCode. ProductKey may include ProductKey/ProductID, which may be optional, is an identifier for a product, and may be based on datatype GDT: ProductID. SourceObjectTypeCode may be optional and may be based on datatype GDT: ObjectTypeCode.

A Project inbound aggregation relationship may exist, from the business object Project/node Project_Template, with a cardinality of 1:C, which represents a project for which a CustomerProjectExpenseList is created. The following inbound association relationships may exist: CreationIdentity, from the business object Identity/node Identity, with a cardinality of 1:CN, which is an identity of a user who created a CustomerProjectExpenseList; and LastChangeIdentity, from the business object Identity/node Identity, with a cardinality of 1:CN, which is an identity of a user who last changed a CustomerProjectExpenseList. The following specialization associations for navigation may exist to the node Expense Document Item Expense: Expense Document Item Expense, with a target cardinality of CN, which is a list of expense document item expenses.

A QueryByProject query provides the node IDs of instances that belong to a project ID that is entered as a query input and can be used to enable a user to select those nodes which belong to a particular project task. The query elements are defined by the inline structure CUSTOMER_PROJECT_EXPENSE_LIST. These elements include: ProjectID and SearchText. ProjectID is an identifier for a project and may be based on datatype GDT: ProjectID. SearchText may be based on datatype GDT: SearchText. For a query that includes SearchText as a query parameter, an application-specific subset of the other query parameters can be defined. A query result can be calculated using the following process: the search terms can be assigned to a subset of query parameters in such a way that every search term is used exactly once in the assignment, where several search terms may be assigned to a same query parameter; for each of these assignments a query result can be calculated; and a total result can be the union of the results calculated per assignment. A Select All query provides the NodeIDs of instances of the node and can be used to enable an initial load of data for a Fast Search Infrastructure.

Expense Document is a document from which an expense stored in expense document items originated. The elements located directly at the node Expense Document are defined by the inline structure PRO_S_CPEL_ED_EL. These elements include: UUID, ProjectExpenseViewUUID, and SystemAdministrativeData. UUID may be an alternative key, is a universally unique identifier of a customer project expense list expense document for referencing purposes, and may be based on datatype GDT: UUID. ProjectExpenseViewUUID is a reference to a project expense view which is creating an expense document node, and may be based on datatype GDT: UUID. SystemAdministrativeData includes administrative data that provides information about creation and change dates as well as a system user who performed such actions, and may be based on datatype GDT: SystemAdministrativeData.

The following composition relationships to subordinate nodes exist: ExpenseDocumentItem, with a cardinality of 1:CN. The following inbound association relationships may exist: CreationIdentity, from the business object Identity/node Identity, with a cardinality of 1:CN, which is an identity of a user who created an ExpenseDocument; and LastChangeIdentity, from the business object Identity/node Identity, with a cardinality of 1:CN, which is an identity of a user who last changed an ExpenseDocument. The following specialization associations for navigation may exist to the node Customer Project Expense List Parent, with a target cardinality of 1; and Root, with a target cardinality of 1.

Expense Document Item is an item of a document from which an expense originated and can be used to provide information about a sales order item, including a quantity or amount to be invoiced for a material or service product incurred for a project task. The elements located directly at the node Expense Document Item are defined by the inline structure PRO_S_CPEL_ED_IT_EL. These elements include: UUID, ProjectExpenseViewItemUUID, ProjectTaskUUID, ProductUUID, ProductKey, ProductCategoryUUID, ProductCategoryIDKey, ExpenseReportExpenseCategoryCode, GeneralLedgerAccountAliasCode, Description, ExpenseIncurrenceDateTimePeriod, TotalQuantity, TotalQuantityTypeCode, TotalRelevantQuantity, TotalRelevantQuantityTypeCode, OpenQuantity, OpenQuantityTypeCode, ToBeInvoicedQuantity, ToBeInvoicedQuantityTypeCode, NotToBeInvoicedQuantity, NotToBeInvoicedQuantityTypeCode, AllocatedQuantity, AllocatedQuantityTypeCode, TotalAmount, TotalRelevantAmount, OpenAmount, ToBeInvoicedAmount, AllocatedAmount, NotToBeInvoicedAmount, SystemAdministrativeData, Status, ID, DifferentBillableQuantity, DifferentBillableQuantityTypeCode, and DifferentBillableQuantityRecordedIndicator. UUID may be an alternative key, is a universally unique identifier of a customer project expense list item for referencing purposes, and may be based on datatype GDT: UUID. ProjectExpenseViewItemUUID is a universally unique identifier of a project expense view item that has expense information of a project and is creating an expense item, and may be based on datatype GDT: UUID. ProjectTaskUUID is a universally unique identifier of a project task on which an expense was incurred, and may be based on datatype GDT: UUID. ProductUUID is a unique identifier of a product used for a project task on which an expense was incurred, and may be based on datatype GDT: UUID. ProductKey is a key of a product that was used to record an expense incurred on a project task, and may be based on datatype KDT: ProductKey. ProductKey may include ProductKey/ProductTypeCode, which is a coded representation of a product type, such as a material or service, which may be based on datatype GDT: ProductTypeCode. ProductKey may include ProductKey/ProductidentifierTypeCode, is a coded representation of a product identifier type which may be based on datatype GDT: ProductidentifierTypeCode. ProductKey may include ProductKey/ProductID, which is an identifier for a product which may be based on datatype GDT: ProductID. ProductCategoryUUID is a unique identifier of a product used for a project task on which an expense was incurred, and may be based on datatype GDT: UUID. ProductCategoryIDKey is a key of a ProductCategory in a business document or master data object, and may be based on datatype KDT: ProductCategoryHierarchyProductCategoryIDKey. ProductCategoryIDKey may include ProductCategoryIDKey/ProductCategoryHierarchyID, which is an identifier for a product category hierarchy which may be based on datatype GDT: ProductCategoryHierarchyID. ProductCategoryIDKey may include ProductCategoryIDKey/ProductCategoryInternalID, which is an identifier for a product category which may be based on datatype GDT: ProductCategoryInternalID. ExpenseReportExpenseCategoryCode may be optional, is an identifier of an expense category for an expense recorded on a project task, and may be based on datatype GDT: ExpenseReportExpenseCategoryCode. GeneralLedgerAccountAliasCode indicates how expenses can be grouped to form an alias for a general ledger account, and may be based on datatype GDT: GeneralLedgerAccountAliasCode. Description is a description of an expense incurred on a project task, and may be based on datatype GDT: Description. ExpenseIncurrenceDateTimePeriod is a date and time period during which an expense was incurred on a project task, and may be based on datatype GDT: UPPEROPEN_LOCALNORMALISED_DateTimePeriod. TotalQuantity is a recorded quantity of an internal expense incurred on a project task, and may be based on datatype GDT: Quantity, with a qualifier of Total. TotalQuantityTypeCode is a coded representation of a type of a total quantity, and may be based on datatype GDT: QuantityTypeCode, with a qualifier of Total. TotalRelevantQuantity is a recorded quantity of an internal expense incurred for a project task that is relevant for invoicing, and may be based on datatype GDT: Quantity. TotalRelevantQuantityTypeCode is a coded representation of a type of a total quantity that is relevant for invoicing, and may be based on datatype GDT: QuantityTypeCode. OpenQuantity is a part of a total quantity for which a decision has not been made concerning invoicing, and may be based on datatype GDT: Quantity, with a qualifier of Open. OpenQuantityTypeCode is a coded representation of a type of an open quantity, and may be based on datatype GDT: QuantityTypeCode, with a qualifier of Open. ToBeInvoicedQuantity is a part of a total quantity for which a decision has been made to invoice, and may be based on datatype GDT: Quantity, with a qualifier of ToBeInvoiced. ToBeInvoicedQuantityTypeCode is a coded representation of a type of quantity that is to be invoiced, and may be based on datatype GDT: QuantityTypeCode, with a qualifier of ToBeInvoiced. NotToBeInvoicedQuantity is a part of a total quantity for which a decision has been made to not invoice, and may be based on datatype GDT: Quantity, with a qualifier of ToBeInvoiced. NotToBeInvoicedQuantityTypeCode is a coded representation of a type of the not to be invoiced quantity, and may be based on datatype GDT: QuantityTypeCode, with a qualifier of ToBeInvoiced. AllocatedQuantity is a part of a total quantity that has been included in a customer project invoice requisition for invoicing, and may be based on datatype GDT: Quantity, with a qualifier of Allocated. AllocatedQuantityTypeCode is a coded representation of a type of an allocated quantity, and may be based on datatype GDT: QuantityTypeCode, with a qualifier of Allocated. TotalAmount is a recorded amount of an internal expense incurred on a project task, and may be based on datatype GDT: Amount, with a qualifier of Total. TotalRelevantAmount is a recorded amount of an internal expense incurred for a project task that is relevant for invoicing, and may be based on datatype GDT: Amount. OpenAmount is a part of a total relevant amount for which a decision has not been made regarding invoicing, and may be based on datatype GDT: Amount, with a qualifier of Open. ToBeInvoicedAmount is a part of a total relevant amount for which a decision has been made to invoice, and may be based on datatype GDT: Amount, with a qualifier of ToBeInvoiced. AllocatedAmount is a part of a total relevant amount that has been included in a customer project invoice requisition for invoicing, and may be based on datatype GDT: Amount, with a qualifier of Allocated. NotToBeInvoicedAmount is a part of a total relevant amount for which a decision has been made to not invoice, and may be based on datatype GDT: Amount, with a qualifier of ToBeInvoiced. SystemAdministrativeData includes administrative data that provides information about creation and change dates as well as a system user who performed such actions, and may be based on datatype GDT: SystemAdministrativeData. Status is a current state of a customer project expense list item, and may be based on datatype BOIDT: CustomerProjectExpenseListExpenseDocumentItemStatusElements. Status can include CancellationStatusCode, ConsistencyStatusCode, and CustomerProjectInvoiceRequisitionAllocationProecssingStatusCode. Status/CancellationStatusCode is a status variable that indicates whether an expense document item has been canceled, and may be based on datatype GDT: CancellationStatusCode. Status/ConsistencyStatusCode is a status variable that indicates whether a customer project expense list item is consistent or inconsistent, and may be based on datatype GDT: INCONSISTENTCONSISTENT_ConsistencyStatusCode. Status/CustomerProjectInvoiceRequisitionAllocationProcessingStatusCode is a status aggregation of a customer project invoice requisition allocation status variable. A status variable can be aggregated from subordinate split items via customer project invoice requisition assignment status variables at a sending end of a derivation. Status/CustomerProjectInvoiceRequisitionAllocationProcessingStatusCode may be based on datatype GDT: NOTSTARTEDINPROCESSFINISHED_ProcessingStatusCode and can represent a current stage in a life cycle of a customer project expense list item. ID may be optional, is a unique identifier for a customer project expense list expense document item, and may be based on datatype GDT: CustomerProjectExpenseListExpenseDocumentItemID DifferentBillableQuantity may be optional and may be based on datatype GDT: Quantity, with a qualifier of Billable. DifferentBillableQuantityTypeCode may be optional and may be based on datatype GDT: QuantityTypeCode, with a qualifier of Billable. DifferentBillableQuantityRecordedIndicator may be optional and may be based on datatype GDT: Indicator, with a qualifier of Billable.

The following composition relationships to subordinate nodes exist: Expense Document Item Expense, with a cardinality of 1:CN; ExpenseDocumentItemAccountingInformation, with a cardinality of 1:CN; ExpenseDocumentItemLocation, with a cardinality of 1:C; and ExpenseDocumentItemParty, with a cardinality of 1:CN; and ExpenseDocumentItemSplit, with a cardinality of 1:CN. A ProjectTask inbound aggregation relationship may exist from the business object Project/node Task, with a cardinality of 1:C, which is a project task for which expenses incurred. The following inbound association relationships may exist: CreationIdentity, from the business object Identity/node Identity, with a cardinality of 1:CN, which is an identity of a user who created an item; LastChangeIdentity, from the business object Identity/node Identity, with a cardinality of 1:CN, which is an identity of a user who last changed an item; ConsumedMaterial, from the business object Material/node Material, with a cardinality of C:C, which is a material that is consumed for a project task; ProductCategoryHierarchyProductCategory, from the business object Product Category Hierarchy/node Product Category, with a cardinality of C:C; which represents characteristics of a product that is responsible for an expense recorded against a project task; ProjectExpenseViewItem, from the business object Project Expense View/node Item, with a cardinality of C:C, which is an expense resulting from a business transaction; and ConsumedServiceProduct, from the business object Service Product/node Service Product, with a cardinality of C:C, which is a service product that is rendered for a project task. The following specialization associations for navigation may exist: Root, to the node Customer Project Expense List, with a target cardinality of 1; and Parent, to the node Expense Document, with a target cardinality of 1. The following specialization associations for navigation may exist to the node Expense Document Item Party: Employee Responsible Party, with a target cardinality of C, which is an association to a party that occurs in a ResponsibleEmployee specialization; Seller Item Party, with a target cardinality of C, which is an association to a party that occurs in a SellerParty specialization; Service Performer Party, with a target cardinality of C, which is an association to a party that occurs in a ServicePerformer specialization; and Vendor Party, with a target cardinality of C, which is an association to an ItemParty that occurs in a VendorParty specialization. The following specialization associations for navigation may exist to the business object Material/node Overview: Material Overview, with a target cardinality of C, which is an overview of a material that is consumed. The following specialization associations for navigation may exist to the business object Service Product/node Overview: Service Product Overview, with a target cardinality of C, which is an overview of a service product that is consumed.

In some implementations, the TotalQuantity is the sum of the OpenQuantity, the ToBeInvoicedQuantity, the NotToBeInvoicedQuantity, and the AllocatedQuantity. In some implementations, all quantity elements have a same QuantityTypeCode. In some implementations, either a ProductUUID or a Description with ProductCategoryHierarchyProductCategoryIDKey are provided.

A Cancel action allows a user to cancel an expense document item that was created manually. A CheckAllocation action checks for a splits assignment to Customer Project Invoicing Requisition items. The CheckAllocation action for the status variable CustomerProjectInvoiceRequisitionAllocationProcessing can be triggered when the CustomerProjectInvoiceRequisitionAllocationProcessing status variable has a value of “Not Started”, “In Process” or “Finished”, and can set the status to any one of such values. In some implementations, the CheckAllocation action can be performed if a split item has been assigned to a customer project invoice requisition item. Changes to status resulting from the CheckAllocation action can include the value of the CustomerProjectInvoiceRequisitionAllocationProcessing status variable being set to “Assigned”. The CustomerProjectInvoiceRequisitionAllocationProcessing status can have a value of “Not Started” if all subordinate expense document split items have a CustomerProjectInvoiceRequisitionAssignment status value of “Not Assigned” and a CustomerProjectInvoiceRequisitionAssignmentItemAssignment status value of “Not Assigned”. In some implementations, if a CustomerProjectInvoiceRequisitionAssignment status value for each of the CustomerProjectExpenseListItemSplitCustomerProjectExpenseListExpenseDocumentItemSplits is “Not Assigned”, then a CustomerProjectInvoiceRequisitionAllocationProcessing status can be set to “Not Started”. The CustomerProjectInvoiceRequisitionAllocationProcessing status value can be set to “In Process” if at least one subordinate expense document split item is neither invoiced nor written off and at least one subordinate split item has a status value of “Assigned”. The CustomerProjectInvoiceRequisitionAllocationProcessing status value can be set to “Finished” if all subordinate expense document item split items are written off or invoiced and if an open quantity on the expense document item is zero. The CheckAllocation action can allow the user to determine whether the allocation processing of the item is completed or is in process.

A Select All query can be used to provide the NodeIDs of all instances of the node. A Query By Elements query can return a list of customer project expense list expense document items that include specified selection criteria. The selection criteria can be specified by a logical ‘AND’ combination of query elements. The query elements are defined by the inline structure PRO_S_CPEL_EDITM_ELEMENTS_QU. These elements include: ProjectExpenseViewID, ProjectExpenseViewItemID, ProjectID, ProjectTaskID, ProductKey, ProductCategoryIDKey, ExpenseReportExpenseCategoryCode, GeneralLedgerAccountAliasCode, Description, ExpenseIncurrenceDateTimePeriod, SystemAdministrativeData, CancellationStatusCode, CustomerProjectInvoiceRequisitionAllocationProcessingStatusCode, SearchText, ID, and CompanyID. ProjectExpenseViewID may be based on datatype GDT: ProjectExpenseViewID. ProjectExpenseViewItemID may be based on datatype GDT: ProjectExpenseViewItemID ProjectID is a unique identifier of a project for referencing purposes, and may be based on datatype GDT: ProjectID. ProjectTaskID is an identifier of a project task on which an expense was recorded, and may be based on datatype GDT: ProjectElementID. ProductKey is a key of a product that was used to record an expense that incurred on a project task, and may be based on datatype KDT: ProductKey. ProductKey can include ProductTypeCode, ProductidentifierTypeCode, and ProductID. ProductKey/ProductTypeCode is a coded representation of a product type, such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. ProductCategoryIDKey is a key of a ProductCategory in a business document or master data object, and may be based on datatype KDT: ProductCategoryHierarchyProductCategoryIDKey. ProductCategoryIDKey may include ProductCategoryIDKey/ProductCategoryHierarchyID, which is an identifier for a product category hierarchy, and may be based on datatype GDT: ProductCategoryHierarchyID. ProductCategoryIDKey/ProductCategoryInternalID is an identifier for a product category, and may be based on datatype GDT: ProductCategoryInternalID. ExpenseReportExpenseCategoryCode is an identifier of an expense category for an expense recorded on a project task, and may be based on datatype GDT: ExpenseReportExpenseCategoryCode. GeneralLedgerAccountAliasCode indicates how expenses can be grouped to form an alias for a general ledger account, and may be based on datatype GDT: GeneralLedgerAccountAliasCode. Description is a description of an expense incurred on a project task, and may be based on datatype GDT: Description. ExpenseIncurrenceDateTimePeriod is a date and time period during which an expense was incurred on a project task, and may be based on datatype GDT: UPPEROPEN_LOCALNORMALISED_DateTimePeriod. SystemAdministrativeData includes administrative data that provides information about creation and change dates as well as system user(s) who performed such actions, and may be based on datatype QueryIDT: QueryElementSystemAdministrativeData.

SystemAdministrativeData can include SystemAdministrativeData/CreationDateTime, SystemAdministrativeData/CreationIdentityBusinessPartnerPersonFamilyName, SystemAdministrativeData/CreationIdentityBusinessPartnerPersonGivenName, SystemAdministrativeData/CreationIdentityEmployeeID, SystemAdministrativeData/LastChangeDateTime, SystemAdministrativeData/LastChangeIdentityBusinessPartnerPersonFamilyName, SystemAdministrativeData/LastChangeIdentityBusinessPartnerPersonGivenName, and SystemAdministrativeData/LastChangeIdentityEmployeeID. SystemAdministrativeData/CreationDateTime is a point in time date and time stamp of a creation, and may be based on datatype GDT: GLOBAL_DateTime. SystemAdministrativeData/CreationIdentityBusinessPartnerPersonFamilyName is a family name of a business partner of a category person that is attributed to a creation identity and that can be reached following relationships of the creation identity, and may be based on datatype GDT: LANGUAGEINDEPENDENT_MEDIUM_Name. SystemAdministrativeData/CreationIdentityBusinessPartnerPersonGivenName is a given name of a business partner of a category person that is attributed to a creation identity and that can be reached following relationships of the creation identity, and may be based on datatype GDT: LANGUAGEINDEPENDENT_MEDIUM_Name. SystemAdministrativeData/CreationIdentityEmployeeID is an identifier for an employee that is attributed to a creation identity and that can be reached following relationships of the creation identity, and may be based on datatype GDT: EmployeeID. SystemAdministrativeData/LastChangeDateTime is a point in time date and time stamp of a last change, and may be based on datatype GDT: GLOBAL_DateTime. SystemAdministrativeData/LastChangeIdentityBusinessPartnerPersonFamilyName is a family name of a business partner of a category person that is attributed to a last change identity and that can be reached following relationships of the last change identity, and may be based on datatype GDT: LANGUAGEINDEPENDENT_MEDIUM_Name. SystemAdministrativeData/LastChangeIdentityBusinessPartnerPersonGivenName is a given name of a business partner of a category person that is attributed to a last change identity and that can be reached following relationships of the last change identity, and may be based on datatype GDT: LANGUAGEINDEPENDENT_MEDIUM_Name. SystemAdministrativeData/LastChangeIdentityEmployeeID is an identifier for an employee that is attributed to a last change identity and that can be reached following relationships of the last change identity, and may be based on datatype GDT: EmployeeID. CancellationStatusCode indicates whether an expense document item has been canceled, and may be based on datatype GDT: CancellationStatusCode. CustomerProjectInvoiceRequisitionAllocationProcessingStatusCode is a status aggregation for a customer project invoice requisition allocation status variable. The status variable can be aggregated from subordinate split items via a customer project invoice requisition assignment status variable at a sending end of a derivation. CustomerProjectInvoiceRequisitionAllocationProcessingStatusCode may be based on datatype GDT: NOTSTARTEDINPROCESSFINISHED_ProcessingStatusCode. SearchText may be based on datatype GDT: SearchText. For every query that includes SearchText as a query parameter, an application-specific subset of the other query parameters can be defined. A query result can be calculated in the following way: the search terms can be assigned to the subset of query parameters in such a way that every search term is used exactly once in the assignment, where several search terms can be assigned to a same query parameter; for each of these assignments a query result can be calculated; and a total result can be the union of the results calculated per assignment. ID may be based on datatype GDT: CustomerProjectExpenseListExpenseDocumentItemID CompanyID may be based on datatype GDT: OrganisationalCentreID.

Expense Document Item Expense is a summary of an expense document item and corresponding expense document item splits. An expense document item expense includes aggregated information of customer project expense list expense document item splits of a customer project expense list expense document item that are related to a same sales order item and a same invoicing product. The elements located directly at the node Expense Document Item Expense are defined by the inline structure PRO_S_CPEL_ED_IT_EXP_EL. These elements include: UUID, ExpenseIncurrenceDateTimePeriod, SalesOrderItemKey, InvoicingTaskID, InvoicingTaskUUID, Description, OriginInvoicingProductKey, OriginInvoicingProductUUID, InvoicingProductUUID, InvoicingProductKey, ExpenseReportExpenseCategoryCode, GeneralLedgerAccountAliasCode, AvailableToBeInvoicedQuantity, AvailableToBeInvoicedQuantityTypeCode, AvailableToBeInvoicedAmount, ToBeInvoicedQuantity, ToBeInvoicedQuantityTypeCode, ToBeInvoicedAmount, NotToBeInvoicedQuantity, NotToBeInvoicedQuantityTypeCode, NotToBeInvoicedAmount, AlreadyInvoicedQuantity, AlreadyInvoicedQuantityTypeCode, AlreadyInvoicedAmount, AlreadyNotToBeInvoicedQuantity, AlreadyNotToBeInvoicedQuantityTypeCode, AlreadyNotToBeInvoicedAmount, PricedAvailableToBeInvoicedAmount, PricedToBeInvoicedAmount, PricedOpenAmount, PricedNotToBeInvoicedAmount, ExcessIndicator, InvoicingBlockedIndicator, ProductUUID, ProductKey, OpenQuantity, OpenQuantityTypeCode, and OpenAmount. UUID is a universally unique identifier of an expense document item expense, and may be based on datatype GDT: UUID. ExpenseIncurrenceDateTimePeriod may be optional, is a date and time period during which an expense document item expense was incurred, and may be based on datatype GDT: UPPEROPEN_LOCALNORMALISED_DateTimePeriod. SalesOrderItemKey is a reference to a sales order item which is used for invoicing an incurred expense document item expense, and may be based on datatype KDT: BusinessTransactionDocumentItemKey. Sales OrderItemKey may include Sales OrderItemKey/BusinessTransactionDocumentItemID, SalesOrderItemKey/BusinessTransactionDocumentKey, and Sales OrderItemKey/BusinessTransactionDocumentKey/BusinessTransactionDocumentType Code. SalesOrderItemKey/BusinessTransactionDocumentItemID is a unique identifier of an item or sub item of a document within a business transaction which is unique in a context of a business transaction and which may be based on datatype GDT: BusinessTransactionDocumentItemID SalesOrderItemKey/BusinessTransactionDocumentKey is a key of a BusinessTransactionDocument, and may be based on datatype KDT: BusinessTransactionDocumentKey. Sales OrderItemKey/BusinessTransactionDocumentKey/BusinessTransactionDocumentID is a unique identifier for a business transaction document, and may be based on datatype GDT: BusinessTransactionDocumentID. Sales OrderItemKey/BusinessTransactionDocumentKey/BusinessTransactionDocumentType Code is a coded representation of a document type that occurs in business transactions, describes a business nature of similar documents, defines basic features of documents of the document type, and may be based on datatype GDT: BusinessTransactionDocumentTypeCode. InvoicingTaskID may be optional, is an identifier of a project task on which revenues can be recognized, and may be based on datatype GDT: ProjectElementID. InvoicingTaskUUID may be optional, is a universally unique identifier of a project task on which revenues can be recognized, and may be based on datatype GDT: UUID. Description is a description of an expense document item expense node instance, and may be based on datatype GDT: Description. OriginInvoicingProductKey may be optional and may be based on datatype KDT: ProductKey. OriginInvoicingProductKey may include OriginInvoicingProductKey/ProductTypeCode, OriginInvoicingProductKey/ProductidentifierTypeCode, and OriginInvoicingProductKey/ProductID. OriginInvoicingProductKey/ProductTypeCode may be optional, is a coded representation of a product type, such as a material or service, and may be based on datatype GDT: ProductTypeCode. OriginInvoicingProductKey/ProductidentifierTypeCode may be optional, is a coded representation of a product identifier type, and may be based on datatype GDT: ProductidentifierTypeCode. OriginInvoicingProductKey/ProductID may be optional, is an identifier for a product, and may be based on datatype GDT: ProductID. OriginInvoicingProductUUID may be optional and may be based on datatype GDT: UUID. InvoicingProductUUID may be optional, is a universally unique identifier of a product that can be used for invoicing an expense document item expense, and may be based on datatype GDT: UUID. InvoicingProductKey may be optional, is a grouping of elements that uniquely identifies a product that can be used for invoicing an expense document item expense, and may be based on datatype KDT: ProductKey. InvoicingProductKey may include InvoicingProductKey/ProductTypeCode, InvoicingProductKey/ProductidentifierTypeCode, and InvoicingProductKey/ProductID. InvoicingProductKey/ProductTypeCode may be optional, is a coded representation of a product type, such as a material or service, and may be based on datatype GDT: ProductTypeCode. InvoicingProductKey/ProductidentifierTypeCode may be optional, is a coded representation of a product identifier type, and may be based on datatype GDT: ProductidentifierTypeCode. InvoicingProductKey/ProductID may be optional, is an identifier for a product, and may be based on datatype GDT: ProductID. ExpenseReportExpenseCategoryCode may be optional, is an identifier of an expense category for an expense recorded on a project task, and may be based on datatype GDT: ExpenseReportExpenseCategoryCode. GeneralLedgerAccountAliasCode may be optional, indicates how expenses can be grouped to form an alias for a general ledger account, and may be based on datatype GDT: GeneralLedgerAccountAliasCode. AvailableToBeInvoicedQuantity is a quantity of an expense document item expense node instance that is available to be invoiced for a customer project expense list, and may be based on datatype GDT: Quantity, with a qualifier of ToBeInvoiced. AvailableToBeInvoicedQuantityTypeCode is a coded representation of a type of a quantity that is available and that can be invoiced, and may be based on datatype GDT: QuantityTypeCode, with a qualifier of ToBeInvoiced. AvailableToBeInvoicedAmount is an amount of an expense document item expense node instance that is available to be invoiced for a customer project expense list, and may be based on datatype GDT: Amount, with a qualifier of ToBeInvoiced. ToBeInvoicedQuantity is a quantity of an expense node instance for which a decision has been made to invoice the instance in the next customer project invoice requisition, and may be based on datatype GDT: Quantity, with a qualifier of ToBeInvoiced. ToBeInvoicedQuantityTypeCode is a coded representation of a type of a quantity that is to be invoiced, and may be based on datatype GDT: QuantityTypeCode, with a qualifier of ToBeInvoiced. ToBeInvoicedAmount is an amount of an expense node instance for which a decision has been made to invoice the instance in the next customer project invoice requisition, and may be based on datatype GDT: Amount, with a qualifier of ToBeInvoiced. NotToBeInvoicedQuantity may be based on datatype GDT: Quantity. NotToBeInvoicedQuantityTypeCode is a quantity of an expense document item expense node instance that has been written off in a customer project expense list, and may be based on datatype GDT: QuantityTypeCode, with a qualifier of ToBeInvoiced. NotToBeInvoicedAmount is an amount of an expense document item expense node instance that has been written off in a customer project expense list, and may be based on datatype GDT: Amount, with a qualifier of ToBeInvoiced. AlreadyInvoicedQuantity is a quantity of an expense document item expense node instance that has been invoiced in a customer project expense list, and may be based on datatype GDT: Quantity, with a qualifier of Invoiced. In a customer project expense list, if an expense document item expense has been invoiced, then such an expense document item expense has been assigned to a customer project invoice requisition. AlreadyInvoicedQuantityTypeCode is a coded representation of a type of a quantity that has been invoiced in a customer project expense list, and may be based on datatype GDT: QuantityTypeCode, with a qualifier of Invoiced. AlreadyInvoicedAmount is an amount of an expense document item expense node instance that has been invoiced in a customer project expense list, and may be based on datatype GDT: Amount, with a qualifier of Invoiced. In a customer project expense list, if an expense document item expense has been invoiced, then such an expense document item expense has been assigned to a customer project invoice requisition. AlreadyNotToBeInvoicedQuantity is a quantity of an expense document item expense node instance that has been written off and has been assigned to a customer project invoice requisition item, and may be based on datatype GDT: Quantity, with a qualifier of ToBeInvoiced. AlreadyNotToBeInvoicedQuantityTypeCode is a coded representation of a type of a quantity that has been written off and has been assigned to a customer project invoice requisition item, and may be based on datatype GDT: QuantityTypeCode, with a qualifier of ToBeInvoiced. AlreadyNotToBeInvoicedAmount is an amount of an expense document item expense node instance that has been written off and has been assigned to a customer project invoice requisition item, and may be based on datatype GDT: Amount, with a qualifier of ToBeInvoiced. PricedAvailableToBeInvoicedAmount is a priced amount of an expense document item expense node instance that is available to be invoiced in a customer project expense list, and may be based on datatype GDT: Amount, with a qualifier of ToBeInvoiced. PricedToBeInvoicedAmount is a priced amount of an expense document item node instance for which a decision has been made to invoice the instance in the next customer project invoice requisition, and may be based on datatype GDT: Amount, with a qualifier of ToBeInvoiced. PricedOpenAmount is a priced amount of an expense document item expense node instance that is deferred to later customer project invoice requisitions, and may be based on datatype GDT: Amount, with a qualifier of Open. PricedNotToBeInvoicedAmount is a priced amount of an expense document item expense node instance that is not to be invoiced, and may be based on datatype GDT: Amount, with a qualifier of ToBeInvoiced. ExcessIndicator is an indicator that specifies whether a quantity or amount to be invoiced exceeds a quantity or amount able to be invoiced, and may be based on datatype GDT: Indicator, with a qualifier of Excess. InvoicingBlockedIndicator may be optional, is an indication which specifies whether an expense document item expense is blocked for invoicing, may be based on datatype GDT: Indicator, with a qualifier of Blocked, and can be set to ‘true’ when the expense document item expense is blocked for invoicing. ProductUUID is a unique identifier of a product used for a project task on which an expense was incurred, and may be based on datatype GDT: UUID. ProductKey is a key of a product that was used to record an expense incurred on a project task, and may be based on datatype KDT: ProductKey. ProductKey can include ProductKey/ProductTypeCode, ProductKey/ProductidentifierTypeCode, and ProductKey/ProductID. ProductKey/ProductTypeCode is a coded representation of a product type, such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. OpenQuantity is a quantity of an expense document item expense node instance that is deferred to later customer project invoice requisitions, and may be based on datatype GDT: Quantity. OpenQuantityTypeCode is a coded representation of a type of a quantity that is deferred to later customer project invoice requisitions, and may be based on datatype GDT: QuantityTypeCode. OpenAmount is an amount of an expense document item expense node instance that is deferred to later customer project invoice requisitions, and may be based on datatype GDT: Amount.

The following inbound aggregation relationships may exist: InvoicingTask, from the business object Project/node Task, with a cardinality of 1:C, which specifies a Project Task for which an expense document item expense has been created. The following specialization associations for navigation may exist: Root, to the node Customer Project Expense List, with a target cardinality of 1; Parent, to the node Expense Document Item, with a target cardinality of 1; Material Overview, to the business object Material/node Overview, with a target cardinality of C, which is an overview of a material that is consumed; and Service Product Overview, to the business object Service Product/node Overview, with a target cardinality of C, which is an overview of a service product that is consumed. The following specialization associations for navigation may exist to the node Expense Document Item Split: to be Invoiced Customer Project Expense List Expense Document Item Split, with a target cardinality of CN, which specifies a customer project expense document item split that carries a quantity and amount that is to be invoiced; Not to be Invoiced Customer Project Expense List Expense Document Item Split, with a target cardinality of CN, which specifies a customer project expense document item split that carries a quantity and amount that is written off, where a corresponding to be invoiced expense document item split is not assigned to a customer project invoice requisition item; and Open Customer Project Expense List Expense Document Item Split, with a target cardinality of C, which specifies a customer project expense document item split that carries a quantity and amount that is deferred to later customer project invoice requisitions.

A ProposeInvoicingParameters action requests a proposal for invoicing parameters from a node Sales Item Assignment Rule for a combination of product, project task, general ledger account alias code, and description of an expense document item expense. Invoicing parameters can include a sales order item for which an expense document split item is invoiced, and an external service product.

Expense Document Item Accounting Information includes information that is provided to financial accounting for a customer project expense list split item. Customer project expense list item accounting information can serve as a document reference for financial accounting. There can be one or more instances of a customer project expense list item accounting information for each customer project expense list split item, but, in some implementations, only one of these instances is valid at a certain point in time. The elements located directly at the node Expense Document Item Accounting Information are defined by the inline structure PRO_S_CPEL_ED_IT_ACC_INFO_EL. These elements include: UUID, ID, SalesOrderItemReference, NotToBeInvoicedIndicator, Quantity, QuantityTypeCode, TotalCalculatedAmount, SystemAdministrativeData, Amount, CancelledIndicator, ExcessIndicator, InvoicingTaskID, InvoicingTaskUUID, and CustomerInvoiceItemReference. UUID may be an alternative key, is a universally unique identifier of a customer project expense list item accounting information for referencing purposes, and may be based on datatype GDT: UUID. ID is an identifier for a customer project expense list expense document item accounting information, can be unique per super-ordinate expense document item, may be based on datatype GDT: CustomerProjectExpenseListExpenseDocumentItemAccountingInformationID, and can be incremented by one for each newly created accounting information node within an expense document item. SalesOrderItemReference is a reference to a sales order item which can be used for invoicing a referenced split item against an incurred expense, and may be based on datatype GDT: BusinessTransactionDocumentReference. NotToBeInvoicedIndicator is an indication of whether a customer project expense list item accounting information is to be invoiced, and may be based on datatype GDT: Indicator, with a qualifier of Invoiced. Quantity is a quantity assigned to a referenced expense document item split for invoicing, and may be based on datatype GDT: Quantity. QuantityTypeCode is a coded representation of a type of a quantity assigned to a referenced customer project expense list split item, and may be based on datatype GDT: QuantityTypeCode. TotalCalculatedAmount is a sum of a calculated amount on item accounting information pricing result instances, and may be based on datatype GDT: Amount, with a qualifier of Calculated. SystemAdministrativeData includes administrative data that provides information about creation and change dates as well as about system user(s) who performed such actions, and may be based on datatype GDT: SystemAdministrativeData. Amount may be optional, is an amount assigned to a referenced expense document item split for invoicing, and may be based on datatype GDT: Amount. CancelledIndicator may be optional, is an indication which specifies whether a referenced expense document item split is canceled, may be based on datatype GDT: Indicator, and can be set to ‘true’ or ‘1’ when a referenced expense document item split is canceled. ExcessIndicator is an indication which specifies whether a quantity or amount of a referenced expense document item split exceeds a total quantity or amount of a corresponding item, may be based on datatype GDT: Indicator, may be set to ‘true’ or ‘1’ when a quantity or amount of a referenced expense document item split exceeds a total quantity or amount of a corresponding item, and can be used in an over invoicing scenario. InvoicingTaskID is an identifier of a project task on which revenues can be recognized, and may be based on datatype GDT: ProjectElementID. InvoicingTaskUUID is a universally unique identifier of a project task on which revenues can be recognized, and may be based on datatype GDT: UUID. CustomerInvoiceItemReference may be optional, is a reference to a customer Invoice item which was used for invoicing an incurred expense, and may be based on datatype GDT: BusinessTransactionDocumentReference. The following composition relationships to subordinate nodes exist: ExpenseDocumentItemAccountingInformationPricingResult, with a cardinality of 1:CN. The following inbound aggregation relationships may exist: ProjectTask, from the business object Project/node Task, with a cardinality of 1:C. The following inbound association relationships may exist: CreationIdentity, from the business object Identity/node Identity, with a cardinality of 1:CN, which is an identity of a user who created an item; and LastChangeIdentity, from the business object Identity/node Identity, with a cardinality of 1:CN, which is an identity of a user who last changed an item. The following specialization associations for navigation may exist: Root, to the node Customer Project Expense List, with a target cardinality of 1; and Parent, to the node Expense Document Item, with a target cardinality of 1.

Expense Document Item Accounting Information Pricing Result includes price element information that is provided to financial accounting for a split item and which can be used to create accounting information for the item. The elements located directly at the node Expense Document Item Accounting Information Pricing Result are defined by the inline structure PRO_S_CPEL_ED_IT_ACC_INF_PR_EL. These elements include: UUID, CategoryCode, PurposeCode, and CalculatedAmount. UUID may be an alternative key, is a universally unique identifier of an ItemAccountingInformationPricingResult for referencing purposes, and may be based on datatype GDT: UUID. CategoryCode is a classification of a price specification element according to a basic economic relevance of the element, and may be based on datatype GDT: PriceSpecificationElementCategoryCode. PurposeCode represents a meaning of a price specification element that explains how the price element was brought about, e.g., a rounding difference or a coupon, and may be based on datatype GDT: PriceSpecificationElementPurposeCode. CalculatedAmount is a calculated amount for a price specification element, and may be based on datatype GDT: Amount, with a qualifier of Calculated. The following specialization associations for navigation may exist: Root, to the node Customer Project Expense List, with a target cardinality of 1; and Parent, to the node Expense Document Item Accounting Information, with a target cardinality of 1. In some implementations, updating a pricing result on item splits can create new Item Accounting Information instances with an updated pricing result, thereby cancelling a previous instance.

Expense Document Item Location represents a physical place to which goods are delivered or where a service is provided. A expense document item location may exist in the following specializations: ShipToLocation, which is a place to which goods are delivered or where a service is provided. The elements located directly at the node Expense Document Item Location are defined by the inline structure PRO_S_CPEL_ED_IT_LOC_EL. These elements include: LocationID, LocationUUID, and RoleCode. LocationID is an identifier of a referenced location, and may be based on datatype GDT: LocationID. LocationUUID is a universally unique identifier of a referenced location, and may be based on datatype GDT: UUID. RoleCode is a coded representation of a role of a location in a split item, and may be based on datatype GDT: LocationRoleCode. A ShipToLocation inbound aggregation relationship may exist from the business object Location/node Location, with a cardinality of C:C, which specifies a location where a service was provided in a role ShipToLocation. The following specialization associations for navigation may exist: Root, to the node Customer Project Expense List, with a target cardinality of 1; and Parent, to the node Expense Document Item, with a target cardinality of 1. In some implementations, a specialization may occur only once per expense document item.

Expense Document Item Party is a natural or legal person, organization, organizational unit or group that is involved in a customer project expense list item in a party role. A party role can specify which rights and obligations a party has regarding a customer project expense list item and associated processes. An ItemParty can be a business partner in the specializations Employee or Supplier. An ItemParty can occur in the following specializations: EmployeeResponsibleParty, which is a party Employee that is responsible for contribution of or has contributed to a creation of goods or services for a company; and VendorParty, which is a party Supplier that delivers goods or provides a service. The elements located directly at the node Expense Document Item Party are defined by the inline structure: PRO_S_CPEL_ED_IT_PARTY_EL. These elements include: PartyKey, PartyUUID, RoleCategoryCode, and RoleCode. PartyKey is a key of an item party in a business document or master data object, and may be based on datatype KDT: PartyKey. PartyKey an include PartyTypeCode and PartyID. PartyKey/PartyTypeCode is a coded representation of a type of party, and may be based on datatype GDT: BusinessObjectTypeCode. PartyKey/PartyID is an identifier for a party, and may be based on datatype GDT: PartyID. PartyUUID is a unique identifier of a business partner involved in an expense incurred for a project task, and may be based on datatype GDT: UUID. RoleCategoryCode may be optional, is a party role category of an item party in a business document or a master data object, and may be based on datatype GDT: PartyRoleCategoryCode. RoleCode may be optional, is a party role of an item party in a business document or a master data object, and may be based on datatype GDT: PartyRoleCode. A Party inbound aggregation relationship may exist from the business object Party/node Party, with a cardinality of C:C, which is a referenced party in master data. The following specialization associations for navigation may exist: Root, to the node Customer Project Expense List, with a target cardinality of 1; and Parent, to the node Expense Document Item, with a target cardinality of 1.

Expense Document Item Split represents a part of an expense document item quantity with invoicing parameters. In some implementations, there can be one or more split items for each expense document item. Split items can be either invoiceable or non-invoiceable. Invoicing can be performed by assigning split items to a customer project invoice requisition item. A split item can include an overview of a service product that is consumed. The elements located directly at the node Expense Document Item Split are defined by the inline structure PRO_S_CPEL_ED_IT_SPT_EL. These elements include: UUID, ExpenseDocumentItemAccountingInformationUUID, Sales OrderItemReference, OriginSalesOrderItemKey, OriginInvoicingProductKey, OriginInvoicingProductUUID, InvoicingProductUUID, InvoicingProductKey, SoleProposalIndicator, NotToBeInvoicedIndicator, ExcessIndicator, ExpenseInvoicingDescription, Amount, Quantity, QuantityTypeCode, TotalCalculatedAmount, SystemAdministrativeData, Status, DeferredIndicator, CustomerInvoiceItemReference, InvoicingTaskID, and InvoicingTaskUUID.

UUID may be an alternative key is a universally unique identifier of a customer project expense list split item for referencing purposes, and may be based on datatype GDT: UUID. ExpenseDocumentItemAccountingInformationUUID is a unique identifier of a latest expense document accounting information node created from a split item, and may be based on datatype GDT: UUID. SalesOrderItemReference is a reference to a sales order item which can be used for invoicing an incurred expense, and may be based on datatype GDT: BusinessTransactionDocumentReference. OriginSalesOrderItemKey may be optional, is a reference to a sales order item which is originally set by a user or by a system proposal, and may be based on datatype KDT: BusinessTransactionDocumentItemKey. OriginSalesOrderItemKey can include BusinessTransactionDocumentItemID and BusinessTransactionDocumentKey. OriginSalesOrderItemKey/BusinessTransactionDocumentItemID may be optional, is a unique identifier of an item or sub item of a document within a business transaction, can be unique in the context of a business transaction, and may be based on datatype GDT: BusinessTransactionDocumentItemID OriginSalesOrderItemKey/BusinessTransactionDocumentKey may be optional, is a key of a BusinessTransactionDocument, and may be based on datatype KDT: BusinessTransactionDocumentKey. OriginSalesOrderItemKey/BusinessTransactionDocumentKey can include BusinessTransactionDocumentID. OriginSalesOrderItemKey/BusinessTransactionDocumentKey/BusinessTransactionDocumentID may be optional, is a unique identifier for a business transaction document, and may be based on datatype GDT: BusinessTransactionDocumentID. OriginInvoicingProductKey may be optional and may be based on datatype KDT: ProductKey. OriginInvoicingProductKey can include ProductTypeCode, ProductidentifierTypeCode, and ProductID. OriginInvoicingProductKey/ProductTypeCode may be optional, is a coded representation of a product type, such as a material or service, and may be based on datatype GDT: ProductTypeCode. OriginInvoicingProductKey/ProductidentifierTypeCode may be optional, is a coded representation of a product identifier type, and may be based on datatype GDT: ProductidentifierTypeCode. OriginInvoicingProductKey/ProductID may be optional, is an identifier for a product, and may be based on datatype GDT: ProductID. OriginInvoicingProductUUID may be optional and may be based on datatype GDT: UUID. InvoicingProductUUID is a unique identifier of a product that is to be used for invoicing a split item, and may be based on datatype GDT: UUID. InvoicingProductKey is a key of a product that is to be used for invoicing a split item, and may be based on datatype KDT: ProductKey. InvoicingProductKey may include ProductTypeCode, ProductidentifierTypeCode, and ProductID. InvoicingProductKey/ProductTypeCode is a coded representation of a product type, such as a material or service, and may be based on datatype GDT: ProductTypeCode. InvoicingProductKey/ProductidentifierTypeCode is a coded representation of a product identifier type, and may be based on datatype GDT: ProductidentifierTypeCode. InvoicingProductKey/ProductID is an identifier for a product, and may be based on datatype GDT: ProductID. SoleProposalIndicator is an indicator that specifies whether an item is a proposal, and may be based on datatype GDT: Indicator, with a qualifier of Proposal. In some implementations, SoleProposalIndicator can be an indication of whether there is zero, one, or more than one set of possible invoicing parameters that can be assigned to a split item and can be set to ‘true’ or ‘1’ when no or only one sales order item can be assigned to an expense incurred on a project task. Invoicing parameters can be a sales order item and an associated service product. NotToBeInvoicedIndicator is an indication of whether a split item can be invoiced, can be set to ‘true’ or ‘1’ when a split item is not to be invoiced, and may be based on datatype GDT: Indicator, with a qualifier of Invoiced. ExcessIndicator is an indicator that specifies whether a quantity or amount of an expense document item split exceeds a total quantity or amount of a corresponding item, and may be based on datatype GDT: Indicator, with a qualifier of Excess. ExpenseInvoicingDescription is a description of an expense that has been created for use in an invoice, and may be based on datatype GDT: MEDIUM_Description, with a qualifier of ExpenseInvoicing. Amount is an amount assigned to a customer project expense list item split for invoicing, and may be based on datatype GDT: Amount. Quantity is a quantity assigned to a customer project expense list split item for invoicing, and may be based on datatype GDT: Quantity. QuantityTypeCode is a coded representation of a type of a quantity assigned to a customer project expense list split item, and may be based on datatype GDT: QuantityTypeCode. TotalCalculatedAmount is a sum of a calculated amount on item split pricing result instances, and may be based on datatype GDT: Amount, with a qualifier of Calculated. SystemAdministrativeData includes administrative data that provides information about creation and change dates as well as about system user(s) who performed such actions, and may be based on datatype GDT: SystemAdministrativeData. Status represents a current stage in the life cycle of a customer project expense list split item, and may be based on datatype BOIDT: CustomerProjectExpenseListExpenseDocumenthemSplitStatusElements. Status includes CancellationStatusCode, CustomerProjectInvoiceRequisitionAssignmentStatusCode, CustomerProjectInvoiceRequisitionhemAssignmentStatusCode, and InvoicingBlockingStatusCode. Status/CancellationStatusCode is a status variable which indicates whether an expense document split item has been canceled, and may be based on datatype GDT: CancellationStatusCode. Status/CustomerProjectInvoiceRequisitionAssignmentStatusCode indicates whether an expense document split item is assigned to a customer project invoice requisition root node, and may be based on datatype GDT: AssignmentStatusCode. Status/CustomerProjectInvoiceRequisitionItemAssignmentStatusCode indicates whether an expense document split item is assigned to a customer project invoice requisition item node, and may be based on datatype GDT: AssignmentStatusCode. Status/InvoicingBlockingStatusCode indicates whether an expense document split item has been blocked for invoicing, and may be based on datatype GDT: BlockingStatusCode. DeferredIndicator indicates whether an expense document item split is deferred, and may be based on datatype GDT: Indicator. CustomerInvoiceItemReference may be optional, is a reference to a customer Invoice item which was used for invoicing an incurred expense, and may be based on datatype GDT: BusinessTransactionDocumentReference. InvoicingTaskID is an identifier of a project task on which revenues can be recognized, and may be based on datatype GDT: ProjectElementID. InvoicingTaskUUID is a universally unique identifier of a project task on which revenues can be recognized, and may be based on datatype GDT: UUID.

The following composition relationships to subordinate nodes may exist: ExpenseDocumentItemSplitPricingResult, with a cardinality of 1:CN; and ExpenseDocumentItemSplitLocation, with a cardinality of 1:C. The following inbound association relationships may exist: CreationIdentity, from the business object Identity/node Identity, with a cardinality of 1:CN, which is an identity of a user who created an item; LastChangeIdentity, from the business object Identity/node Identity, with a cardinality of 1:CN, which is an identity of a user who last changed an item; InvoicingMaterial, from the business object Material/node Material, with a cardinality of C:C, which is a material that is used for invoicing; InvoicingServiceProduct, from the business object Service Product/node Service Product, with a cardinality of C:C, which is a service product that is used for invoicing. The following specialization associations for navigation may exist: Root, to the node Customer Project Expense List, with a target cardinality of 1; Parent, to the node Expense Document Item, with a target cardinality of 1; Material Overview, to the business object Material/node Overview, with a target cardinality of C, which is an overview of a material that is consumed; and Service Product Overview, to the business object Service Product/node Overview, with a target cardinality of C, which is an overview of a service product that is consumed. In some implementations, a sum of the quantities of all split items does not exceed the total quantity of the associated expense document item. In some implementations, a total calculated amount is the sum of a calculated amount of all split item pricing result node instances.

A Cancel action sets a cancellation status of an expense document split item and creates a new split item with the same parameters as that of the canceled split item. The Cancel action can be performed in response to a cancellation of a linked customer project invoice requisition. The Cancel action can be called by a customer project invoice requisition item customer project expense list split assignment. The Cancel action can be performed if the CustomerProjectInvoiceRequisitionAssignment status variable has a value of “Assigned”. The new split item can have a CustomerProjectInvoiceRequisitionAssignment status of “NotAllocated”. Changes to status resulting from the Cancel action can include the value of a CancellationStatus variable being set to “Canceled” from “Not Canceled”.

A Determine Price action determines price elements corresponding to a sales order item and service product assigned to a split item. The Determine Price action can be performed when a split item is created or in response to a change of an invoicing product and/or quantity type code. In response to the Determine Price action, an instance of an ItemSplitPricingResult node can be created or updated. A pricing result can be determined by an invoicing product and a quantity type code for an expense document split item for which a customer is to be billed.

A NotifyOfInvoiceRequisitionitemAssignment action can be called by the business object Customer Project Invoice Requisition. The Customer Project Invoice Requisition sets a CustomerProjectInvoiceRequisitionItemAssignment status of an expense document split item to “Assigned” whenever an ItemCustomerProjectExpenseListExpenseDocumentItemSplitAssignment node is created. The NotifyOfInvoiceRequisitionitemAssignment action can be performed if a CustomerProjectInvoiceRequisitionitemAssignment status of an expense document split item has a value of “NotAssigned”. In response to the NotifyOfInvoiceRequisitionitemAssignment action, an expense document item quantity and amount fields and quantity and amount fields of an item node of a customer project invoicing agreement can be changed. Changes to status resulting from the NotifyOfInvoiceRequisitionitemAssignment action can include the value of a CustomerProjectInvoiceRequisitionitemAssignment status variable being set to “Assigned”. The NotifyOfInvoiceRequisitionitemAssignment action can allow a user to assign expense items to invoicing items to create a customer invoice. The NotifyOfInvoiceRequisitionitemAssignment action can update a corresponding quantity and amount information on an item node of a customer project invoicing agreement if the item node has a reference to a sales order.

A Notify of Invoice Requisition Item Assignment Removal action can be called by the business object Customer Project Invoice Requisition. The business object Customer Project Invoice Requisition sets a CustomerProjectInvoiceRequisitionitemAssignment status of an expense document split item to “NotAssigned” whenever an ItemCustomerProjectExpenseListExpenseDocumentItemSplitAssignment node is deleted. The Notify of Invoice Requisition Item Assignment Removal action can be performed if a CustomerProjectInvoiceRequisitionitemAssignment status of an expense document split item has a value of “Assigned”. An expense document item quantity and amount fields and quantity and amount fields of an item node of a customer project invoicing agreement can be changed as a result of the Notify of Invoice Requisition Item Assignment Removal action. Changes to status resulting from the Notify of Invoice Requisition Item Assignment Removal action include the value of the CustomerProjectInvoiceRequisition Item Assignment status variable being set to a value of “NotAssigned”. The Notify of Invoice Requisition Item Assignment Removal action can allow a user to delete an assignment of expense items to invoicing items. The Notify of Invoice Requisition Item Assignment Removal action can update corresponding quantity and amount fields of an ItemCustomerProjectExpenseListExpenseDocumentItemSplitAssignment node and can update a quantity and amount information on an item node of a customer project invoicing agreement if the item node has a reference to a sales order item.

A Notify of Invoice Requisition Assignment action sets a Customer Project Invoice Requisition Assignment status of a split item to “Assigned” whenever a CustomerProjectExpenseListExpenseDocumentItemSplitAssignment node is created. The action Notify of Invoice Requisition Assignment can be called by a customer project invoice requisition item customer project expense list split assignment. The Notify of Invoice Requisition Assignment action can be performed if a CustomerProjectInvoiceRequisitionAssignment status variable has a value of “Not Assigned”. Changes to status resulting from the Notify of Invoice Requisition Assignment action can include the value of a CustomerProjectInvoiceRequisitionAssignment status variable being set to “Assigned” from a value of “Not Assigned”.

A Notify of Invoice Requisition Assignment Removal action sets a status of a split item to “Not Assigned” if a CustomerProjectInvoiceRequistion ItemCustomerProjectExpenseListItemSplitAssignment is deleted. The Notify of Invoice Requisition Assignment Removal action can be called by a customer project invoice requisition item customer project expense list split assignment. The Notify of Invoice Requisition Assignment Removal action can be performed if a CustomerProjectInvoiceRequisitionAssignment status variable has a value of “Assigned”. Changes to status resulting from the Notify of Invoice Requisition Assignment Removal action can include the value of a CustomerProjectInvoiceRequisitionAssignment status variable being set to “NotAssigned” from a value of “Assigned”.

A ProposeInvoicingParameters action requests a proposal for invoicing parameters from a customer project invoicing agreement for a combination of a product and a project task of a customer project expense list expense document split item. Invoicing parameters can include a sales order item for which an expense document split item is invoiced, and an external service product. The ProposeInvoicingParameters action can be performed when a split item is created and/or an InvoicingParameterDecision status code has a value of “Not Made”. As a result of performing the ProposeInvoicingParameters action, a sales order item, product, and location information can be filled in a split item and a limit check can performed for a quantity. Also as a result of performing the ProposeInvoicingParameters action, a SalesOrderItemAssignmentCounter node can be incremented and an amount and/or quantity information on a CustomerProjectInvoicingAgreementItem node can be updated. The ProposeInvoicingParameters action proposes one or more frequently used invoicing parameters for a split item for a given project task and expense product.

A ProposeInvoicingProduct action can be used to determine if an internal representation of expenses can be used as an external representation of expenses. A Block Invoicing action blocks an expense document item split for invoicing. The Block Invoicing action sets the value of a status variable InvoicingBlocking to “Blocked”. The action Block Invoicing can be allowed when status variables CustomerProjectInvoiceRequisitionAssignment and CustomerProjectInvoiceRequisitionitemAssignment have a value of “Unassigned” and an InvoicingBlocking status variable has a value of “Not Blocked”.

An Unblock Invoicing action unblocks an expense document item split for invoicing and sets the value of a status variable InvoicingBlocking to “Unblocked”. The action Unblock Invoicing can be allowed when a status variable InvoicingBlocking has a value of “Blocked”.

A Query By Elements query returns a list of customer project expense list expense document item split items including specified selection criteria. The selection criteria can be specified by a logical ‘AND’ combination of query elements. The query elements are defined by the inline structure PRO_S_CPEL_EDITM_SPLIT_ELE_QU. These elements include: SalesOrderID, Sales OrderItemID, ProjectID, ProjectTaskID, ExpenseIncurrenceDateTimePeriod, CustomerProjectInvoiceRequisitionitemAssignmentStatusCode, CustomerProjectInvoiceRequisitionAssignmentStatusCode, and SearchText. SalesOrderID is an identifier of a SalesOrder, and may be based on datatype GDT: BusinessTransactionDocumentID. SalesOrderItemID is an identifier of a SalesOrderItem, and may be based on datatype GDT: BusinessTransactionDocumentItemID ProjectID is an identifier for a project, and may be based on datatype GDT: ProjectID. ProjectTaskID is an identifier of a task, and may be based on datatype GDT: ProjectElementID. ExpenseIncurrenceDateTimePeriod is a date and time period during which an expense was incurred on a project task, and may be based on datatype GDT: UPPEROPEN_LOCALNORMALISED_DateTimePeriod. CustomerProjectInvoiceRequisitionitemAssignmentStatusCode indicates whether an expense document split item is assigned to a customer project invoice requisition item node, and may be based on datatype GDT: AssignmentStatusCode. CustomerProjectInvoiceRequisitionAssignmentStatusCode indicates whether an expense document split item is assigned to a customer project invoice requisition root node, and may be based on datatype GDT: AssignmentStatusCode. SearchText may be based on datatype GDT: SearchText. For every query that includes SearchText as a query parameter, an application-specific subset of the other query parameters can be defined. A query result can be calculated using the following steps: search terms can be assigned to the subset of query parameters in such a way that every search term is used exactly once in the assignment; several search terms may be assigned to a same query parameter; for each of these assignments a query result can be calculated; and a total result can be a union of the results calculated per assignment.

Expense Document Item Split Pricing Result is a price element with which a customer project expense list split item is sold to a customer. The Expense Document Item Split Pricing Result node can be populated with price information that is calculated on a CustomerProjectInvoiceRequisitionitem simulated corresponding to a sales order item reference on item split. The elements located directly at the node Expense Document Item Split Pricing Result are defined by the inline structure PRO_S_CPEL_ED_IT_SPT_PR_RES_EL. These elements include: UUID, CategoryCode, PurposeCode, CalculatedAmount, and SystemAdministrativeData. UUID may be an alternative key, is a universally unique identifier of an ItemSplitPricingResult for referencing purposes, and may be based on datatype GDT: UUID. CategoryCode is a classification of a price specification element according to a basic economic relevance, and may be based on datatype GDT: PriceSpecificationElementCategoryCode. PurposeCode is a meaning of a price specification element that explains how the price element was created, such as by a rounding difference or by a coupon, and may be based on datatype GDT: PriceSpecificationElementPurposeCode. CalculatedAmount is a calculated amount for a price specification element, and may be based on datatype GDT: Amount, with a qualifier of Calculated. SystemAdministrativeData includes administrative data that provides information about creation and change dates as well as about system user(s) who performed such actions, and may be based on datatype GDT: SystemAdministrativeData.

The following inbound association relationships may exist: CreationIdentity, from the business object Identity/node Identity, with a cardinality of 1:CN, which is an identity of a user who created an item; and LastChangeIdentity, from the business object Identity/node Identity, with a cardinality of 1:CN, which is an identity of a user who last changed an item. The following specialization associations for navigation may exist: Root, to the node Customer Project Expense List, with a target cardinality of 1; and Parent, to the node Expense Document Item Split, with a target cardinality of 1. In some implementations, a pricing result is filled in as zero if a sales order item assigned to a split item is marked as finally invoiced or a limit has been reached.

Expense Document Item Split Location represents a physical place to which goods are delivered or where a service is provided for a split item if the physical place differs from an origin location. Location information can be filled when a split item that includes a proposed sales order item is assigned to a customer project invoice requisition item. The location information can indicate, for a parent item, that there is at least one split item where goods are delivered or a service is provided at a different location than the location in the parent item. The elements located directly at the node Expense Document Item Split Location are defined by the inline structure PRO_S_CPEL_ED_IT_SPT_LOC_EL. These elements include: LocationID, LocationUUID, and RoleCode. LocationID is an identifier of a referenced location, and may be based on datatype GDT: LocationID. LocationUUID is a universally unique identifier of a referenced location, and may be based on datatype GDT: UUID. RoleCode is a coded representation of a role of a location in a split item, and may be based on datatype GDT: LocationRoleCode.

A ShipToLocation inbound aggregation relationship may exist from the business object Location/node Location, with a cardinality of C:C, which specifies a location where the service was provided in the role ShipToLocation. The following specialization associations for navigation may exist: Root, to the node Customer Project Expense List, with a target cardinality of 1; and Parent, to the node Expense Document Item Split, with a target cardinality of 1.

Sales Item Assignment Counter is a counter that tracks how often a combination of a project task and an internal representation of expenses was assigned to a combination of a sales order item and an external representation of expenses in a customer project expense list. There can be one SalesItemAssignmentCounter node for each combination of project task, internal representation of expenses, sales order item, and external representation of expenses. If an internal representation of expenses is assigned to an external representation of an expense or for a combination of a sales order item and an external representation of expenses in a customer project expense list, then the counter can be incremented by one. The elements located directly at the node Sales Item Assignment Counter are defined by the inline structure PRO_S_CPEL_SA_IT ASS_COUNT_EL. These elements include: SalesOrderItemReference, ProductUUID, ProductKey, Description, InvoicingProductUUID, InvoicingProductKey, ExpenseInvoicingDescription, ProjectTaskUUID, GeneralLedgerAccountAliasCode, ProductCategoryHierarchyProductCategoryIDKey, UsageCounterValue, and SystemAdministrativeData. SalesOrderItemReference is a reference to a sales order item that was accepted or used for a given project task, and may be based on datatype GDT: BusinessTransactionDocumentReference. ProductUUID is a universally unique identifier of a material or service product used for a project task on which a posting was made, and may be based on datatype GDT: UUID. ProductKey is a key of a product, and may be based on datatype KDT: ProductKey. ProductKey can include ProductTypeCode, ProductidentifierTypeCode, and ProductID. ProductKey/ProductTypeCode is a coded representation of a product type, such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. Description is a description of expenses incurred on a project task on which a recording was made, and may be based on datatype GDT: MEDIUM_Description. InvoicingProductUUID is a universally unique identifier of a material or service product that corresponds to a product UUID and that will be used for invoicing, and may be based on datatype GDT: UUID. InvoicingProductKey is a key of an invoicing product, and may be based on datatype KDT: ProductKey. InvoicingProductKey can include ProductTypeCode, ProductidentifierTypeCode, and ProductID. InvoicingProductKey/ProductTypeCode is a coded representation of a product type, such as a material or service, and may be based on datatype GDT: ProductTypeCode. InvoicingProductKey/ProductidentifierTypeCode is a coded representation of a product identifier type, and may be based on datatype GDT: ProductidentifierTypeCode. InvoicingProductKey/ProductID is an identifier for a product, and may be based on datatype GDT: ProductID. ExpenseInvoicingDescription is a description of an expense that has been created for use in an invoice, and may be based on datatype GDT: MEDIUM_Description, with a qualifier of ExpenseInvoicing. ProjectTaskUUID is a universally unique identifier for a project task on which a posting is made, and may be based on datatype GDT: UUID. GeneralLedgerAccountAliasCode is a coded representation of a group of expense types which is used as an alias for a general ledger account, and may be based on datatype GDT: GeneralLedgerAccountAliasCode. ProductCategoryHierarchyProductCategoryIDKey is a key of a product category, can be provided with a description of an incurred expense, and may be based on datatype KDT: ProductCategoryHierarchyProductCategoryIDKey. ProductCategoryHierarchyProductCategoryIDKey can include ProductCategoryHierarchyID and ProductCategoryInternalID. ProductCategoryHierarchyProductCategoryIDKey/ProductCategoryHierarchyID is an identifier for a product category hierarchy, and may be based on datatype GDT: ProductCategoryHierarchyID. ProductCategoryHierarchyProductCategoryIDKey/ProductCategoryInternalID is an identifier for a product category, and may be based on datatype GDT: ProductCategoryInternalID. UsageCounterValue is a counter that reflects how often an assignment is used, denotes the number of assignments, and may be based on datatype GDT: CounterValue. SystemAdministrativeData includes administrative data recorded by a system, such as system user and change dates/times, and may be based on datatype GDT: SystemAdministrativeData.

The following inbound association relationships may exist: CreationIdentity, from the business object Identity/node Identity, with a cardinality of 1:CN, which is an identity of a user who created the SalesItemAssignmentCounter node, and LastChangeIdentity, from the business object Identity/node Identity, with a cardinality of 1:CN, which is an identity of a user who last changed the SalesItemAssignmentCounter node. The following specialization associations for navigation may exist to the node Customer Project Expense List: Parent, with a target cardinality of 1; and Root, with a target cardinality of 1. In some implementations, either a ProductUUID or a Description with a ProductCategoryHierarchyProductCategoryIDKey is specified. In some implementations, either an InvoicingProductUUID or an ExpenseInvoicingDescription is specified.

A Notify of Assignment Counter Values Change action changes a value of an assignment counter for a specified assignment. The assignment counter value can be increased or decreased using the Notify of Assignment Counter Values Change action. The action elements are defined by the inline structure PRO_S_CPEL_SL_IT_AS_NTF_CTR_AC. These elements include DifferenceCounterValue, which may be optional, is a difference in counter value, and may be based on datatype GDT: CounterValue.

A Set Assignment Counter Value action sets the value of an assignment counter to a defined value for a specified assignment. The action elements are defined by the inline structure PRO_S_CPEL_SL_IT_AS_CTR_VAL_AC. These elements include CounterValue, which may be optional, is a value of a sales item assignment counter, and may be based on datatype GDT: CounterValue.

Sales Item Assignment Proposal Transformation Node includes a list of combinations of a sales order item and an external representation of expenses that a system identified as proposals for a given combination of a project task and an internal representation of expenses. In some implementations, assignment proposals are not persisted but are determined when they are requested by a customer project expense list. A proposal can be influenced by assignment rules laid down in the system and an assignment counter. One SalesItemAssignmentProposal node can exist for each combination of project task, internal representation of expenses, sales order item, and external representation of expenses. The elements located directly at the node Sales Item Assignment Proposal are defined by the inline structure PRO_S_CPEL_SA_IT_ASS_PROP_EL. These elements include: ProductKey, InvoicingProductKey, SalesOrderItemReference, ProductUUID, Description, InvoicingProductUUID, ExpenseInvoicingDescription, UsageCounterValue, CounterLastChangeDateTime, ProductCategoryHierarchyProductCategoryIDKey, GeneralLedgerAccountAliasCode, ProjectTaskUUID, ProjectTaskID, SourceObjectTypeCode, and NotToBeInvoicedIndicator. ProductKey is a key of a product, and may be based on datatype KDT: ProductKey. ProductKey can include ProductTypeCode, ProductidentifierTypeCode, and ProductID. ProductKey/ProductTypeCode is a coded representation of a product type, such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. InvoicingProductKey is a key of an invoicing product, and may be based on datatype KDT: ProductKey. InvoicingProductKey can include ProductTypeCode, ProductidentifierTypeCode, and ProductID. InvoicingProductKey/ProductTypeCode is a coded representation of a product type, such as a material or service, and may be based on datatype GDT: ProductTypeCode. InvoicingProductKey/ProductidentifierTypeCode is a coded representation of a product identifier type, and may be based on datatype GDT: ProductidentifierTypeCode. InvoicingProductKey/ProductID is an identifier for a product, and may be based on datatype GDT: ProductID. SalesOrderItemReference is a reference to a sales order item that can be assigned to a given project task, and may be based on datatype GDT: BusinessTransactionDocumentReference. ProductUUID is a unique identifier of a product used for a project task on which an expense was incurred, and may be based on datatype GDT: UUID. Description is a description of an expense incurred on a project task, and may be based on datatype GDT: MEDIUM_Description. InvoicingProductUUID is a universally unique identifier of a material or service product that corresponds to a product UUID which can be used for invoicing, and may be based on datatype GDT: UUID. ExpenseInvoicingDescription is a description of an expense that has been created for use in an invoice, and may be based on datatype GDT: MEDIUM_Description, with a qualifier of ExpenseInvoicing. UsageCounterValue may be optional, is a counter that reflects how often a combination of a project task and an internal representation of expenses is assigned to a combination of a sales order item and an external representation of expenses, and may be based on datatype GDT: CounterValue. CounterLastChangeDateTime may be optional, is a date and time at which an assignment counter is last changed, and may be based on datatype GDT: GLOBAL_DateTime, with a qualifier of LastChange. ProductCategoryHierarchyProductCategoryIDKey is a key of a product category, can be provided with a description of an incurred expense, and may be based on datatype KDT: ProductCategoryHierarchyProductCategoryIDKey. ProductCategoryHierarchyProductCategoryIDKey can include ProductCategoryHierarchyID and ProductCategoryInternalID. ProductCategoryHierarchyProductCategoryIDKey/ProductCategoryHierarchyID is an identifier for a product category hierarchy, and may be based on datatype GDT: ProductCategoryHierarchyID. ProductCategoryHierarchyProductCategoryIDKey/ProductCategoryInternalID is an identifier for a product category, and may be based on datatype GDT: ProductCategoryInternalID. GeneralLedgerAccountAliasCode is a coded representation of a group of expense types which can be used as an alias for a general ledger account, and may be based on datatype GDT: GeneralLedgerAccountAliasCode. ProjectTaskUUID may be optional, is a universally unique identifier of a project task on which an expense is incurred, and may be based on datatype GDT: UUID. ProjectTaskID may be optional, is an identifier of a project task on which revenues can be recognized, and may be based on datatype GDT: ProjectElementID. SourceObjectTypeCode may be optional, is a source object type code from which an expense is incurred, and may be based on datatype GDT: ObjectTypeCode. NotToBeInvoicedIndicator may be based on datatype GDT: Indicator.

The following composition relationships to subordinate nodes exist: Sales Item Assignment Proposal Party, with a cardinality of 1:CN. The following inbound association relationships may exist: CreationIdentity, from the business object Identity/node Identity, with a cardinality of 1:CN, which is an identity of a user who created a SalesItemAssignmentProposal node; and LastChangeIdentity, from the business object Identity/node Identity, with a cardinality of 1:CN, which is an identity of a user who last changed a SalesItemAssignmentProposal node.

The following specialization associations for navigation may exist: Parent, to the node Customer Project Expense List, with a target cardinality of 1; Root, to the node Customer Project Expense List, with a target cardinality of 1; Service Performer Party, to the node Sales Item Assignment Proposal Party, with a target cardinality of C, which is an association to a party that occurs in a ServicePerformerParty specialization; and Seller Party, with a target cardinality of C, which is an association to a party that occurs in a SellerParty specialization. In some implementations, either a ProductUUID or a Description with a ProductCategoryHierarchyProductCategoryIDKey is specified. In some implementations, either an InvoicingProductUUID or an ExpenseInvoicingDescription is specified.

Sales Item Assignment Proposal Party Transformation Node is a natural or legal person, organization, organizational unit or group that is involved in a sales item assignment in a party role. A party role specifies which rights and obligations a party has regarding a sales item assignment and associated processes. A Party can be a business partner in the specializations Service Performer Party or Supplier. A Party can occur in the following specializations: ServicePerformerParty, which is a party Employee (e.g., internal, external) that is responsible for contribution of or has contributed to a creation of goods or services for a company; and SupplierParty, which is a party Supplier that delivers goods or provides a service. The elements located directly at the node Sales Item Assignment Proposal Party are defined by the inline structure PRO_S_CPEL_SOI_PROPOSAL_PTY_EL. These elements include: PartyKey, PartyUUID, RoleCategoryCode, and RoleCode. PartyKey may be optional and may be based on datatype KDT: PartyKey. PartyKey may include PartyTypeCode and PartyID. PartyKey/PartyTypeCode may be optional, is a coded representation of a type of party, and may be based on datatype GDT: BusinessObjectTypeCode. PartyKey/PartyID may be optional, is an identifier for a party, and may be based on datatype GDT: PartyID. PartyUUID may be optional and may be based on datatype GDT: UUID. RoleCategoryCode may be optional and may be based on datatype GDT: PartyRoleCategoryCode. RoleCode may be optional and may be based on datatype GDT: PartyRoleCode.

The following inbound aggregation relationships may exist: Party, from the business object Party/node Party, with a cardinality of C:C. The following specialization associations for navigation may exist: Root, to the node Customer Project Expense List, with a target cardinality of 1; and Parent, to the node Sales Item Assignment Proposal, with a target cardinality of 1.

Sales Item Assignment Rule is a rule that defines which sales order item and external representation of expenses a system proposes to be assigned to a project task and an internal representation of expenses. Rules stored in SalesItemAssignmentRule nodes can be defined by a customer and can be used to reduce a list of possible assignments. In some implementations, there is one SalesItemAssignmentRule node for each combination of project task, internal representation of expenses, sales order item, and external representation of expenses. The elements located directly at the node Sales Item Assignment Rule are defined by the inline structure PRO_S_CPEL_SA_IT_ASS_RULE_EL. These elements include: SalesOrderItemReference, ProductUUID, ProductKey, Description, InvoicingProductKey, InvoicingProductUUID, ExpenseInvoicingDescription, ProjectTaskID, ProjectTaskUUID, GeneralLedgerAccountAliasCode, ProductCategoryHierarchyProductCategoryIDKey, ExcludedIndicator, SystemAdministrativeData, OrdinalNumberValue, ID, ExpenseIndicator, CreationMethodCode, SourceObjectTypeCode, HigherRankSalesItemAssignmentRuleUUID, LowerRankSalesItemAssignmentRuleUUID, AnyServiceProductIDAllowedIndicator, AnyProductCategoryHierarchyIDAllowedIndicator, AnyGeneralLedgerAccountAliasCodeAllowedIndicator, AnyProjectTaskIDAllowedIndicator, AnyServicePerformerPartyAllowedIndicator, AnySellerPartyAllowedIndicator, AnySourceObjectTypeCodeAllowedIndicator, AnyMaterialIDAllowedIndicator, and NotToBeInvoicedIndicator. SalesOrderItemReference may be optional, is a reference to a sales order item that is accepted or used for a given project task, and may be based on datatype GDT: BusinessTransactionDocumentReference. ProductUUID may be optional, is a universally unique identifier of a material or service product used for a project task on which a posting is made, and may be based on datatype GDT: UUID. ProductKey may be optional, is a key of a product, and may be based on datatype KDT: ProductKey. ProductKey can include ProductTypeCode, ProductidentifierTypeCode, and ProductID. ProductKey/ProductTypeCode may be optional, is a coded representation of a product type, such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. Description may be optional, is a description of expenses incurred on a project task on which a recording is made, and may be based on datatype GDT: MEDIUM_Description. InvoicingProductKey may be optional, is a key of an invoicing product, and may be based on datatype KDT: ProductKey. InvoicingProductKey may include ProductTypeCode, ProductidentifierTypeCode, and ProductID. InvoicingProductKey/ProductTypeCode may be optional, is a coded representation of a product type, such as a material or service, and may be based on datatype GDT: ProductTypeCode. InvoicingProductKey/ProductidentifierTypeCode may be optional, is a coded representation of a product identifier type, and may be based on datatype GDT: ProductidentifierTypeCode. InvoicingProductKey/ProductID may be optional, is an identifier for a product, and may be based on datatype GDT: ProductID. InvoicingProductUUID may be optional, is a universally unique identifier of a material or service that corresponds to a product UUID and that can be used for invoicing, and may be based on datatype GDT: UUID. ExpenseInvoicingDescription may be optional, is a description of an expense that has been created for use in an invoice, and may be based on datatype GDT: MEDIUM_Description, with a qualifier of ExpenseInvoicing. ProjectTaskID may be optional, is an identifier for a project task on which a recording is made, and may be based on datatype GDT: ProjectElementID. ProjectTaskUUID may be optional, is a universally unique identifier of a project task on which a recording is made, and may be based on datatype GDT: UUID. GeneralLedgerAccountAliasCode may be optional, is a coded representation of a group of expense types which can be used as an alias for a general ledger account, and may be based on datatype GDT: GeneralLedgerAccountAliasCode. ProductCategoryHierarchyProductCategoryIDKey may be optional, is a key of a product category of a product for which a recording is made, and may be based on datatype KDT: ProductCategoryHierarchyProductCategoryIDKey. ProductCategoryHierarchyProductCategoryIDKey can include ProductCategoryHierarchyID and ProductCategoryInternalID. ProductCategoryHierarchyProductCategoryIDKey/ProductCategoryHierarchyID may be optional, is an identifier for a product category hierarchy, and may be based on datatype GDT: ProductCategoryHierarchyID. ProductCategoryHierarchyProductCategoryIDKey/ProductCategoryInternalID may be optional, is an identifier for a product category, and may be based on datatype GDT: ProductCategoryInternalID. ExcludedIndicator is a flag which can be used to prohibit a specified assignment of a project task and internal representation of expenses to a sales order item and an external representation of expenses, and may be based on datatype GDT: Indicator, with a qualifier of Excluded. SystemAdministrativeData includes administrative data recorded by a system, such as system user and change dates/times, and may be based on datatype GDT: SystemAdministrativeData. OrdinalNumberValue may be optional and may be based on datatype GDT: OrdinalNumberValue. ID is a unique identifier for a customer project expense list sales item assignment rule, and may be based on datatype GDT: CustomerProjectExpenseListSalesItemAssignmentRuleID. ExpenseIndicator may be based on datatype GDT: Indicator. CreationMethodCode may be based on datatype GDT: CustomerProjectExpenseListSalesItemAssignmentRuleCreationMethodCode. SourceObjectTypeCode may be optional and may be based on datatype GDT: ObjectTypeCode. HigherRankSalesItemAssignmentRuleUUID may be optional and may be based on datatype GDT: UUID. LowerRankSalesItemAssignmentRuleUUID may be optional and may be based on datatype GDT: UUID. AnyServiceProductIDAllowedIndicator and may be based on datatype GDT: Indicator. AnyProductCategoryHierarchyIDAllowedIndicator and may be based on datatype GDT: Indicator. AnyGeneralLedgerAccountAliasCodeAllowedIndicator and may be based on datatype GDT: Indicator. AnyProjectTaskIDAllowedIndicator and may be based on datatype GDT: Indicator. AnyServicePerformerPartyAllowedIndicator may be optional and may be based on datatype GDT: Indicator. AnySellerPartyAllowedIndicator may be optional and may be based on datatype GDT: Indicator. AnySourceObjectTypeCodeAllowedIndicator and may be based on datatype GDT: Indicator. AnyMaterialIDAllowedIndicator and may be based on datatype GDT: Indicator. NotToBeInvoicedIndicator may be optional and may be based on datatype GDT: Indicator.

The following composition relationships to subordinate nodes exist: Sales Item Assignment Rule Party, with a cardinality of 1:CN. The following inbound association relationship may exist: CreationIdentity, from the business object Identity/node Identity, with a cardinality of 1:CN, which is an identity of a user who created a SalesItemAssignmentRule node; LastChangeIdentity, from the business object Identity/node Identity, with a cardinality of 1:CN; which is an identity of a user who last changed a SalesItemAssignmentRule node; Material, from the business object Material/node Material, with a cardinality of C:C; InvoicingMaterial, from the business object Material/node Material, with a cardinality of C:C, which is a material that is used for invoicing; ProductCategoryHierarchyProductCategory, from the business object Product Category Hierarchy/node Product Category, with a cardinality of C:C, which represents characteristics of a product responsible for an expense recorded against a project task; ServiceProduct, from the business object Service Product/node Service Product, with a cardinality of C:C; and InvoicingServiceProduct, from the business object Service Product/node Service Product, with a cardinality of C:C, which is a service product that is used for invoicing. The following specialization associations for navigation may exist to the node Customer Project Expense List: Parent, with a target cardinality of 1; and Root, with a target cardinality of 1. The following specialization associations for navigation may exist to the node Sales Item Assignment Rule Party: Service Performer Party, with a target cardinality of C, which is an association to a party that occurs in a ServicePerformerParty specialization; and Seller Party, with a target cardinality of C, which is an association to a party that occurs in a SellerParty specialization. In some implementations, either a ProductUUID or a Description is specified. In some implementations, either an InvoicingProductUUID or an ExpenseInvoicingDescription is specified.

A Move action can be used to move a Sales Item Assignment Rule below a given target Sales Item Assignment Rule. If a target Sales Item Assignment Rule is an initial rule, then the Sales Item Assignment Rule can be moved to a topmost position. The action elements are defined by the inline structure PRO_S_CPEL_SL_IT_AS_RUL_MOV_AC. These elements include TargetHigherSalesItemAssignmentRuleUUID, which may be optional and may be based on datatype GDT: UUID.

Sales Item Assignment Rule Party is a natural or legal person, organization, organizational unit or group that is involved in a sales item assignment in a party role. A party role specifies which rights and obligations a party has regarding a sales item assignment and associated processes. A Party can be a business partner in the specializations Service Performer Party or Supplier. A Party can occur in the following specializations: ServicePerformerParty, which is a party Employee (e.g., internal or external) that is responsible for contribution of or has contributed to a creation of goods or services for a company; and SupplierParty, which is a party Supplier that delivers goods or provides a service. The elements located directly at the node Sales Item Assignment Rule Party are defined by the inline structure PRO_S_CPEL_SOI_RULE_PARTY_EL. These elements include: PartyKey, PartyUUID, RoleCategoryCode, and RoleCode. PartyKey may be optional and may be based on datatype KDT: PartyKey. PartyKey may include PartyTypeCode and PartyID. PartyKey/PartyTypeCode may be optional, is a coded representation of a type of party, and may be based on datatype GDT: BusinessObjectTypeCode. PartyKey/PartyID may be optional, is an identifier for a party, and may be based on datatype GDT: PartyID. PartyUUID may be optional and may be based on datatype GDT: UUID. RoleCategoryCode may be optional and may be based on datatype GDT: PartyRoleCategoryCode. RoleCode may be optional and may be based on datatype GDT: PartyRoleCode. The following inbound aggregation relationship may exist from the business object Party/node Party: Party, with a cardinality of C:C. The following specialization associations for navigation may exist: Root, to the node Customer Project Expense List, with a target cardinality of 1; and Parent, to the node Sales Item Assignment Rule, with a target cardinality of 1.

A number of implementations have been described. Nevertheless, it will be understood that various modifications may be made without departing from the spirit and scope of the disclosure. Accordingly, other implementations are within the scope of the following claims.

1-6. (canceled)

7. A non-transitory computer readable medium including program code for providing a message-based interface for exchanging information about cost object expense lists, including accounting notifications, the program code operable when executed by a process to:
receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification about expenses arising from and collected during a customer project, including information regarding how to invoice expenses or how expenses have been invoiced to a customer, the first message including a first message package derived from the common business object model, the first message package hierarchically organized in memory based on the common business object model, the first message package including:
at a first hierarchical level in the first message package, a cost object expense list accounting notification message entity; and
at the first hierarchical level in the first message package, a cost object expense list accounting notification package including, at a second hierarchical level in the first message package, a cost object expense list accounting notification entity, an expense original entry document reference package, and an item package, wherein the cost object expense list accounting notification entity includes, at a third hierarchical level in the first message package, a reconciliation period counter value, an item list complete transmission indicator, an operational document containing business object reference, an operational document reference, an operational document transaction universally unique identifier (UUID), a company identifier (ID), an accounting business transaction date time and a cost object reference, wherein the expense original entry document reference package includes, at the third hierarchical level in the first message package, an expense original entry document reference entity, and wherein the item package includes, at the third hierarchical level of the first message package, at least one item entity, wherein each item entity includes an action code, an operational document item reference, a sales order reference, a cancelled indicator, a not to be invoiced indicator, and an excess indicator, wherein each item package further includes, at a fifth hierarchical level in the first message package, a pricing package, wherein each pricing package includes, at a sixth hierarchical level in the first message package, at least one pricing entity, and wherein each pricing entity includes, at a seventh hierarchical level within the first message package, a calculated amount;
processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
sending a second message to the heterogeneous application responsive to the first message, where the second message includes a second message package derived from the common business object model to provide consistent semantics with the first message package.

8. The computer readable medium of claim 7, wherein the cost object expense list accounting notification entity further includes at least one of the following: a total amount, a total quantity and a total quantity type code.

9. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for providing a notification about expenses arising from and collected during a customer project, including information regarding how to invoice expenses or how expenses have been invoiced to a customer, the instructions using a request;
a first memory storing a user interface controller executable by the at least one processor for processing the request and involving a message including a first message package derived from a common business object model, where the common business object model includes business objects having relationships that enable derivation of message-based service interfaces and message packages, the first message package hierarchically organized, the hierarchical organization of the first message package including:
at a first hierarchical level in the first message package, a cost object expense list accounting notification message entity; and
at the first hierarchical level in the first message package, a cost object expense list accounting notification package including, at a second hierarchical level in the first message package, a cost object expense list accounting notification entity, an expense original entry document reference package, and an item package, wherein the cost object expense list accounting notification entity includes, at a third hierarchical level in the first message package, a reconciliation period counter value, an item list complete transmission indicator, an operational document containing business object reference, an operational document reference, an operational document transaction universally unique identifier (UUID), a company identifier (ID), an accounting business transaction date time and a cost object reference, wherein the expense original entry document reference package includes, at the third hierarchical level in the first message package, an expense original entry document reference entity, and wherein the item package includes, at the third hierarchical level of the first message package, at least one item entity wherein each item entity includes an action code, an operational document item reference, a sales order reference, a cancelled indicator, a not to be invoiced indicator, and an excess indicator, wherein each item package further includes, at a fifth hierarchical level in the first message package, a pricing package, wherein each pricing package includes, at a sixth hierarchical level in the first message package, at least one pricing entity, and wherein each pricing entity includes, at a seventh hierarchical level within the first message package, a calculated amount; and
a second memory, remote from the graphical user interface, storing a plurality of service interfaces, wherein one of the service interfaces is operable to process the message via the service interface.

10. The distributed system of claim 9, wherein the first memory is remote from the graphical user interface.

11. The distributed system of claim 9, wherein the first memory is remote from the second memory.
